(19) United States
(12) Patent Application Publication
(10) Pub. No.: US 2016/0239854 A1
(43) Pub. Date: Aug. 18, 2016

(54) SYSTEM AND METHOD FOR IMPLEMENTING A PRODUCT SALES ACTIVITY EXECUTION TRACKING PLATFORM WITH ANNOTATED PHOTOS AND CLOUD DATA

(71) Applicant: CPG DATA, LLC, El Dorado Hills, CA (US)

(72) Inventor: Tracy Breck Neal, El Dorado Hills, CA (US)

(21) Appl. No.: 15/135,872

(22) Filed: Apr. 22, 2016

Related U.S. Application Data
(63) Continuation-in-part of application No. 14/499,233, filed on Sep. 28, 2014.
(60) Provisional application No. 62/152,822, filed on Apr. 25, 2015.
(60) Provisional application No. 61/884,300, filed on Sep. 30, 2013.

(51) Int. Cl. G06Q 30/02; G06F 17/24; G06F 3/0481; G06F 3/0485; G06F 3/0482; G06F 17/30; G06T 11/60

(52) U.S. Cl. CPC G06Q 30/0201; G06F 17/3056; G06F 17/241; G06T 11/60; G06F 3/0485; G06F 3/0482; G06F 3/04817; H04W 80/04

(57) ABSTRACT

A system and method for implementing a product sales activity execution tracking platform with annotated photos and cloud data are disclosed. A particular embodiment includes: providing access to a mobile device having a mobile application executable by the mobile device; providing access to a host site computing system having an enterprise portal executable by the host site computing system, the mobile application and the enterprise portal being connectable via a data network; providing access to a data repository being connectable with the mobile application and the enterprise portal; collecting sales execution metrics as digital records for storage in the data repository, the digital records including product images and product data related to products placed at a retail location; annotating the product images, the annotation including an associated date, time, user, and geographical location; sharing the digital records with authorized users of the data repository; and generating and displaying a manager's survey view in a user interface.

### REFERENCE TO PRIORITY PATENT APPLICATIONS

The present application is a non-provisional patent application claiming priority to U.S. provisional patent application Ser. No. 62/152,822, filed on Apr. 25, 2015. The present application is also a continuation-in-part patent application drawing priority from U.S. patent application Ser. No. 14/499,233; filed Sep. 28, 2014, which is a non-provisional patent application claiming priority to U.S. provisional patent application Ser. No. 61/884,300; filed Sep. 30, 2013. The present non-provisional continuation-in-part patent application claims priority to the referenced patent applications, which are hereby incorporated by reference herein in their entirety.

### TECHNICAL FIELD

This patent application relates to computer-implemented software and networked systems, according to one embodiment, and more specifically to a system and method for implementing a product sales activity execution tracking platform with annotated photos and cloud data.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2016 CPG Data LLC, All Rights Reserved.

### BACKGROUND

Electronic information processing and communication systems are playing an increasingly important role in coordinating business operations among various participants in a community (e.g., the product distribution community). Among other functions, these technologies may be utilized for coordinating administrative operations, disseminating information or documents for review and retention, and providing individual access to product, inventory, distribution, tracking, and sales execution information. Currently, these activities are disjoint and provided independently of each other. In addition, many vital services and product distribution tracking activities as well as important historical and processed information are not provided in an automated way. Further, the interaction between product manufacturers or suppliers, product distributors, and retailers can suffer lost productivity and opportunity due to delays, missing data, or errors in communication and coordination between the parties.

### BRIEF DESCRIPTION OF THE DRAWINGS

The various embodiments are illustrated by way of example, and not by way of limitation, in the figures of the accompanying drawings in which:

FIG. 1 illustrates an example embodiment of a product sales activity execution tracking system in a network-enabled ecosystem;

FIG. 2 illustrates a home page of a user interface presented to a user when the product sales activity execution tracking system of an example embodiment is initially launched on a mobile device;

FIGS. 3 through 21 illustrate sample pages of a user interface presented to a user by the product sales activity execution tracking system of an example embodiment when the Mobile App of an example embodiment is used on a mobile device;

FIGS. 22 through 52 illustrate sample pages of a user interface presented to a user by the product sales activity execution tracking system of an example embodiment when the Enterprise Portal of an example embodiment is used on a client device;

FIG. 53 is a processing flow chart illustrating an example embodiment of a method as described herein;

FIG. 54 illustrates another example embodiment of a networked system in which various embodiments may operate;

FIG. 55 shows a diagrammatic representation of machine in the example form of a computer system within which a set of instructions when executed may cause the machine to perform any one or more of the methodologies discussed herein;

FIGS. 56 through 68 illustrate sample pages of a user interface presented to a user by the product sales activity execution tracking system of an example embodiment when the Mobile App of an example embodiment is used on a mobile device with the Manager's Survey feature; and

FIGS. 69 through 80 illustrate sample pages of a user interface presented to a user by the product sales activity execution tracking system of an example embodiment when the Mobile App of an example embodiment is used on a mobile device with the Tap Handle Survey feature.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for implementing a product sales activity execution tracking platform with annotated photos and cloud data are disclosed. The various embodiments described herein enable a distributor (or manufacturer, supplier, retailer, etc.) of product inventory to proactively manage product delivery, displays, arrangements, and other sales execution activity at a retail store or other in-store or on-premise location. The various embodiments can be used to enable multiple parties to track product sales execution and capture and share a set of sales execution metrics that enable tracking of sales execution. The set of sales execution metrics are the set of leading indicators of immediate sales activity as a result of effort and strategy by a product sales representative. In an example embodiment, these sales execution metrics can include, 1) product sales displays, 2) new distribution activity, 3) on-premise market share, and 4) tap handle acquisition. The various embodiments provide a plurality of software platforms that include a smartphone software application (app) and a web portal for the purposes of capturing a portion of the sales execution metrics (e.g., product photos and data) at a retail location, annotating the photos with delivery and product data, and sharing the annotated photos and data in a network cloud database.

In various embodiments described in detail herein, a software application program is used to gather, process, and distribute product data and image information, product placement data, tracking information, and other related product, distributor, and retailer information in digital records, using a computer system, a web appliance, and/or a mobile device. As described in more detail below, the computer or computing system on which the described embodiments can be implemented can include personal computers (PCs), portable computing devices, laptops, tablet computers, personal digital assistants (PDAs), wearable computing devices, personal communication devices (e.g., cellular telephones, smartphones, or other wireless devices), network computers, set-top boxes, consumer electronic devices, or any other type of computing, data processing, communication, networking, or electronic system.

The various embodiments described herein provide a solution to provide a fast and efficient way to gather and distribute product display data from retail locations. Prior to the systems and methods described herein, the process for collecting and sharing photos and data related to consumer packaged goods (CPG) at retail locations by wholesalers was conducted in one of the following methods; a) conventional camera or Polaroid—providing physical photos to share by hand; b) digital camera or smartphone—with the ability to share/send photos of product, accompanied by text in email descriptions and accounts of the photo; c) route accounting software integrated surveys that asked questions about the state of an activity at a retailer to provide a description of the account; and d) third party subscription sample data (extrapolated from a sample to represent the population) without photos that was provided 10-30+ days after the activity had taken place at the retail location. All of these conventional processes are inefficient and expensive. None of these existing solutions provided a fast and easy way for sales reps to: 1) capture photo plus activity account data in one record; 2) publish the photo and related data immediately to the network cloud for analytical or visual retrieval; 3) provide a fast look photo with all important data surrounding the subject matter; 4) provide time and geo-location verification of the activity; and 5) provide a variety of parameters of value based on a single brand selection (e.g., by selecting “Coors Light”, the software of the example embodiment automatically applies additional information, such as: supplier=MillerCoors, segment=premium, sub-segment=premium light, origin=domestic US, brand family=Coors brands, competitor=Bud Light).

Prior to the systems and methods described herein, conventional business processes included the following: a) sales rep would send a photo with corresponding email and details of the account of the photo. Then, an administrator would receive the photo, save the photo, and record the details of the account in a database or spreadsheet for limited sharing; b) a sales rep would take digital photos with a camera or smartphone, download the photos to their personal computer, then upload them to a USB (universal serial bus) stick, then bring the USB stick to work for the administrator to upload to their computer, then conduct the same steps as above; c) a sales reps would collect information in a digital spreadsheet and then take a corresponding photo. Then, the spreadsheet and the photos (many, different files) would be shared with an administrator who would conduct the one or more of the steps above; d) a sales rep would share a digital photo of retail activity internally or externally, but there would be no proof of when the photo was taken or where it was taken—resulting in fraudulent sharing of previously used photos; e) some RAS (route account software) systems that asked questions of sales reps had the ability to roll the answers to those questions up in summary, without photos and specifically without the “output photo” as described below.

As described in detail herein for an example embodiment, customers can log in to the presently-disclosed Enterprise Portal from any networked location. From the Enterprise Portal, users can access all photos and related data in real-time (e.g., 2-3 seconds after a sales rep completes a survey at a retail location). Additionally, users can access the total market, not merely a sampling of the market. The photos provide an instant result of qualitative and quantitative value against the retail standards that customers may be coaching and compensating their sales teams against. Further, the collected data can be simultaneously separated from the photos and placed in detail and aggregate for further analytics and reporting—in a manner that is predictively valuable and reasonable to customers. Some of these reports include, incentive tracking, advertising (ad) performance tracking, specific static reports required by their suppliers, and retail activity trend analytics.

Prior to the systems and methods described herein, the focus for the industry was on “sales volume” and nobody was tracking “execution data”. Execution data provides leading indicators related to the weekly activity of consumer product goods sales at retail. Because of the nature of the 3-tier system in alcoholic beverage distribution, the suppliers (brewers, manufacturers, and importers) place contractual demands on their distributors and carry a “big stick” when it comes to requesting reporting and other information. The systems and methods described herein solve this problem by providing the distributors with these data points, which they are then open to share with their suppliers/vendors at their own discretion.

Because most suppliers and distributors focus on four key execution elements of their annual business plan, the example embodiments described herein support the collection and sharing of these four key execution elements. These four key execution elements include:
1. Display tracking at retail=DTA: Display Tracking Awesomeness!
2. Tap handle market share changes=THS: Tap Handle Survey
3. New points of distribution=NPP: New Product Placement
4. On-premise consumer activities=OPP: On-Premise Promotions (may also be used for Off-Premise Promotions, where legal by state)

Because each of these execution elements are so highly dependent on a strong sales force, the example embodiments described herein support a fifth survey for customer management/supervisors. This survey is called MGR: Manager's Capture & Caption. This survey allows managers to capture photos of good and bad execution elements in the trade and then “caption them” with one or more predetermined statements of feedback. The photos from this process as well as the “tags” are also placed in a database where the raw data can be sorted by parameters or presented in pre-packed reports can provide insight on better developing sales reps or managers.

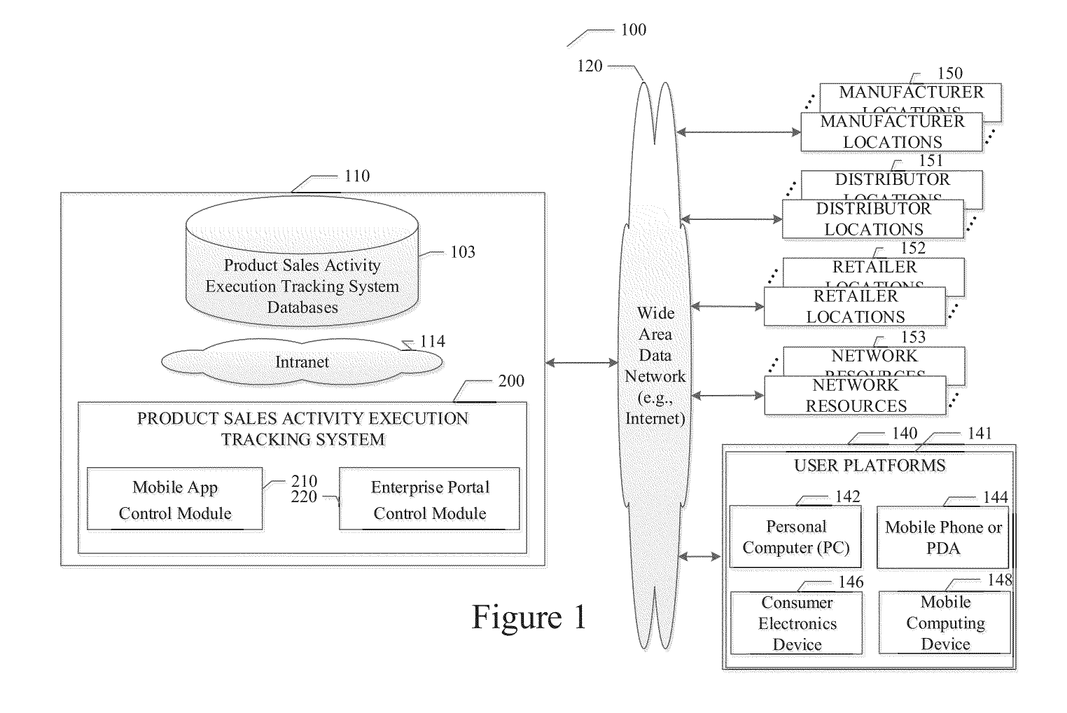

Referring now to FIG. 1, in an example embodiment, a system for product sales activity execution tracking management 100 in a network-enabled ecosystem is disclosed. In various example embodiments, an application or service, typically provided by or operating on a host site (e.g., a website) 110, is provided to simplify and facilitate the downloading or hosted use of the product sales activity execution tracking system 200 of an example embodiment. In a particular embodiment, the product sales activity execution tracking system 200, or a portion thereof, can be downloaded from the host site 110 by a user at a user platform 140. Alternatively, the product sales activity execution tracking system 200 can be hosted by the host site 110 for a networked user at a user platform 140. The details of the product sales activity execution tracking system 200 of an example embodiment are provided below.

Referring again to FIG. 1, the product sales activity execution tracking system 200 can be in network communication with a plurality of user platforms 140. The host site 110 and user platforms 140 may communicate and transfer data and information in the data network ecosystem 100 shown in FIG. 1 via a wide area data network (e.g., the Internet) 120. Various components of the host site 110 can also communicate internally via a conventional intranet or local area network (LAN) 114.

In an example embodiment, the product sales activity execution tracking system 200 can also be in network communication with a plurality of manufacturer locations 150, a plurality of distributor locations 151, a plurality of retailer locations 152, and a plurality of network resources 153. Locations 150, 151, and 152 can represent the network locations of product manufacturers, product distributors, or product retailers for which product displays and product sales are being managed using an embodiment described herein. Network resources 153 can represent the network locations of host team members, third party contacts, affiliates, information sources, or other contacts or network resources that may provide or consume data associated with the product sales activity execution tracking system 200 of the example embodiment.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device can act as a link between LANs, enabling messages to be sent between computing devices. Also, communication links within LANs may include optical fiber data lines, twisted wire pairs or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), optical fiber, wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to be moved freely and randomly and to organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example. Internet Protocol (IP) addresses or addressing can be used to reference and access a particular device via the networks 120 and 114.

The product sales activity execution tracking system can be implemented using any form of network transportable digital data. The network transportable digital data can be transported in any of a group of data packet or file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JavaScript Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol.

In a particular embodiment, a user platform 140 with one or more client devices 141 enables a user to access data and provide data and/or instructions for the product sales activity execution tracking system 200 via the host 110 and network 120. Client devices 141 may include virtually any computing device that is configured to send and receive information over a network, such as network 120. Such client devices 141 may include mobile or portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., Twitter), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

As one option, the product sales activity execution tracking system 200, or a portion thereof, can be downloaded to a user device 141 of user platform 140 and executed locally on a user device 141. The downloading of the product sales activity execution tracking system 200 application (or a portion thereof) can be accomplished using conventional software downloading functionality. As a second option, the product sales activity execution tracking system 200 can be hosted by the host site 110 and executed remotely, from the user's perspective, on host system 110. In one embodiment, the product sales activity execution tracking system 200 can be implemented as a service in a service-oriented architecture (SOA) or in a Software-as-a-Service (SAAS) architecture. In any case, the functionality performed by the product sales activity execution tracking system 200 is as described herein, whether the application is executed locally or remotely, relative to the user.

Referring again to FIG. 1, the host site 110 and product sales activity execution tracking system 200 of an example embodiment is shown to include a product sales activity execution tracking system database 103. The database 103 is a secure network cloud database used in an example embodiment for data storage of information related to product sales activity execution, product display photos and records, manufacturer, distributor or retailer data, reports, calendar data, configuration data, scheduling data, and the like. It will be apparent to those of ordinary skill in the art that the database 103 can represent multiple datasets and can be used for the storage of a variety of data in support of the product sales activity execution tracking system 200 of an example embodiment.

Referring again to FIG. 1, host site 110 of an example embodiment is shown to include the product sales activity execution tracking system 200. Product sales activity execution tracking system 200 can include a Mobile App Control Module 210 and an Enterprise Portal Control Module 220. Each of these modules can be implemented as software components executing within an executable environment of product sales activity execution tracking system 200 operating wholly or in part on host site 110 or user platform 140. Each of these modules of an example embodiment is described in more detail below in connection with the figures provided herein.

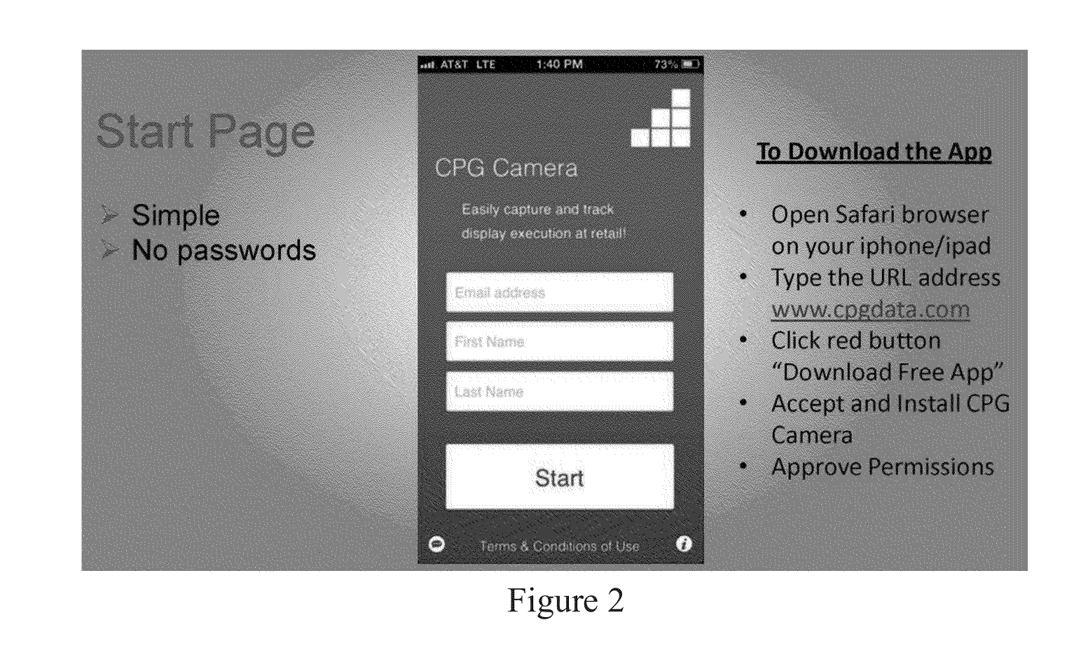

FIG. 2 illustrates an initial page of a user interface presented to a user when the product sales activity execution tracking system 200 of an example embodiment is initially launched. As described above, the product sales activity execution tracking system 200 can be configured to operate wholly or in part on host site 110 or a user platform 141. Software components executing within an executable environment of product sales activity execution tracking system 200 can present various pages of a user interface to a user at a user platform 141. These pages can be presented using well-known protocols and data transfer interfaces. The initial page shown in FIG. 2 is presented when an example embodiment of the product sales activity execution tracking system 200 is initially activated or launched. As shown, the example embodiment presents a set of command or function options as softkeys, input objects, or other user interface mechanisms, which enable a user to signal activation of a desired option. As well-known to those of ordinary skill in the art, such user interface mechanisms can be implemented using touchscreens, physical buttons, regions on a display screen that can be selected using a pointing device, alphanumeric codes or keystrokes, or the like.

Referring again to FIG. 1 and as described above, a user platform 141 can include a mobile device on which a mobile application (app) can be executed. An example embodiment, implemented as a mobile device app, can be used to support a mobile device user interface for the product sales activity execution tracking system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant information from a mobile device. As described in more detail herein, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen can display a host logo and wallpaper image while opening the login screen or a live feed of processed information.

User log-in functionality in the mobile app provides a user-friendly user interface in which the user provides the email address and password associated with the user account. If the user does not have an account, the user can create an account from this user interface. The process of creating a user account in an example embodiment is simple and only requires the user to provide the following information: name, surname, e-mail address, and password. By completing this information, the user can create an account and get access to processed information.

An example embodiment of the product sales activity execution tracking system 200 is comprised of two platforms, (1) a Smartphone App, denoted herein as the “Mobile App” implemented by the Mobile App Control Module 210; and (2) a cloud-based web access portal to a secure database, denoted herein as the “Enterprise Portal” implemented by the Enterprise Portal Control Module 220. These two platforms of an example embodiment are described in more detail below.

### Mobile App

Consumer packaged goods (CPG) represent a large retail industry of products associated with, but not limited, to beverages (e.g., alcoholic and non-alcoholic), cereals, salty-snacks, canned goods, frozen foods, over-the-counter pharmaceuticals, health & beauty products, and many more. In an example embodiment, a software application (app) for a mobile device allows a user to capture, identify, and record, via meta-data, user-provided parameters and photos related to the retail execution of consumer packaged goods (e.g. sales execution metrics), in a particular example embodiment. Retail execution can be described as efforts made by manufacturers, brokers, distributors, or retailers to increase the shelf or floor awareness of a product for the purposes of improving profit, market share, or volume velocity.

As described above with reference to FIG. 1, the product sales activity execution tracking system 200 of an example embodiment can include the Mobile App Control Module 210. As also described above, the Mobile App Control Module 210 can be downloaded in whole or in part as the Mobile App to a mobile device of a user platform 141. The downloaded app or Mobile App can be executed locally on the mobile device by a user.

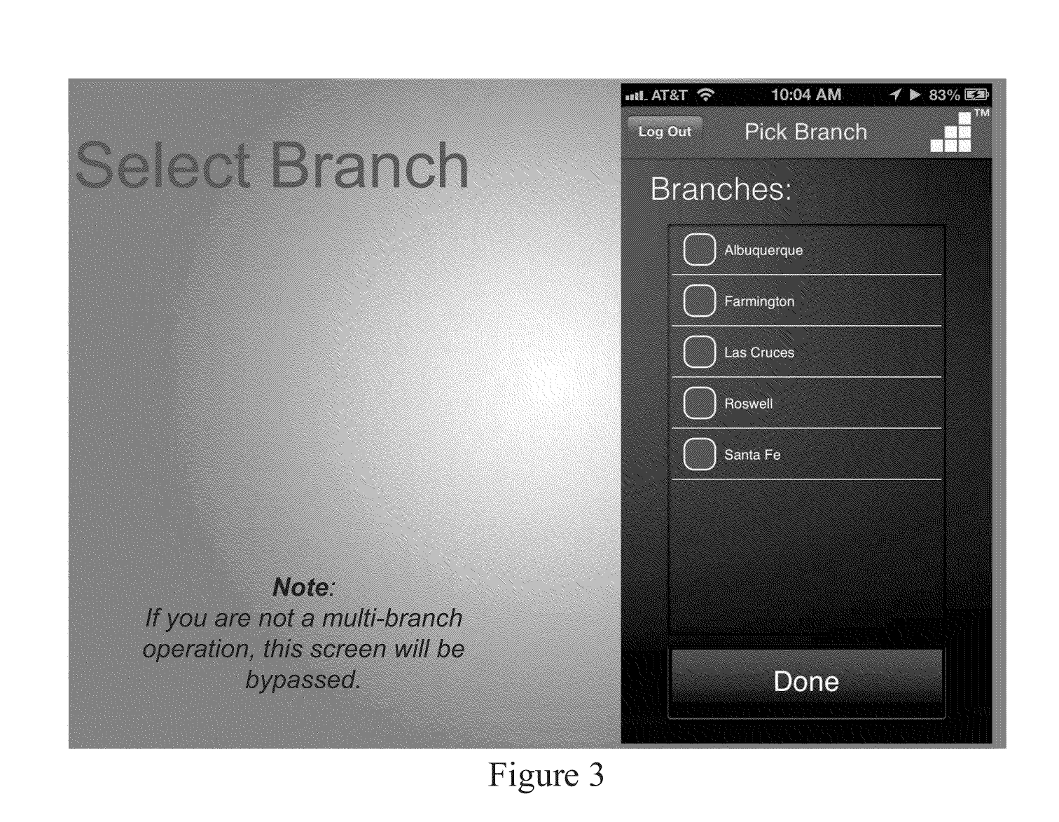

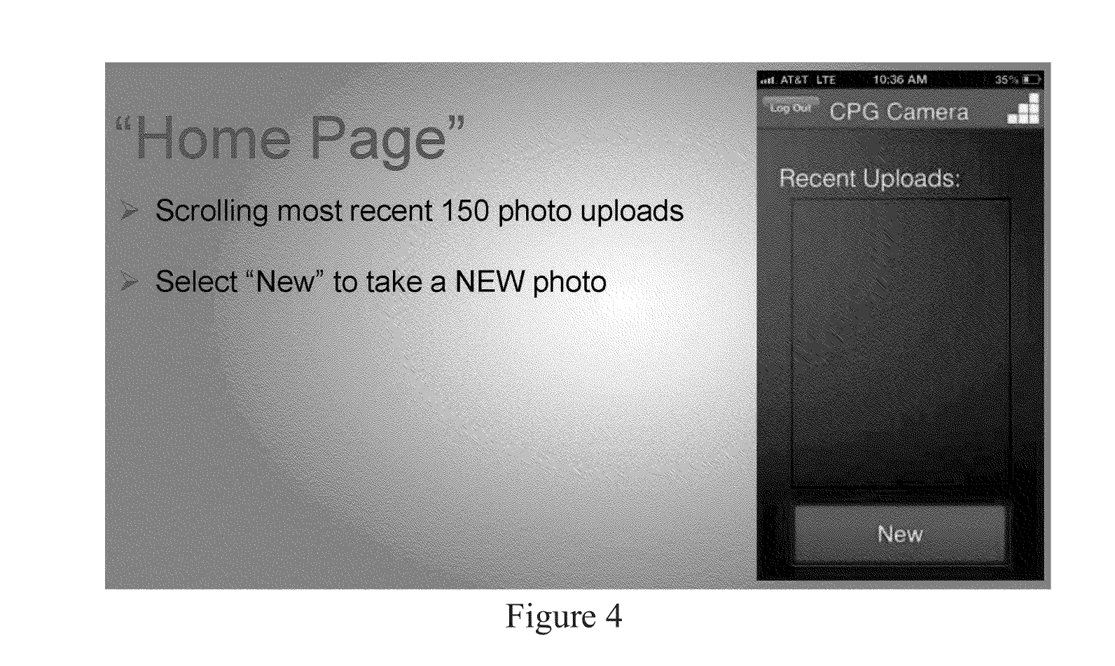

Referring now to FIG. 2, upon launching the Mobile App on the mobile device, the user is presented with three simple registration prompts: Email, First Name, and Last Name. When the user has responded to these prompts, the user is directed to the home page shown in FIG. 4. If, based on the user registration information, the user is associated with a business having multiple branch offices, the user is prompted to select a branch office as shown in FIG. 3.

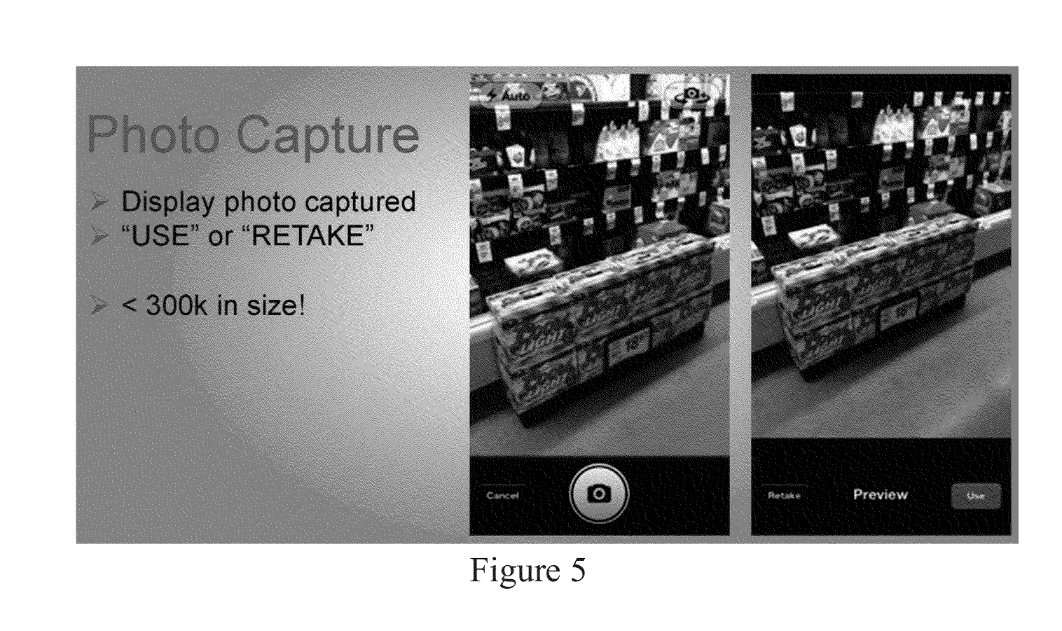

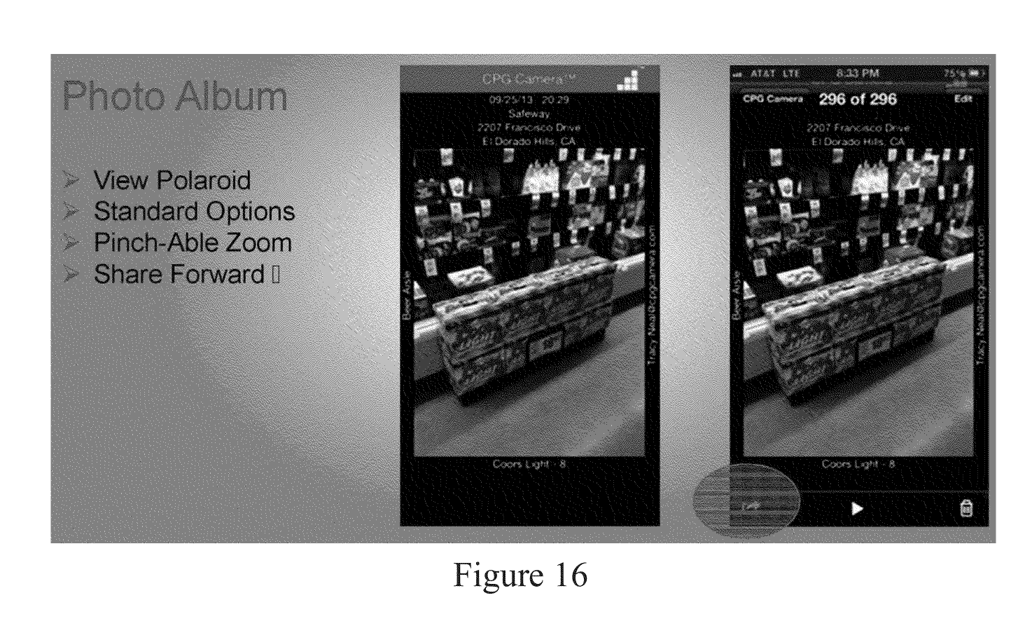

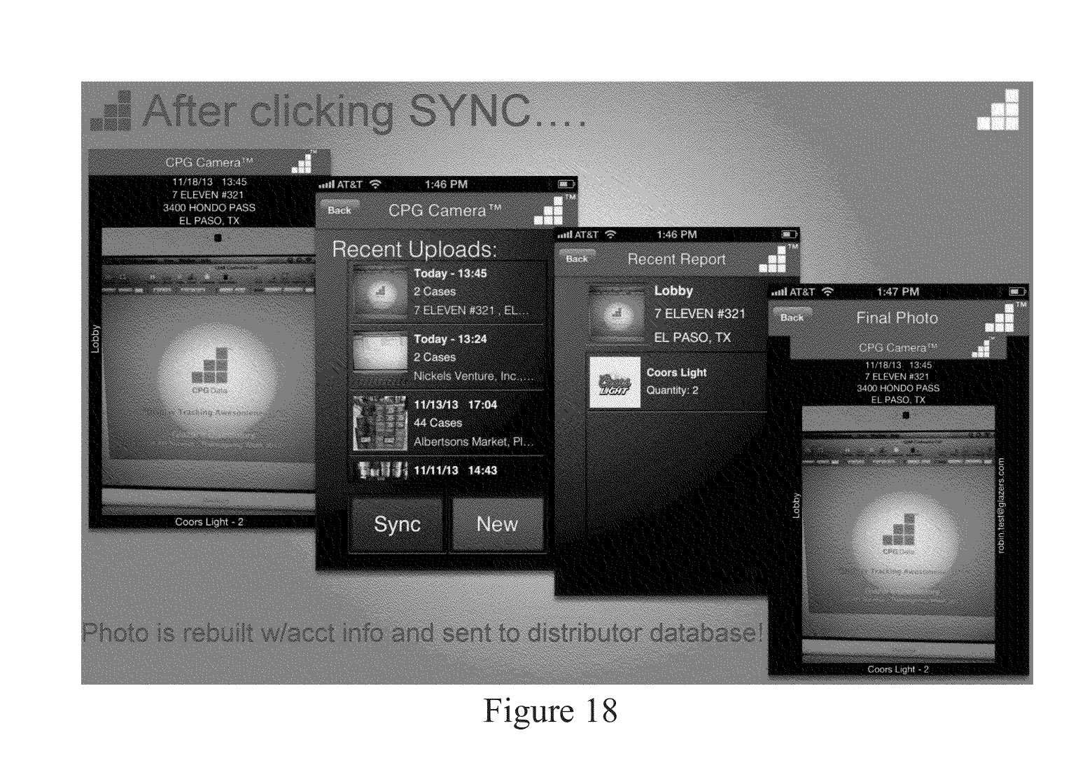

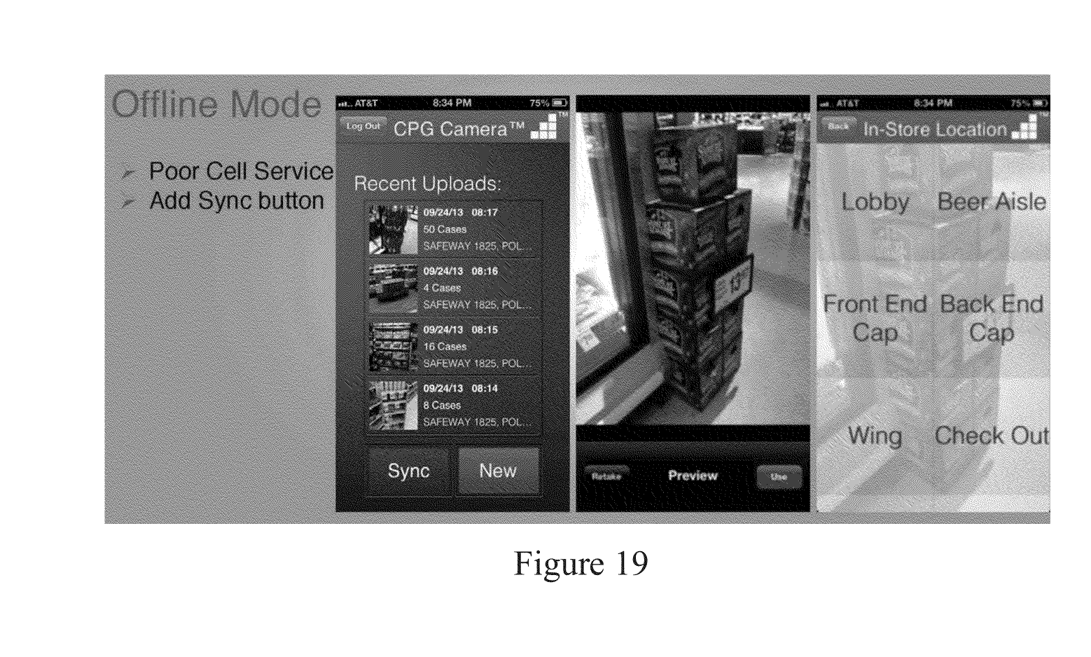

Referring now to FIG. 4, the user lands on the home page once the login or registration process is complete. In the example embodiment, the home page has a vertical scrolling summary of the records/reports that the user has taken in the past. These records are presented with a date/time stamp and other parameters captured with each report. The home page has a “New” button and may have a “Sync” button (see FIGS. 16 through 20 described in more detail below). By clicking “New”, the Mobile App activates the camera on the mobile device and the user can capture a desired photo. The photo is then presented by the Mobile App for “retake” or “use”. These operations of an example embodiment are shown in FIG. 5.

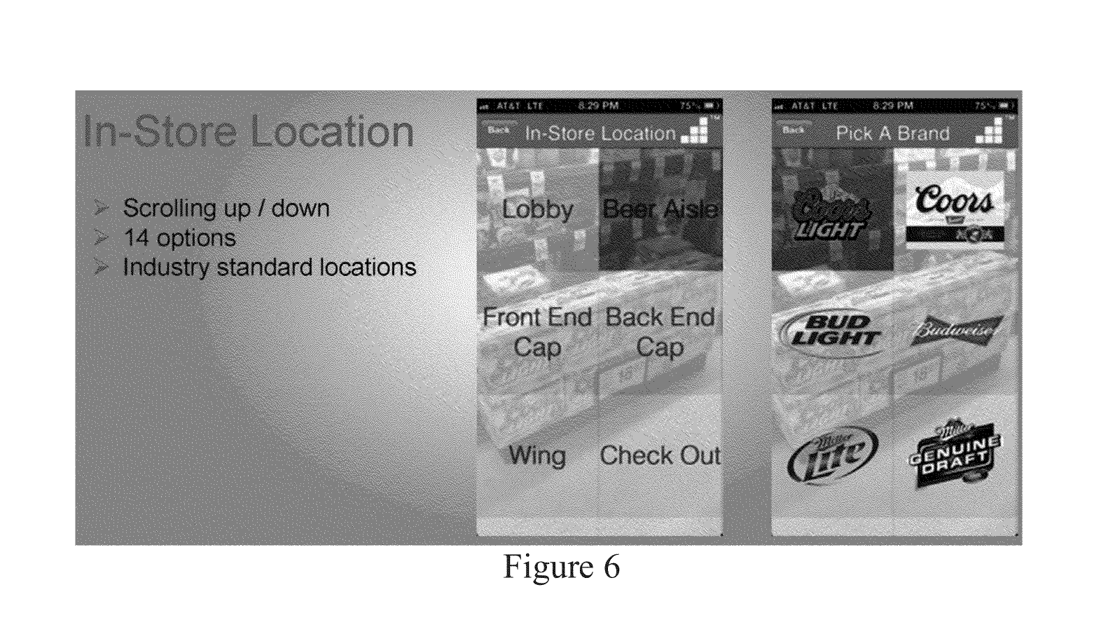

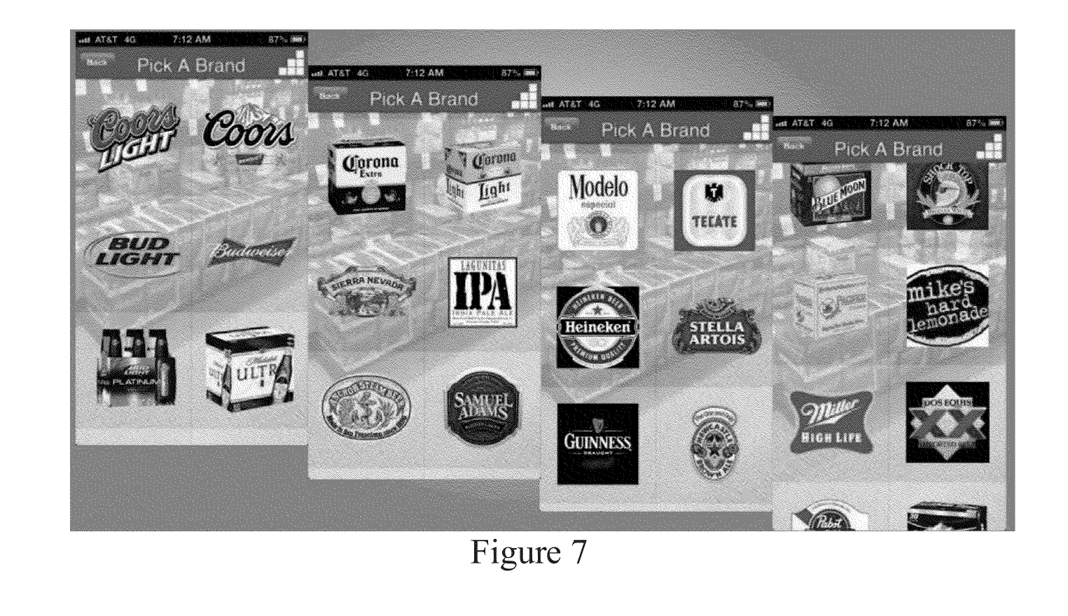

Referring now to FIG. 6, the user is next presented with the “vertical scrolling” options of in-store locations, presented in large square buttons for easy use. The in-store locations can correspond to the location captured in a related photo. In an example embodiment, the in-store locations can include: lobby, beer aisle, front end cap, back end cap, wing, and checkout. It will be apparent to those of ordinary skill in the art that a variety of in-store locations can be prompted. The options may also scroll left to right in association with other parameter options. Additionally, the photo taken and accepted is provided in a transparent background throughout this page and the remaining pages of the Mobile App. Referring to FIGS. 6 and 7, after selecting an in-store location, the user can be prompted to select the primary product brand featured in the previously-captured photo by scrolling across large buttons with pre-configured brand icons, similar in size and behavior as the previous screen and also with the transparent photo provided in the background. The selected in-store location and the selected product brand can be associated in the database with the related photo and data.

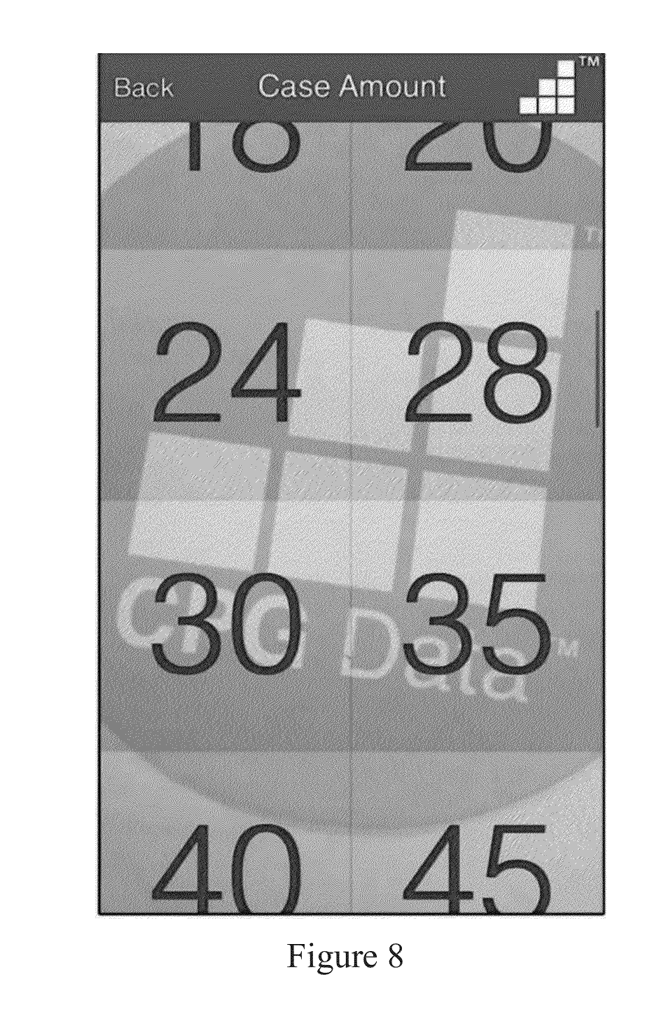

Referring now to FIG. 8, the user can be prompted to provide data about the quantity of units on featured in the photo, again, scrolling up and down or side to side in the big square buttons, similar in size and behavior as the previous screen and also with the transparent photo provided in the background. The selected product brand quantity can be associated in the database with the related photo and data. A stock keeping unit (SKU) and/or product barcode associated with the selected product brand and quantity can also be associated in the database with the related photo and data.

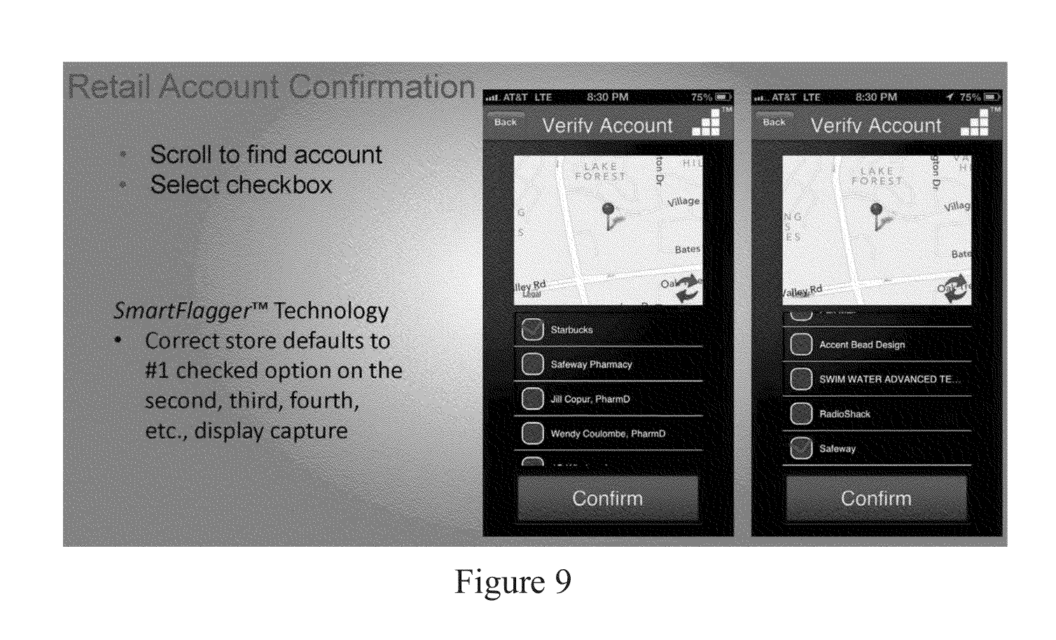

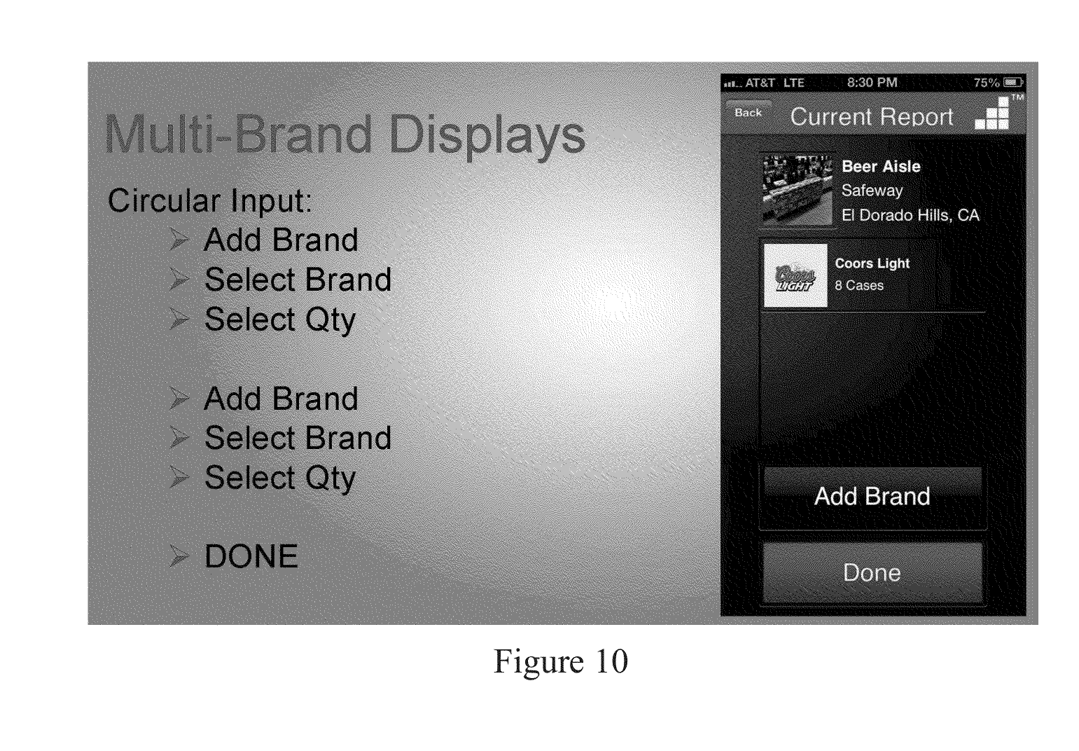

Referring now to FIG. 9, the user can be prompted to associate the photo and data with a business account identifier. A map of the user's current geographical location can also be presented. The user's current geographical location can be obtained from the geo-location data or GPS (global positioning satellite) data provided by the standard mobile device. The user's current geographical location and a current time/date tag can be recorded with the data associated with the photo. In a particular embodiment, the user can be presented with a list of selectable business accounts, where the available accounts are presented in a checklist, and a selected account can be checked to represent the account to associate with the photo and data. If the account is not provided, there are two red arrows provided on the map to “refresh” the list. Once the user selects the account, then clicks “Confirm”, the user is now presented with the option of being “Done” or “Add Brand”, which allows the user to select another brand, another quantity of units, and then back to the Done/Add Brand option again (see FIG. 10). The “Done” button is presented in similar red and featured with a vertical gradient while the Add Brand button is provided in the base color of the Mobile App. In a particular embodiment, the appropriate business account and related account identifier can be found using a third party information provider (e.g., Google®). For example, a geographical position of a particular in-store location associated with a photo can be matched to a corresponding geographical position of a related business in a business account index. In this manner, the business account and account identifier can be automatically matched to a set of sales execution metrics captured at the in-store location.

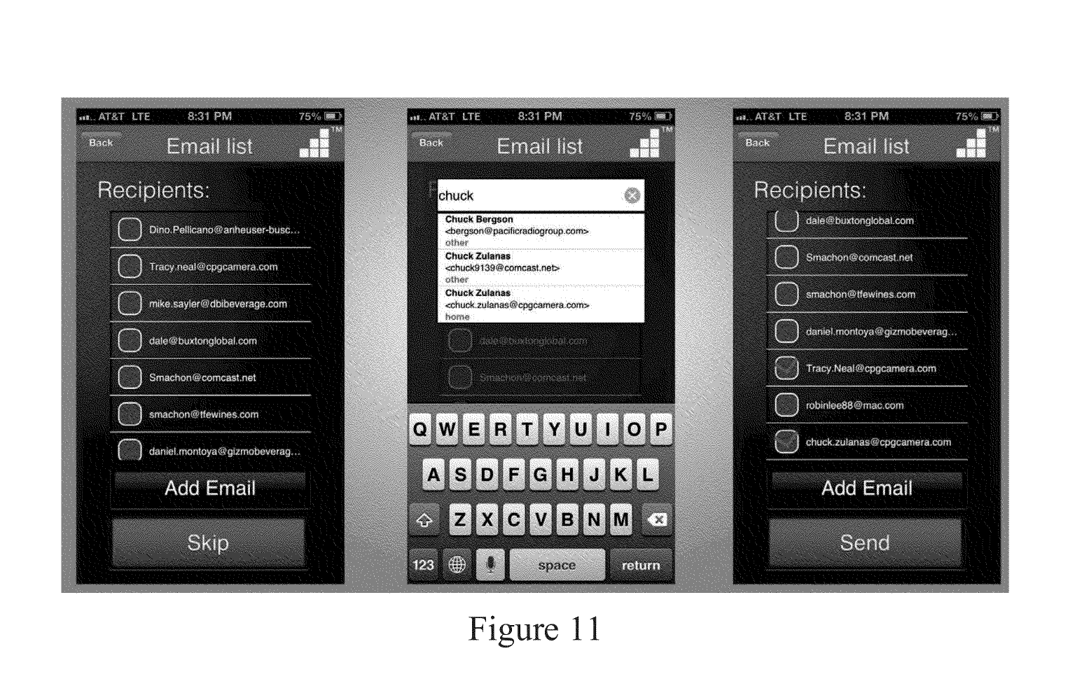

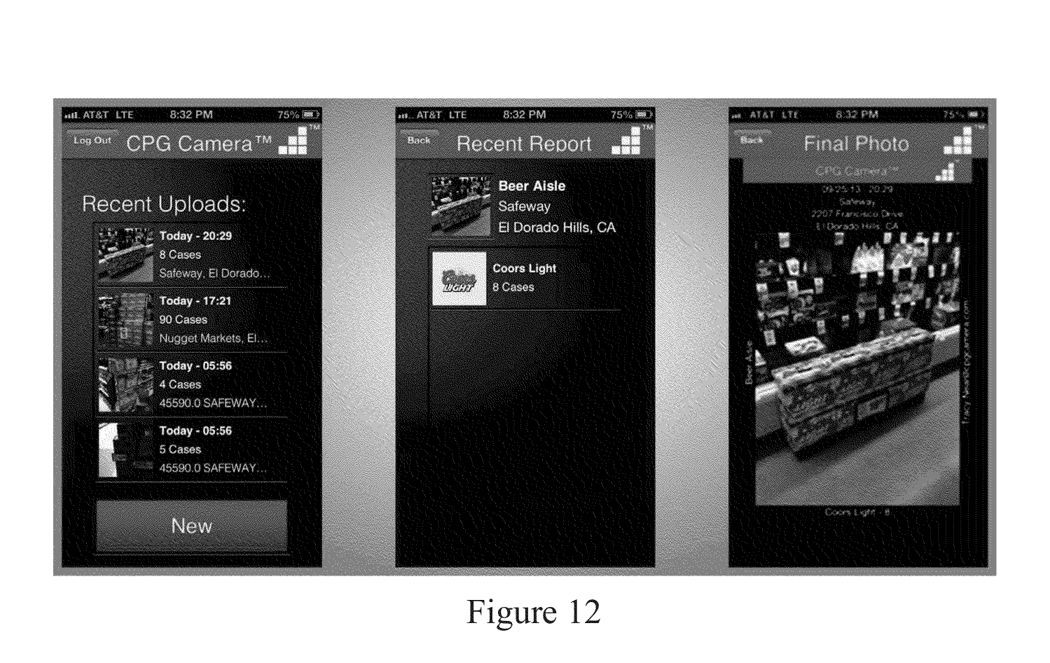

Referring now to FIG. 11, the “Recipients” page is the next page of the Mobile App of an example embodiment. The “Recipients” page enables the user to select the destinations where the photo and data (or links thereto) can be sent. In a particular embodiment, the destinations can be email addresses of the desired recipients of the photo and data. The user's email address will appear as the first and only email address by default. To add more email addresses, the user can select the button “Add Email” as shown in FIG. 11. Using the Add Email feature, the user can look up an email address from a standard address book or contact list and add the email address as an added recipient destination address. The selectable checkboxes, as shown in FIG. 11, are provided to the left of each email address and the email addresses are listed in a vertical scrolling window in the order added by the user. Using standard iOS (or other standard mobile device operating system) features, the user may “swipe right” to each email address to delete it. iOS® and Apple® are trademarks of Apple Computers. Because the email feature of the example embodiment is optional, the red “SKIP” button at the base of this screen (see FIG. 11) can prompt the user to skip to the next screen if no email is selected. If one or more email addresses are selected, the red “SEND” button is provided. After the user clicks or selects the SKIP or SEND options, the Mobile App can return the user to the home page shown in FIG. 4 and described above. Alternatively, the Mobile App can direct the user to a Recent Updates page or a Recent Uploads page as shown in FIG. 12.

Referring now to FIG. 12, a Recent Updates or Recent Uploads page of an example embodiment is shown. On the Recent Updates or Recent Uploads page, the user may vertically scroll all recent reports. A report can correspond to or include the captured photo and related data as described above. Upon selecting a particular available report from the Recent Updates or Recent Uploads page, the Mobile App can provide a screen called “Recent Report” as shown in FIG. 12, which provides a mini-photo of a previously captured photo above a scrollable list of the product brands and quantities associated with this record. Next to each listed product brand is the brand's logo for easy identification. If the user selects the photo, the user is directed to a copy of the “output photo” or “final photo” as shown in FIGS. 12 through 14.

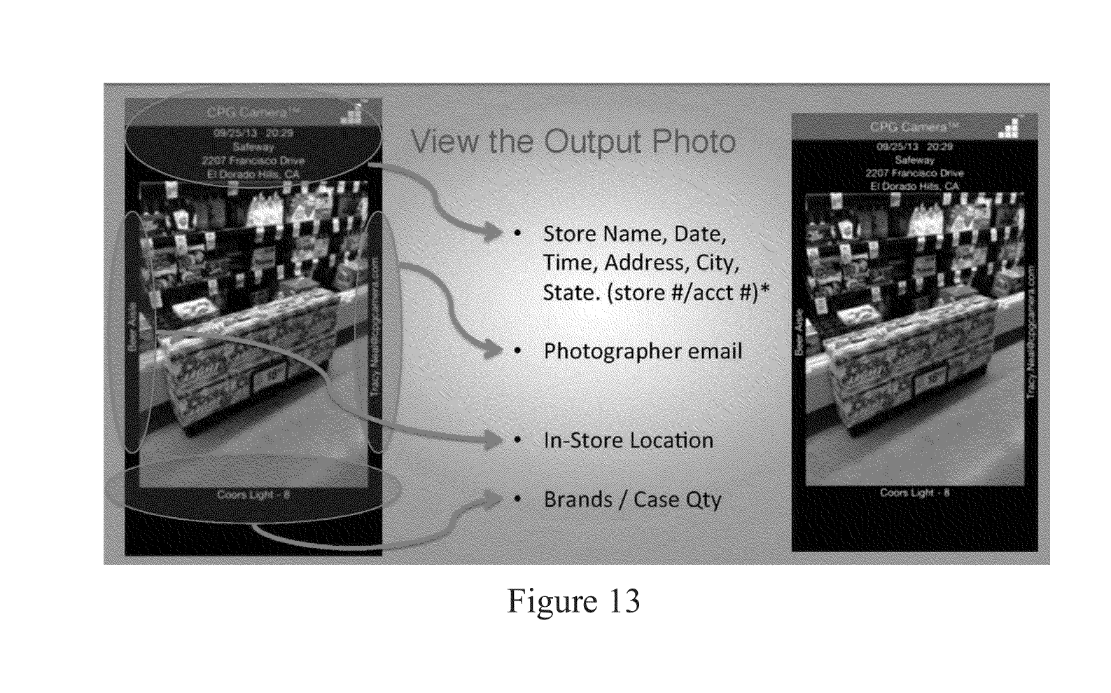

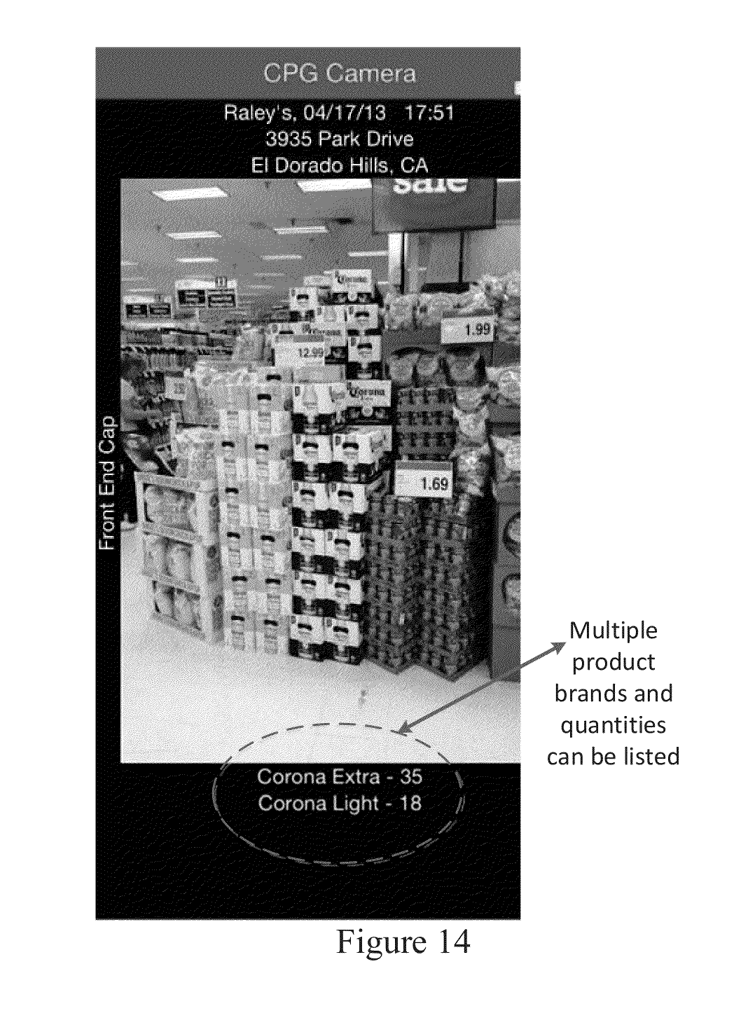

Referring now to FIGS. 13 and 14, the “output photo” or “final photo” is shown. The output photo or final photo in an example embodiment has a red header for easy identification. The output photo of an example embodiment is surrounded by a black border with white text captioning around the four sides of the photo. In the example embodiment, the following information can be provided in the white text captioning around the four sides of the photo and published with each photo, depending on the type of customer and their license agreement with the host.

1. On top of the photo, with center justification:
Date/Time
Store or Retail Location or Account Name
Store or Retail Location or Account Number
Store or Retail Location or Account Address
Store or Retail Location or Account City, State, Zip

2. On the left side or the right side of the photo:
Sales Rep or App User Name
Sales Rep or App User Email Address
In-Store Location of the Display for the Account

3. On the bottom of the photo:
Brand(s) selected and Unit quantity selected
If multiple brands are shown in the photo, the annotation area at the bottom of the photo expands with each additional brand going to the bottom of the existing list. An example of an output or final photo with multiple brands and quantities is shown in FIG. 14.

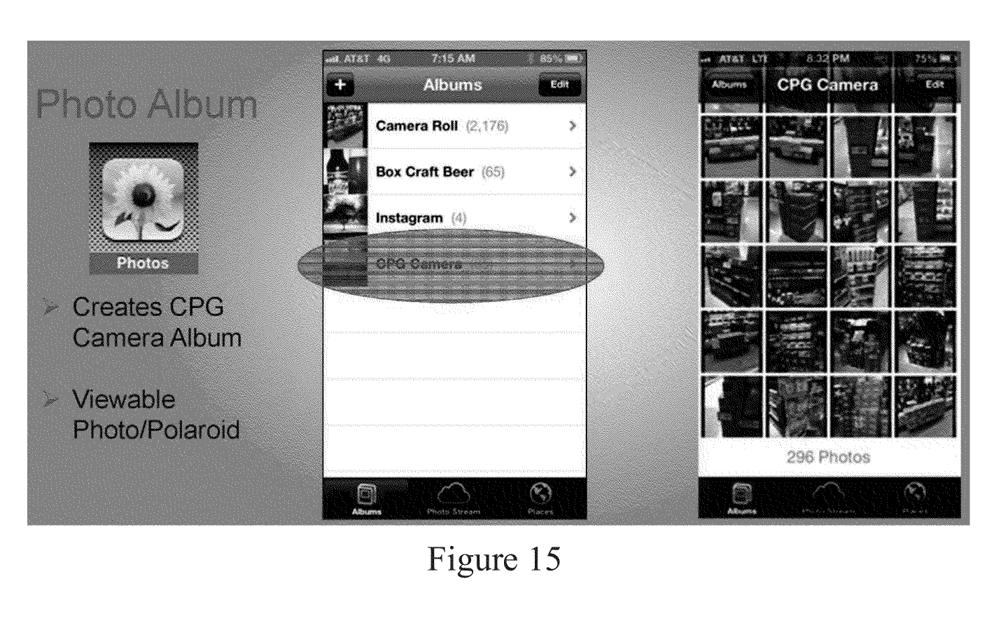

As shown in FIGS. 15 and 16, groupings of output photos or final photos can be arranged in a photo album. The groupings can be arranged in a variety of categories or groups based on any of the data associated with the related photos. For example, photos can be arranged by date/time, location, account, sales representative, in-store location, brand, etc. The photo albums can be created and shared with others using the email features described above. The output photos and related photo albums can be transferred for storage to a secure cloud server database 103 via a data network 120.

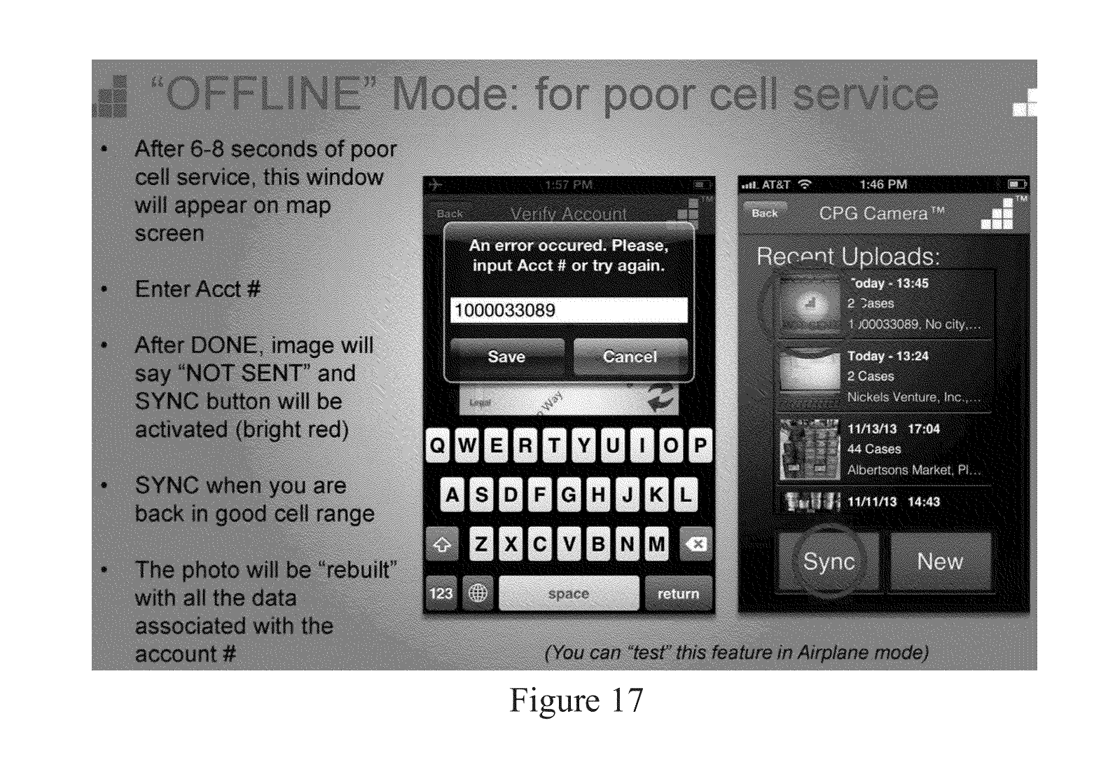

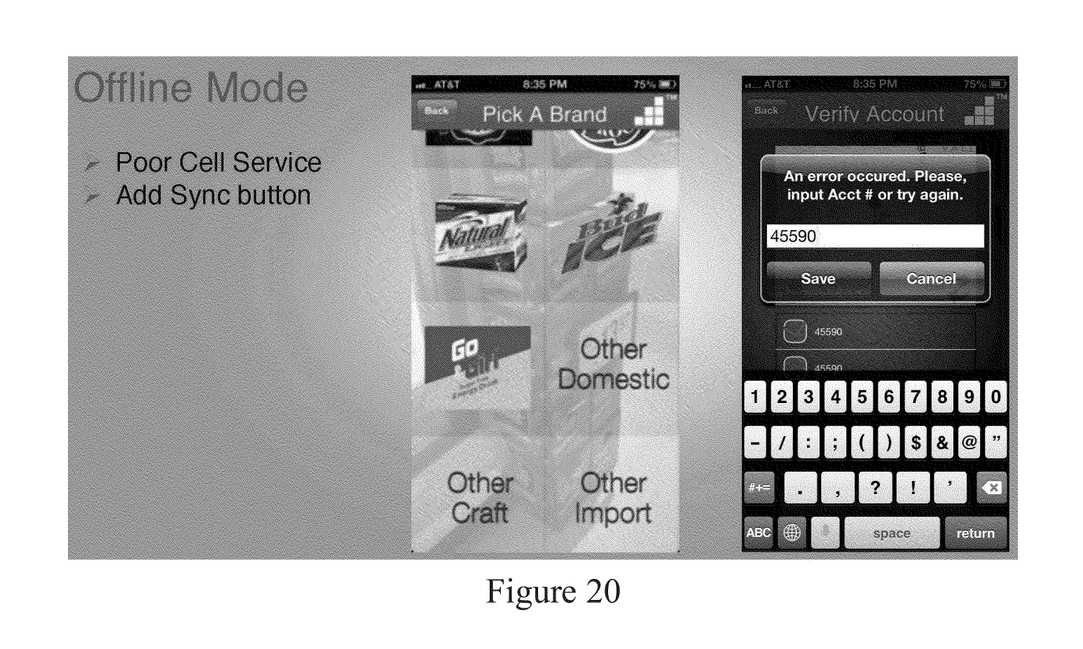

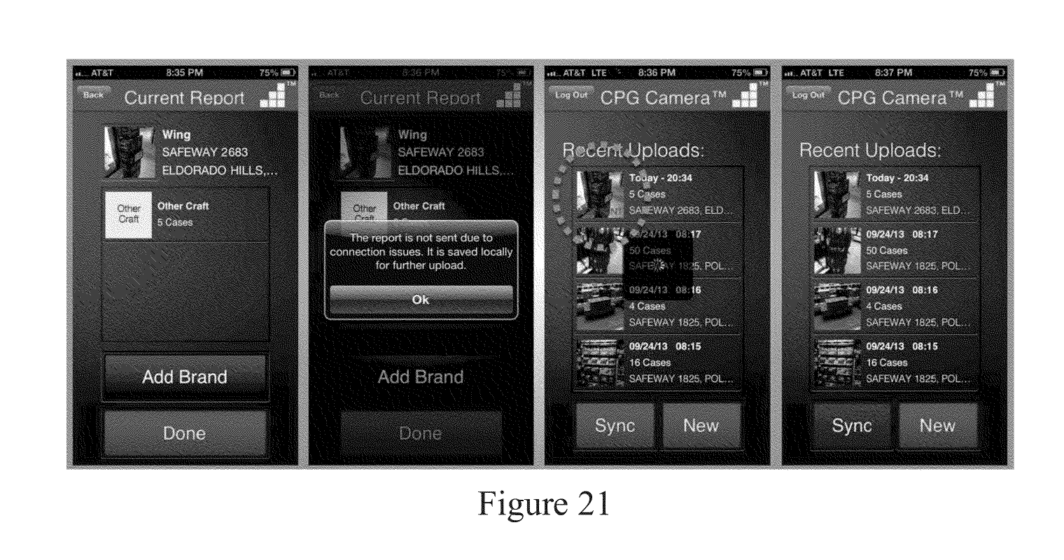

Referring now to FIGS. 17 through 21, the Mobile App of the example embodiment includes an “offline” feature so that the app can be used in accounts or with devices that may have poor to no data network connectivity. The Mobile App can automatically determine when this feature is activated and when doing so, the changes are evident to the user. In particular, when the offline feature of the example embodiment is activated based on a poor network connection, a Verify Account Page, as shown in FIGS. 17 and 20 is presented. The Verify Account Page can include a pop up window notifying the user that network reception is poor or absent. The user is prompted to “Retry” the network connection for connectivity access or to input the “Account #”. If the user inputs the account number, then the account number is stored locally in the vertical scrolling list below the map on the current page. This account can now be “checked” and the account will remain there to be checked for the next record taken offline. Upon clicking “Done”, the user will see a pop up window that says, “This report is not sent due to connection issues. The report is saved locally for further upload.” The user may click “OK” to continue. Now the user can be directed to the Recent Uploads page as described above and shown in FIGS. 17 and 21. In the case of a retained offline record, the user will notice two notifications that signal that a record has been stored locally without being sent to the secure cloud server database: 1) at the bottom of the photo in the Recent Uploads page, the words “Not Sent” are provided in red (e.g., see FIGS. 17 and 21); and 2) The “Sync” button is now the same color as the “New” button at the bottom of the page (e.g., see FIGS. 17 and 21). When the mobile device is again able to establish a reliable network connection, the locally retained offline records can be transferred for storage to the secure cloud server database 103 via a data network 120. In this manner, the Mobile App of an example embodiment can used anywhere and at any time. The locally retained offline records can be synched with the database 103 automatically or synched when the user of the mobile device activates the “Sync” button of the Recent Uploads page as described above.

### Enterprise Portal

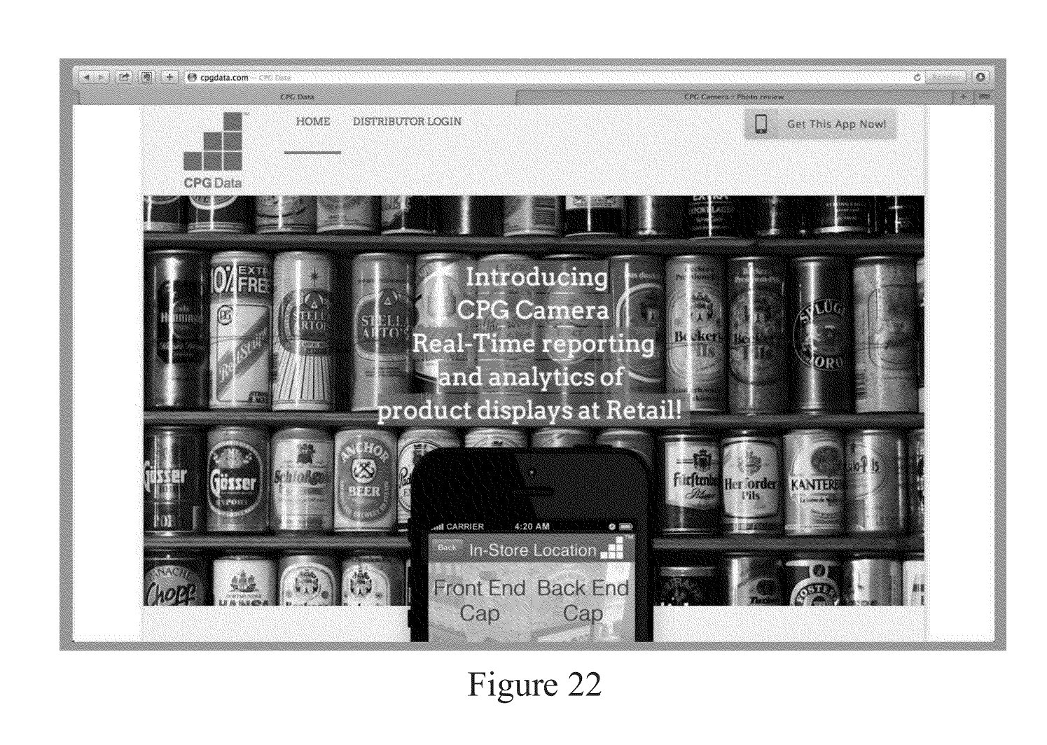

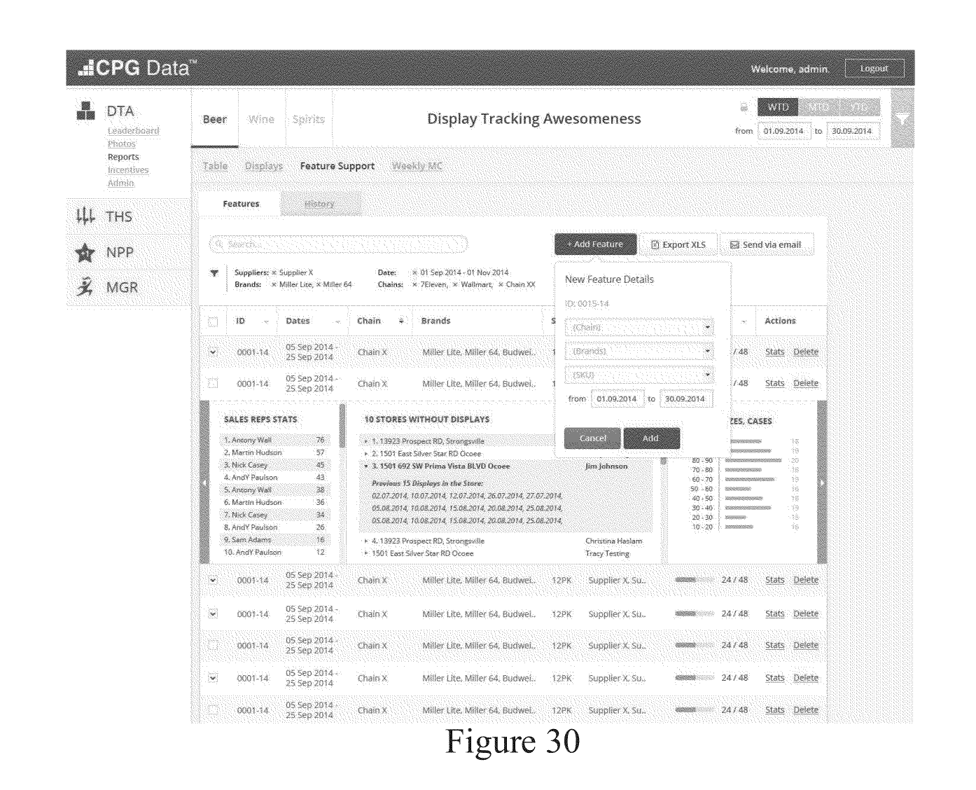

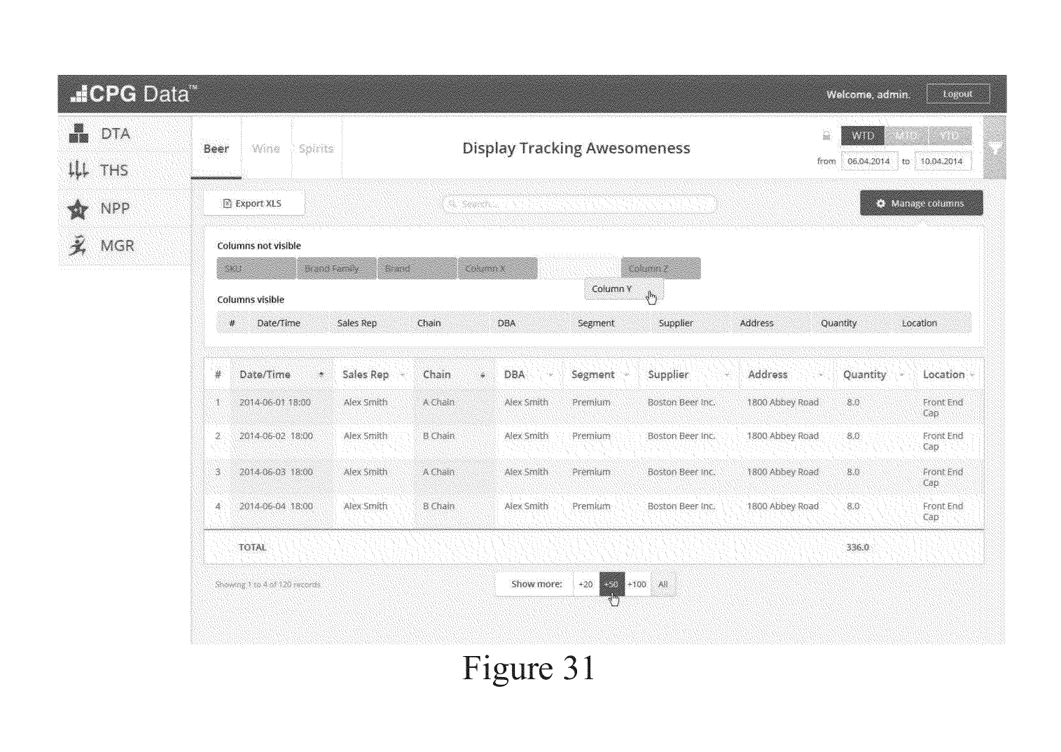

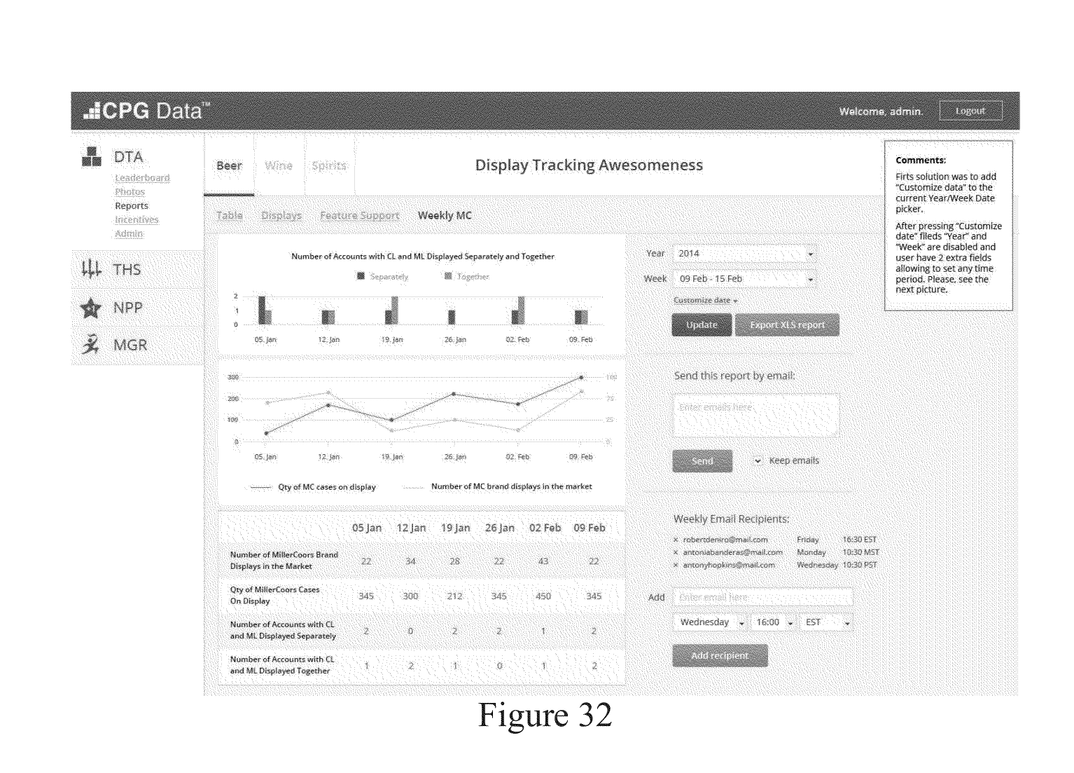

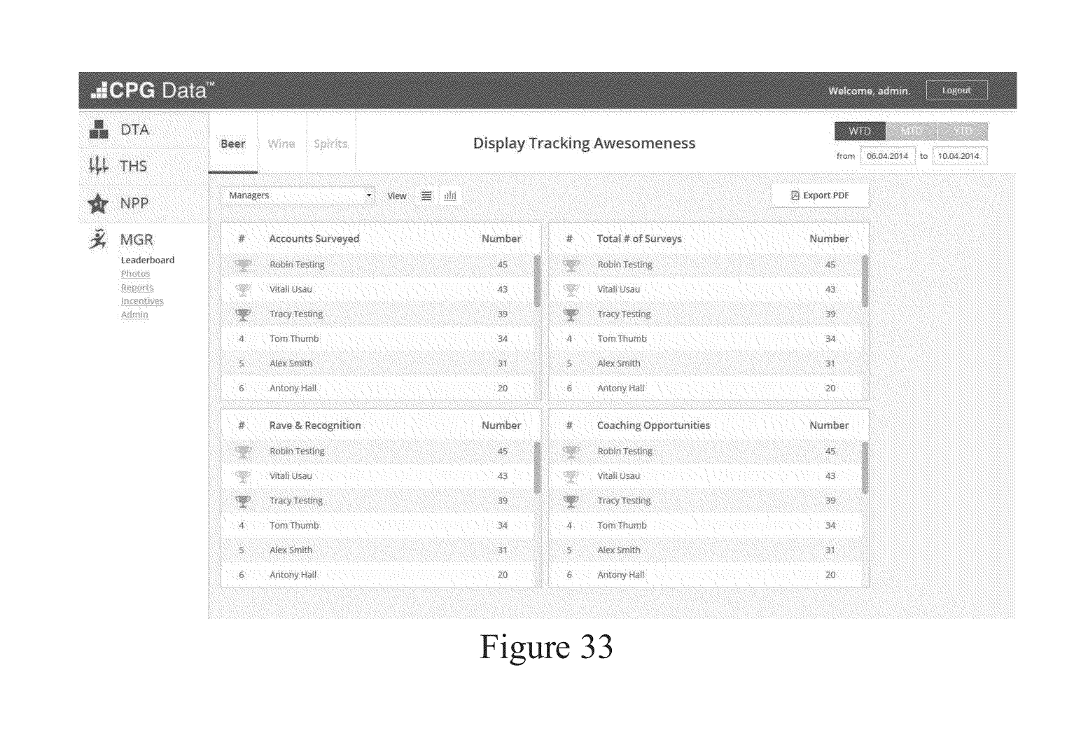

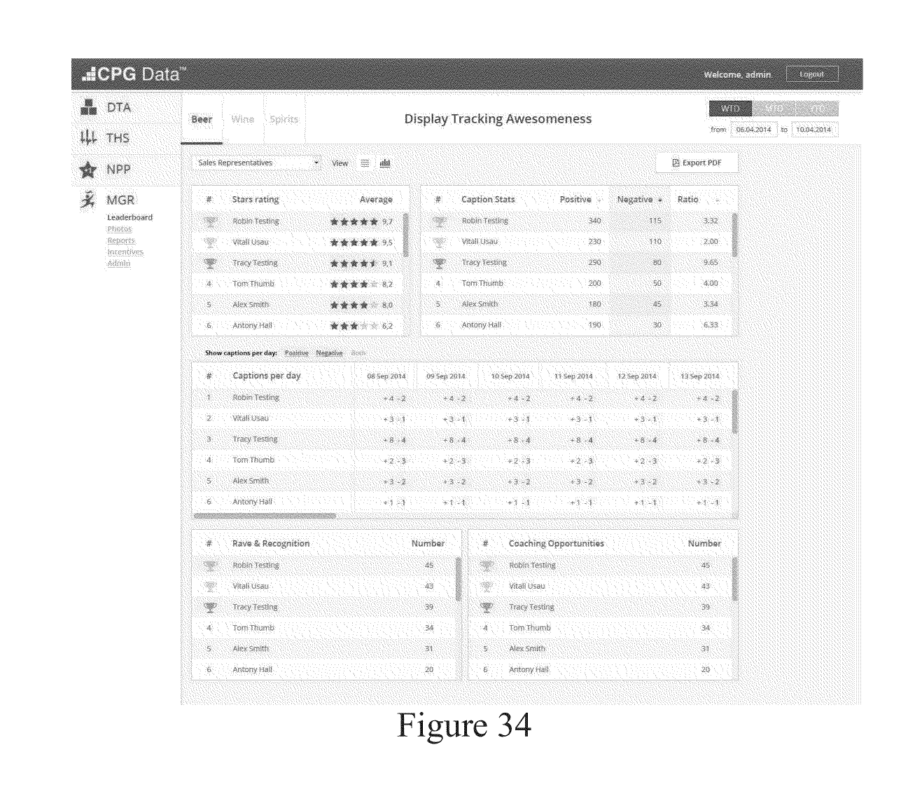

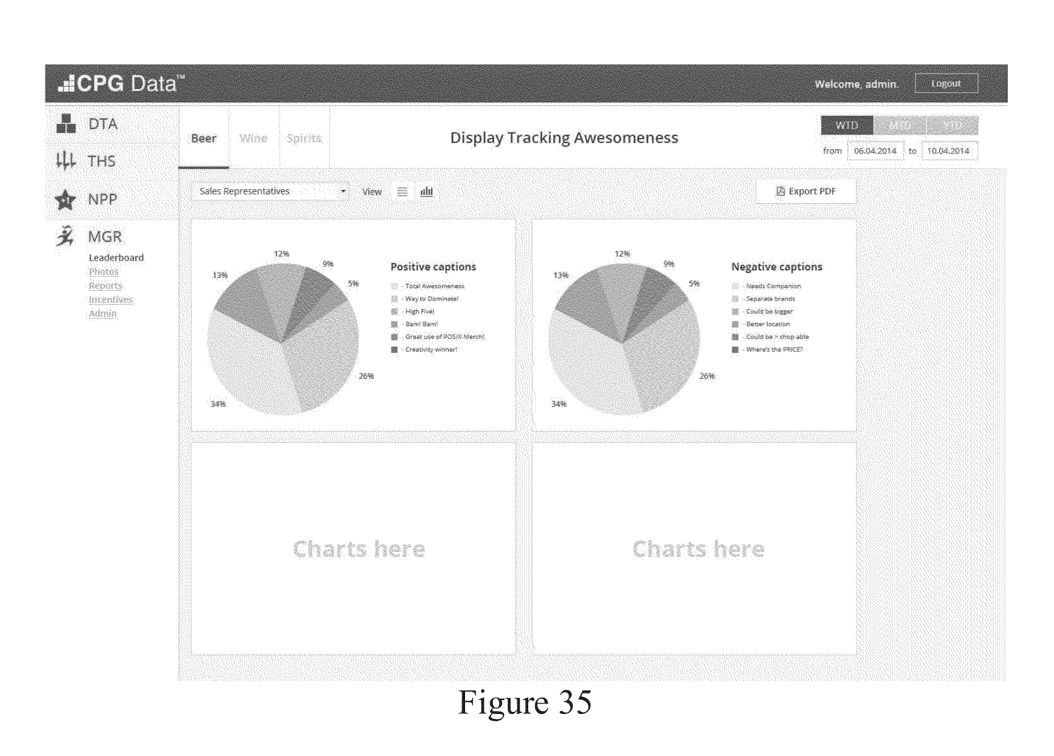

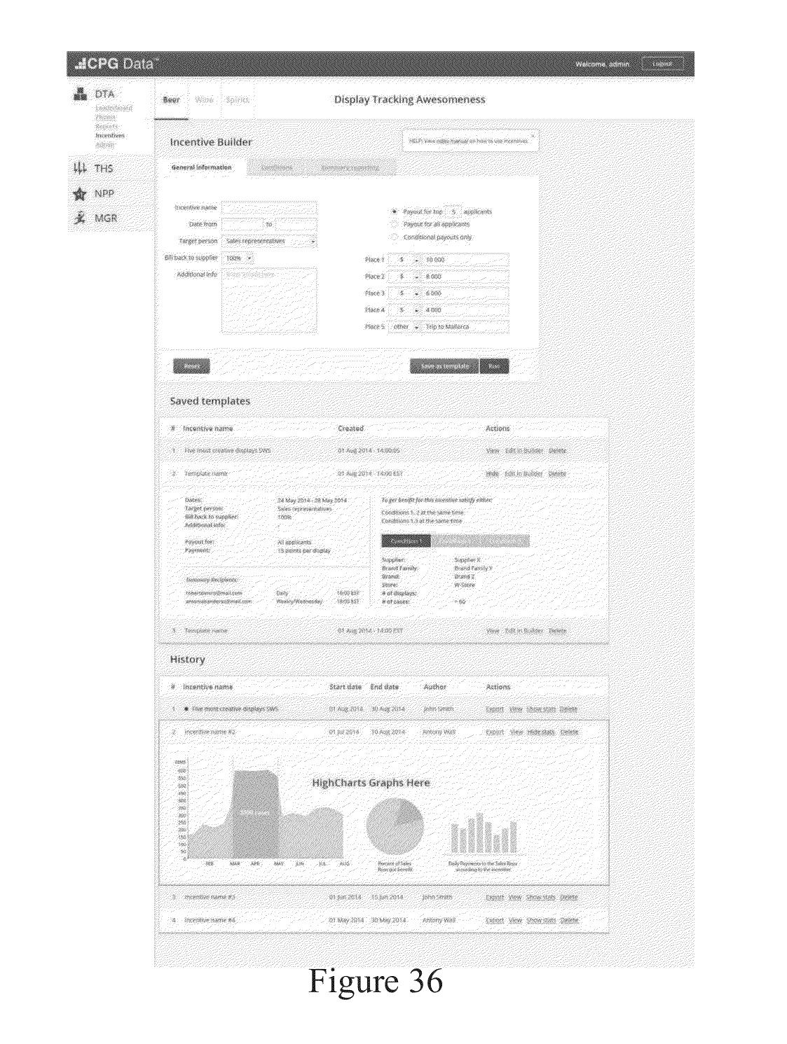

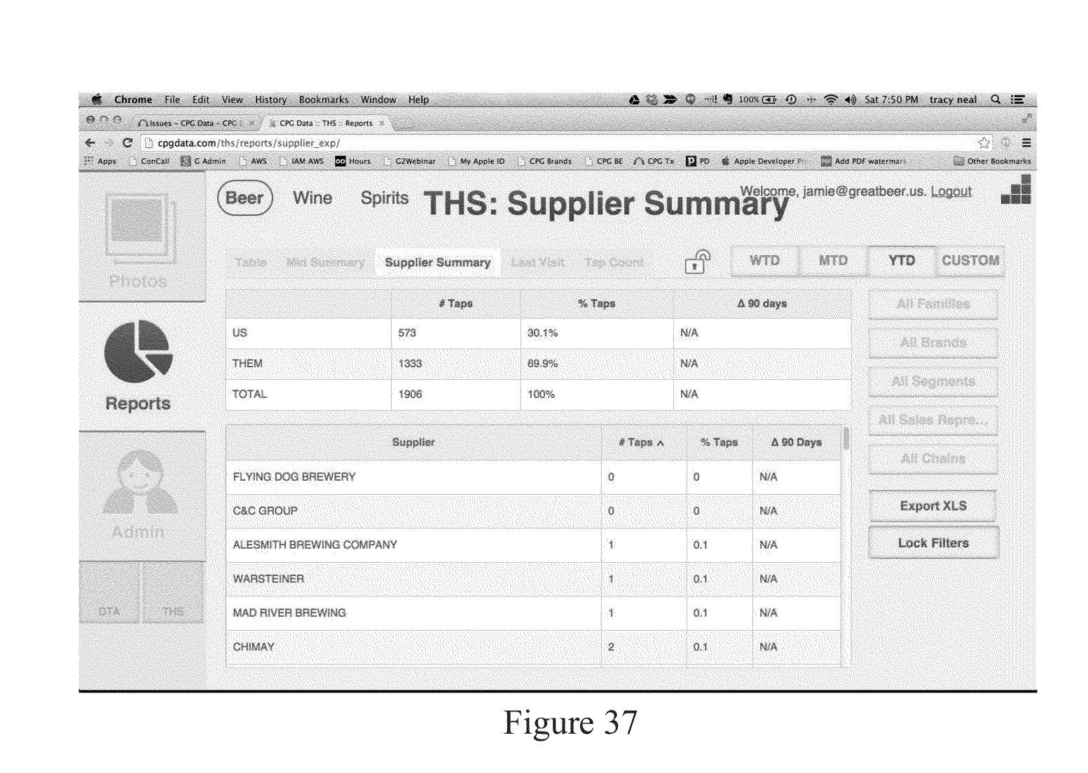

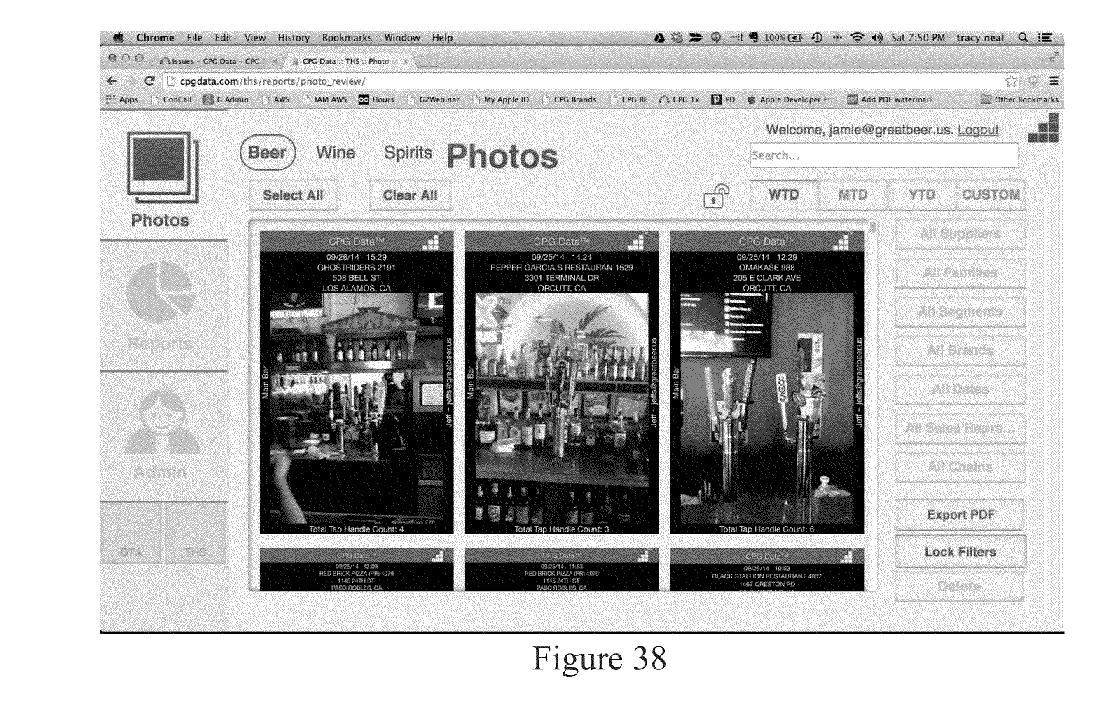

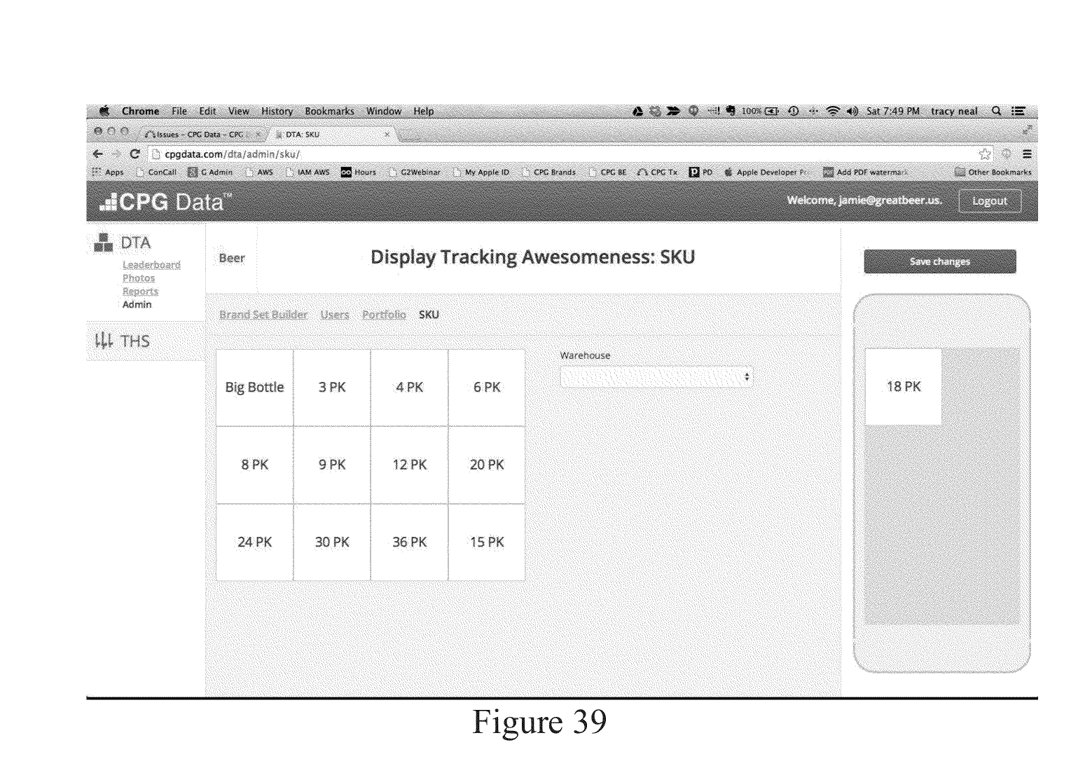

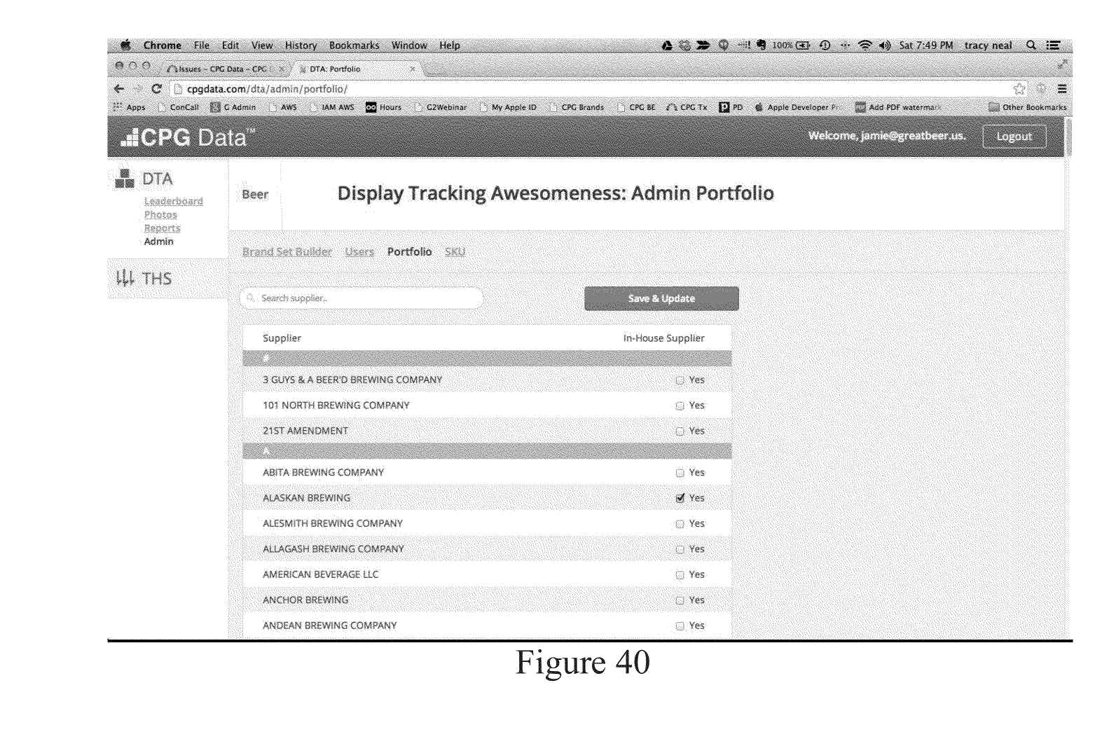

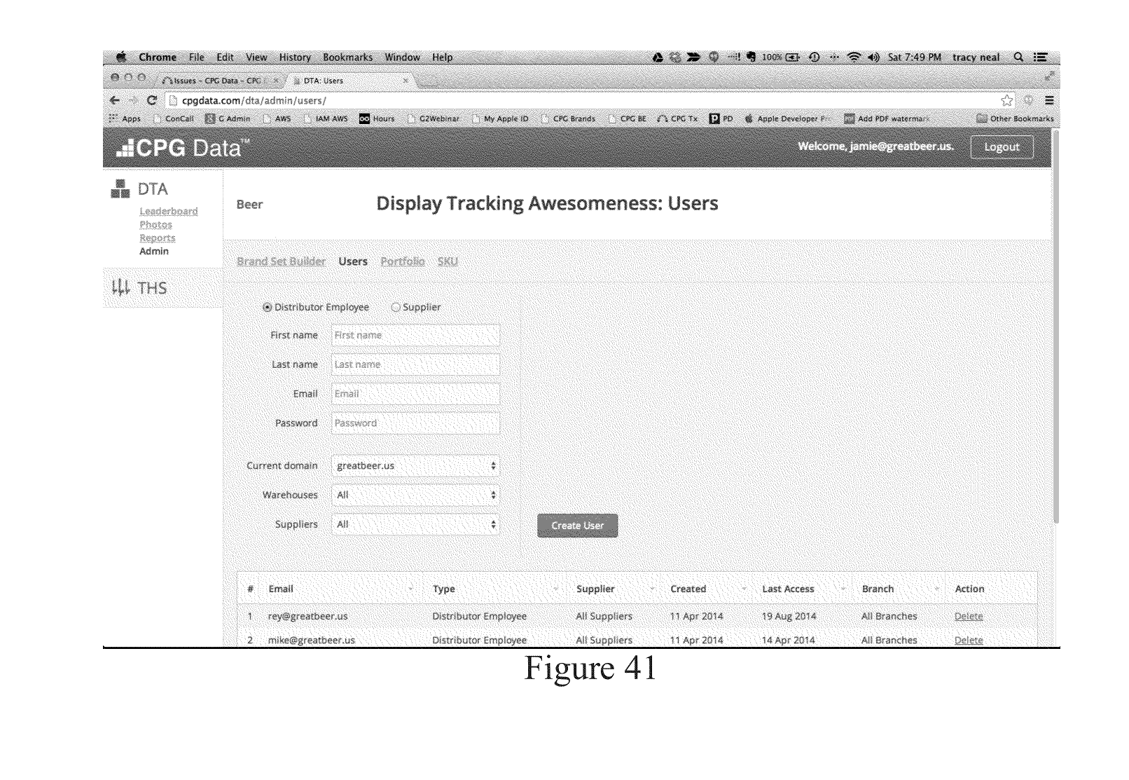

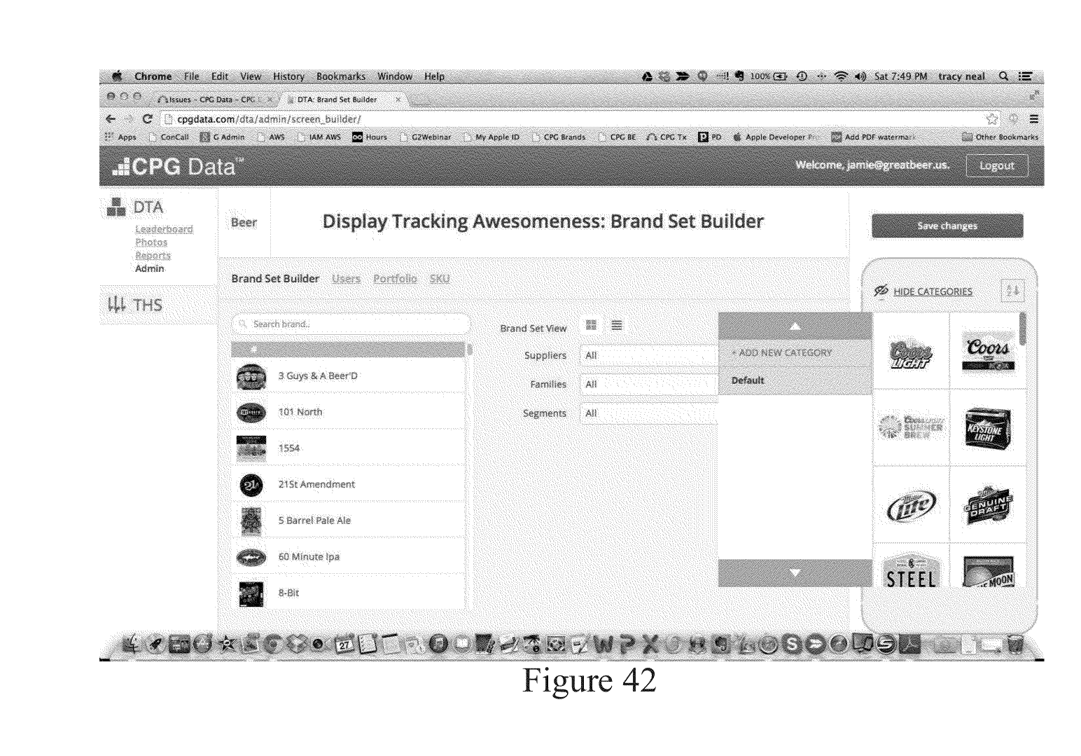

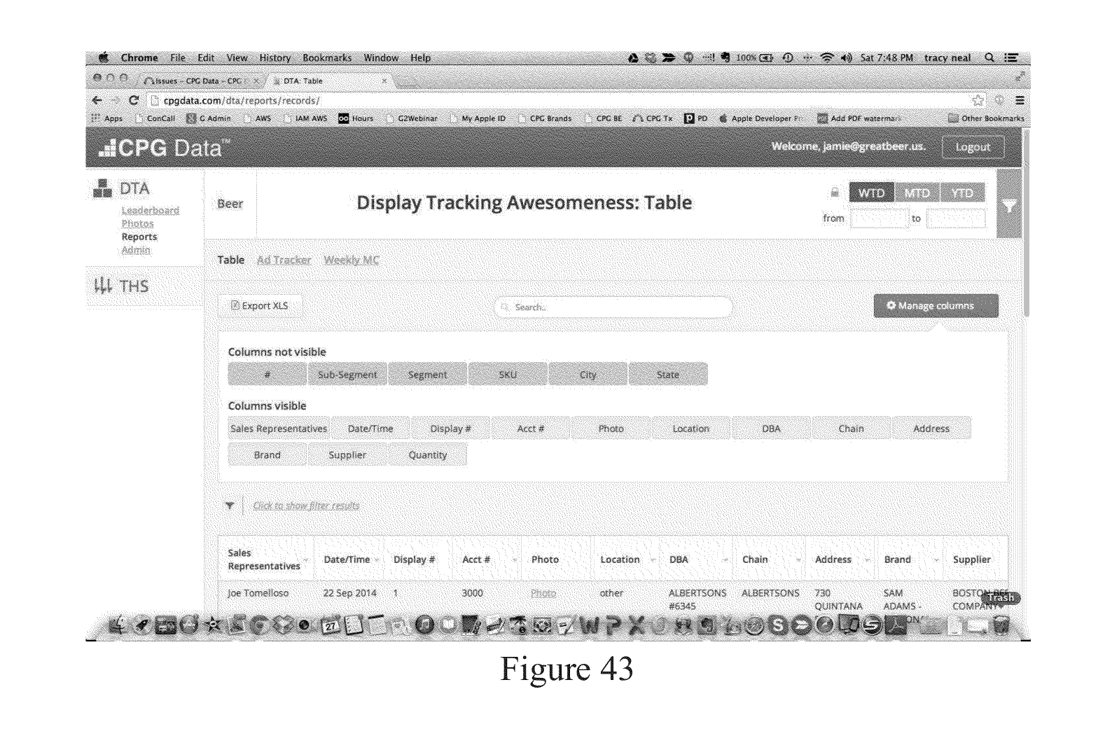

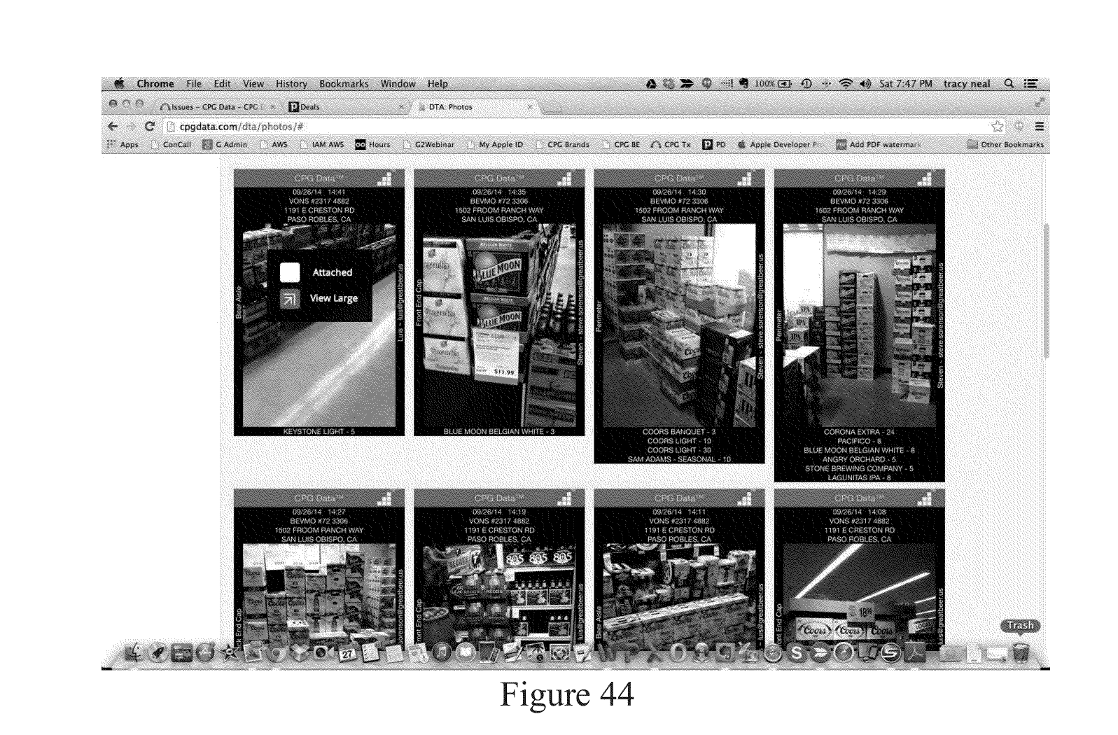

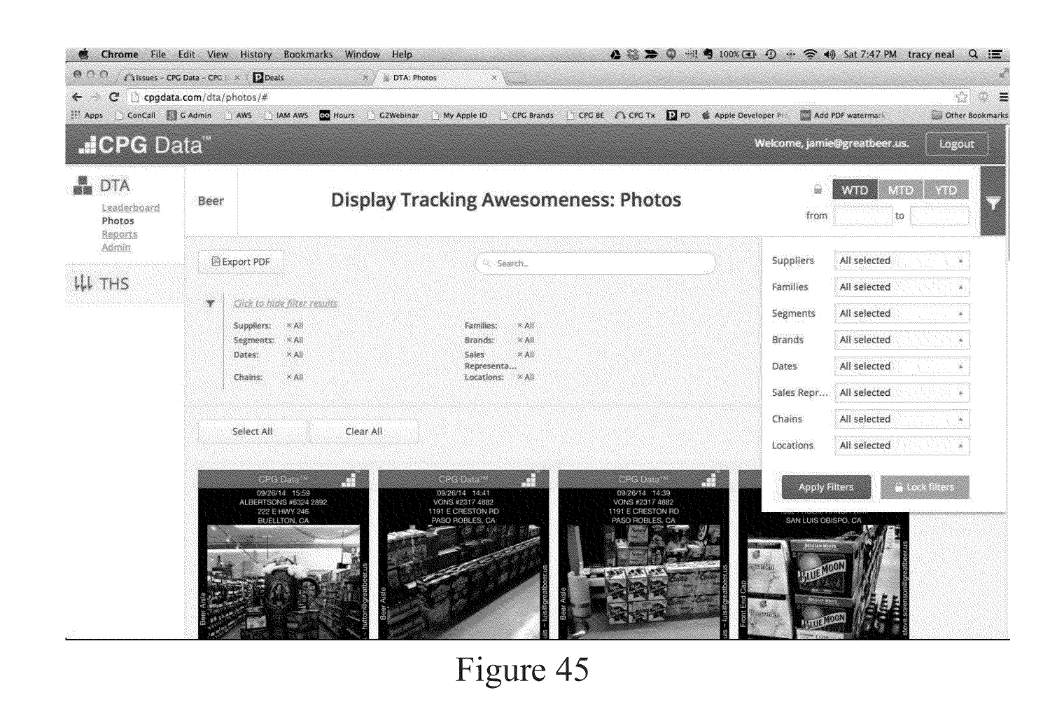

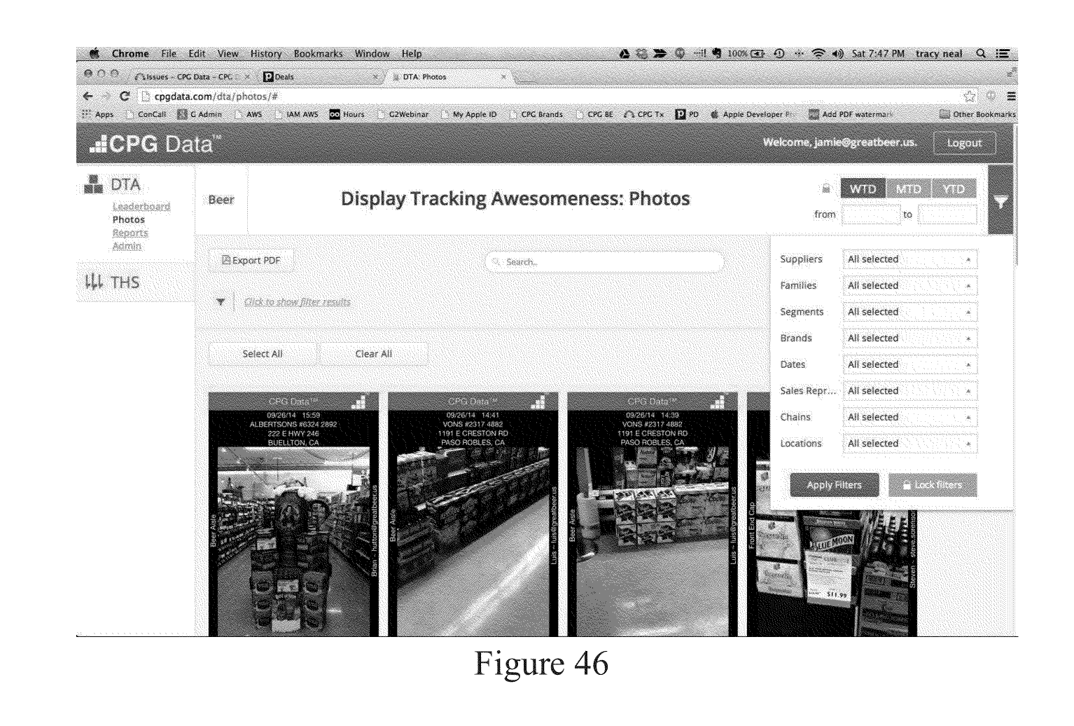

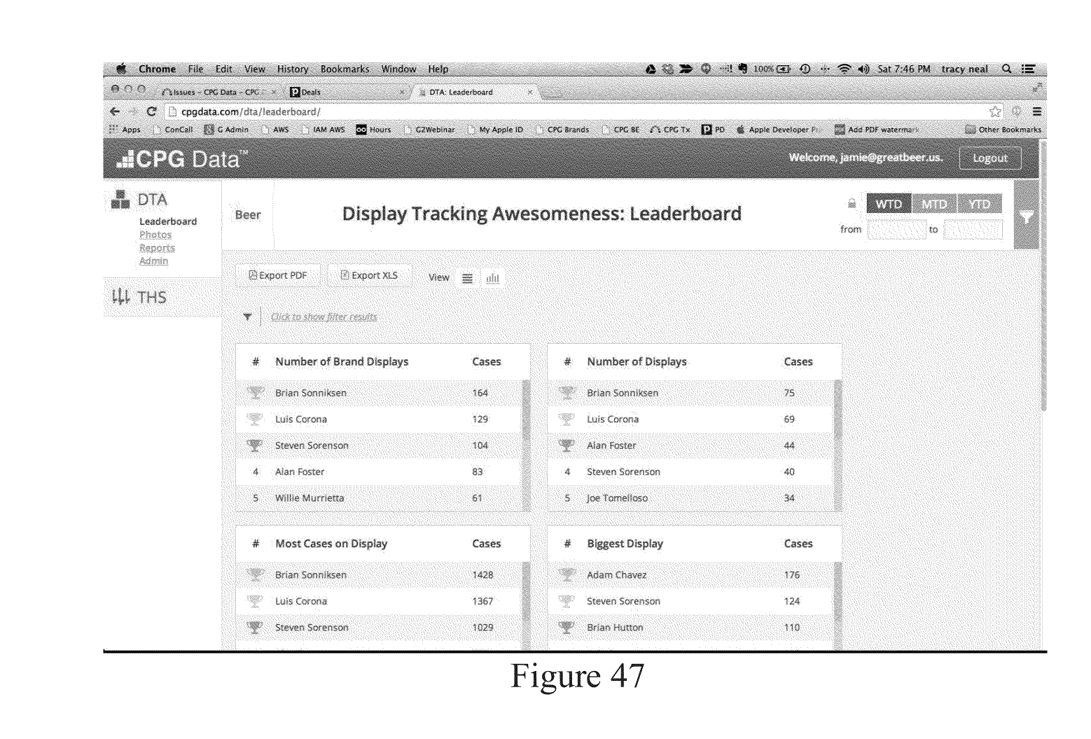

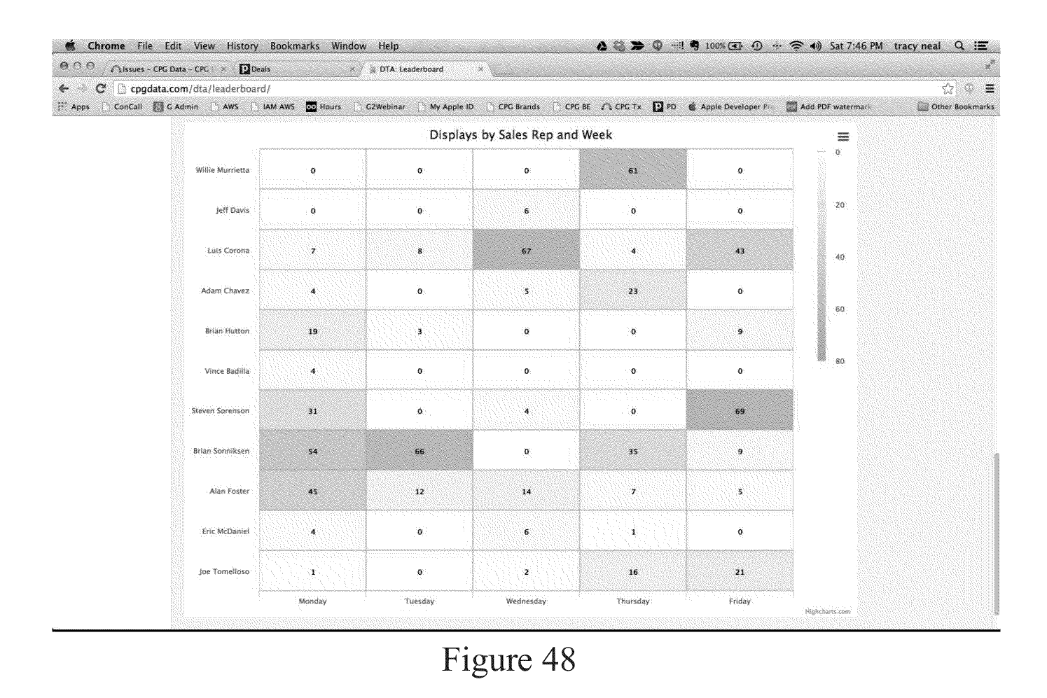

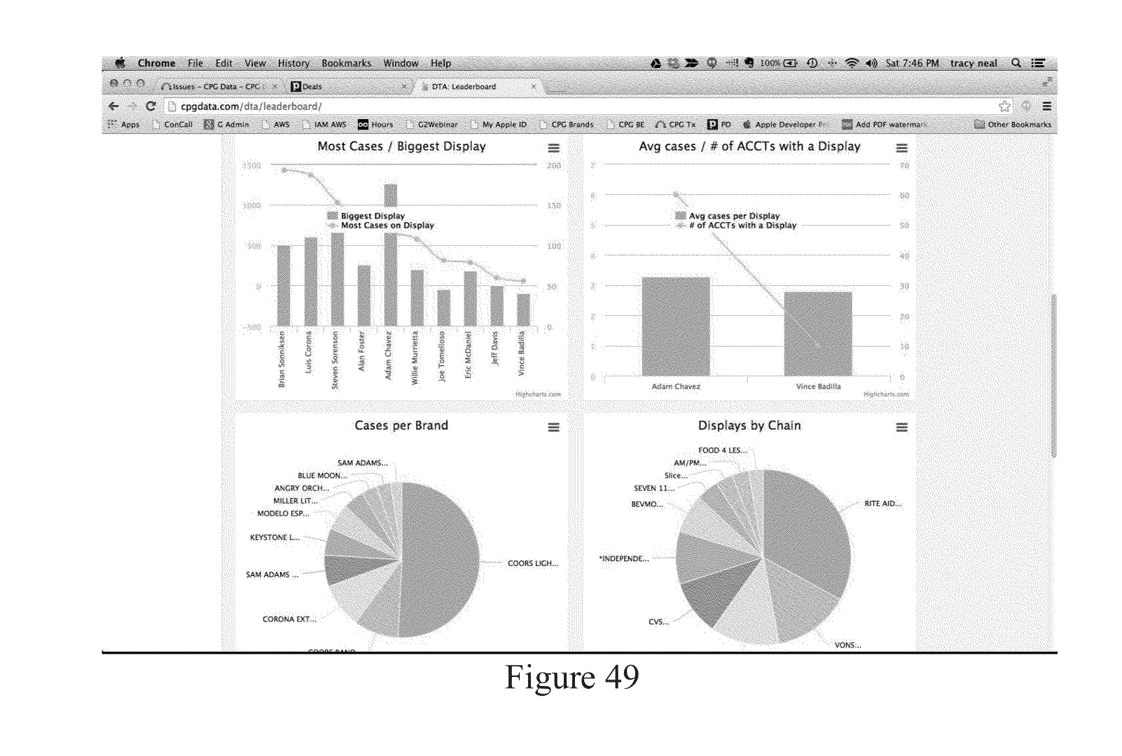

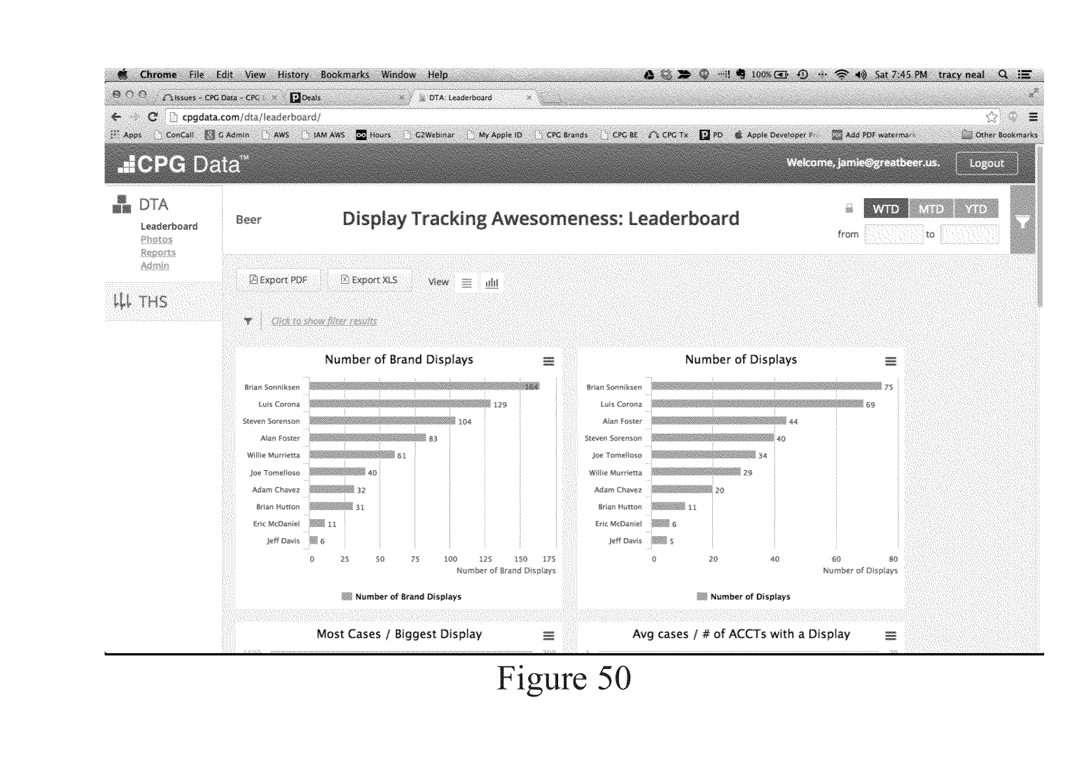

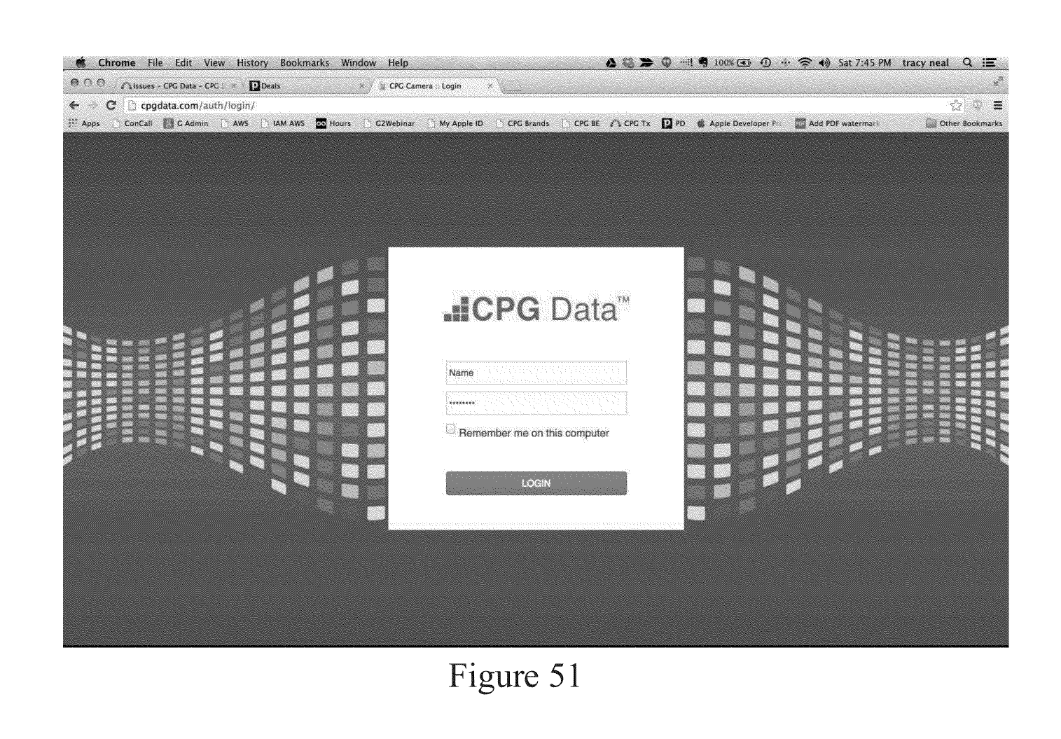

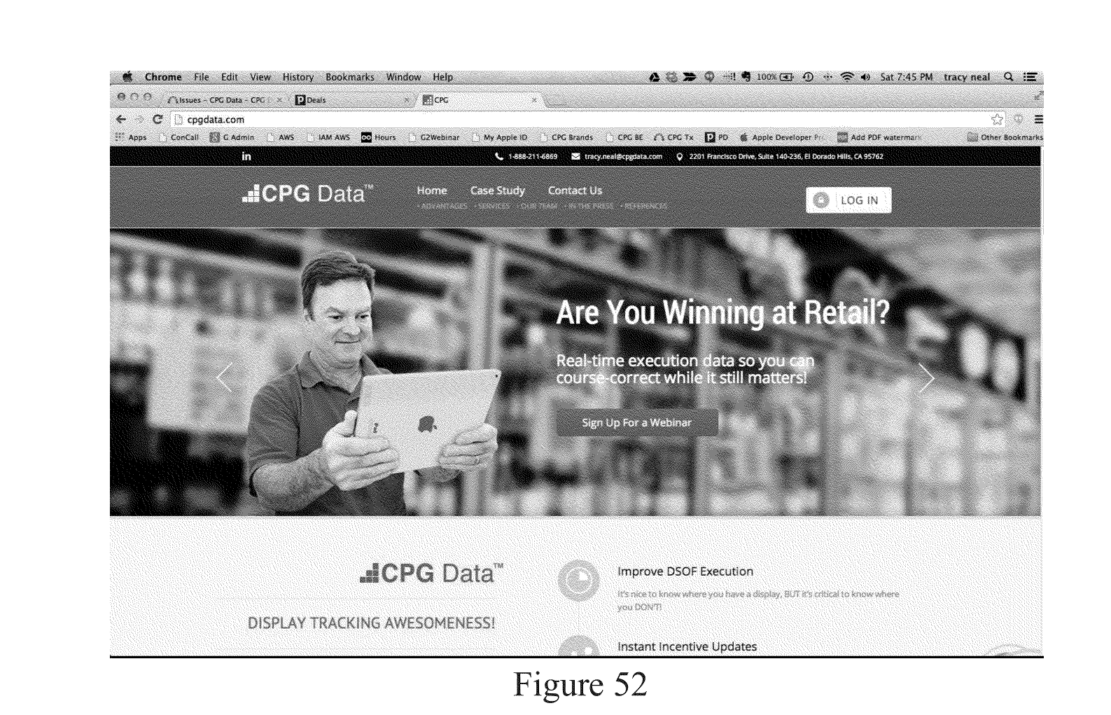

In the example embodiment described herein, the second platform of an example embodiment is the Enterprise Portal. The Enterprise Portal enables a user to access the secure cloud server database 103 from any networked location using any of a variety of computing devices. In general, the Enterprise Portal provides secure, password entry-only access for host customers. The Enterprise Portal is a dedicated and secure web portal for sharing, analyzing, and trending, retail activity. The Enterprise Portal also provides a variety of view of the product sales activity metrics as captured and processed in an example embodiment. Referring now to FIGS. 22 through 52, an example embodiment of the Enterprise Portal is illustrated.

As described above with reference to FIG. 1, the product sales activity execution tracking system 200 of an example embodiment can include the Enterprise Portal Control Module 220. As also described above, the Enterprise Portal Control Module 220 can be used in a hosted configuration with a user of a client device or downloaded in whole or in part to a client device of a user platform 141. The hosted or downloaded Enterprise Portal can be used on the client device by a user.

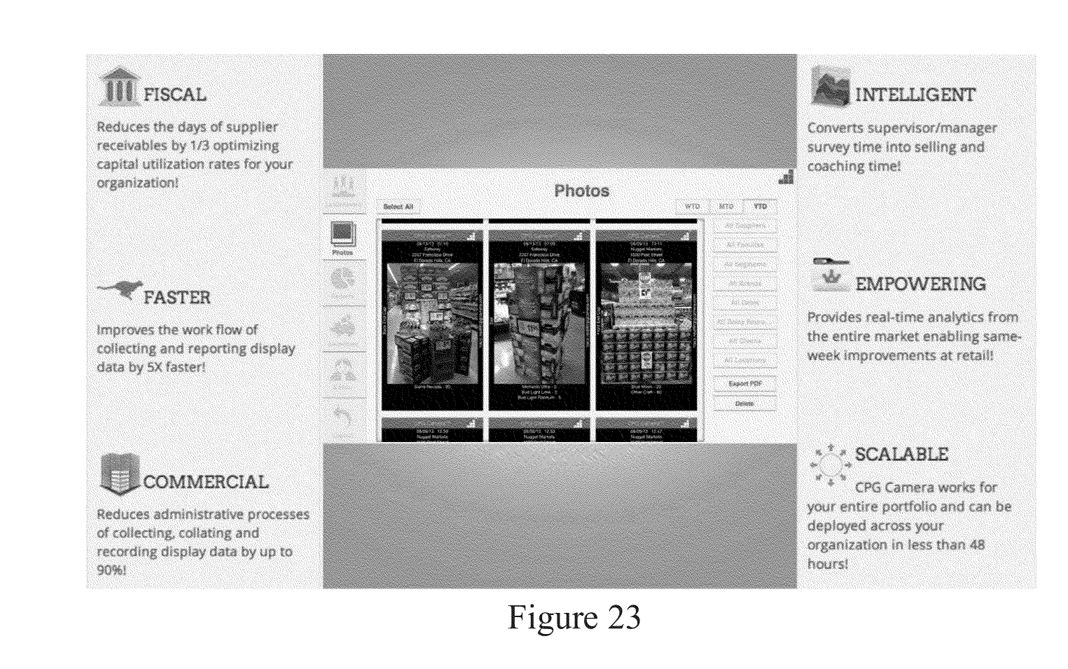

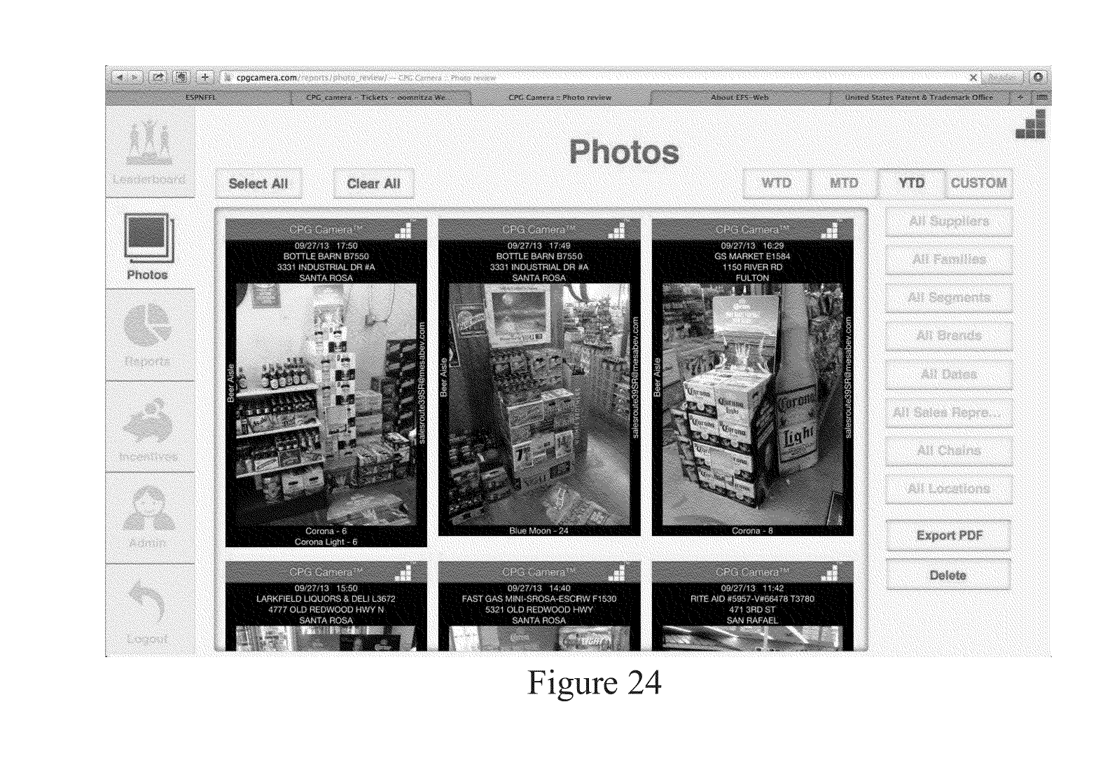

In a particular embodiment, a customer or other user can use a computing device (e.g., any of user platforms 141) to visit a webpage associated with the Enterprise Portal. An initial page, such as webpage shown in FIG. 22, can be presented to the user by the Enterprise Portal software. Once the customer or user is on the Enterprise Portal site, the customer or user can navigate the site to a main page, such as the page shown in FIGS. 23 and 24. On the main page, customers or users have among the following options to navigate the Enterprise Portal. These options are described below.

Referring now to FIGS. 24, 25, and 27 in the upper right corner, four buttons provide the time filtering options of WTD (week to date), MTD (month to date), YTD (year to date), and Custom. Once the Custom button is selected, two white boxes appear to the right where the user may select a custom date range for filtering. These filtering options can be used to customize the presentation of photos and data in data record displays and reports based on time/date stamps.

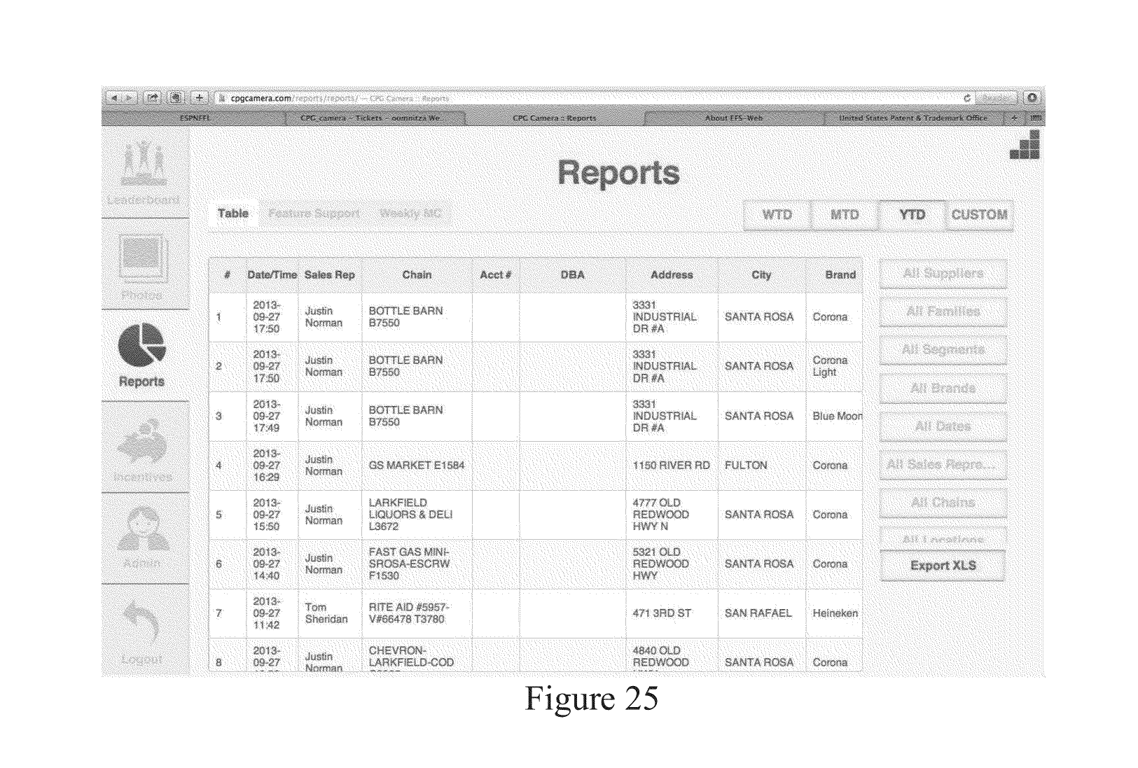

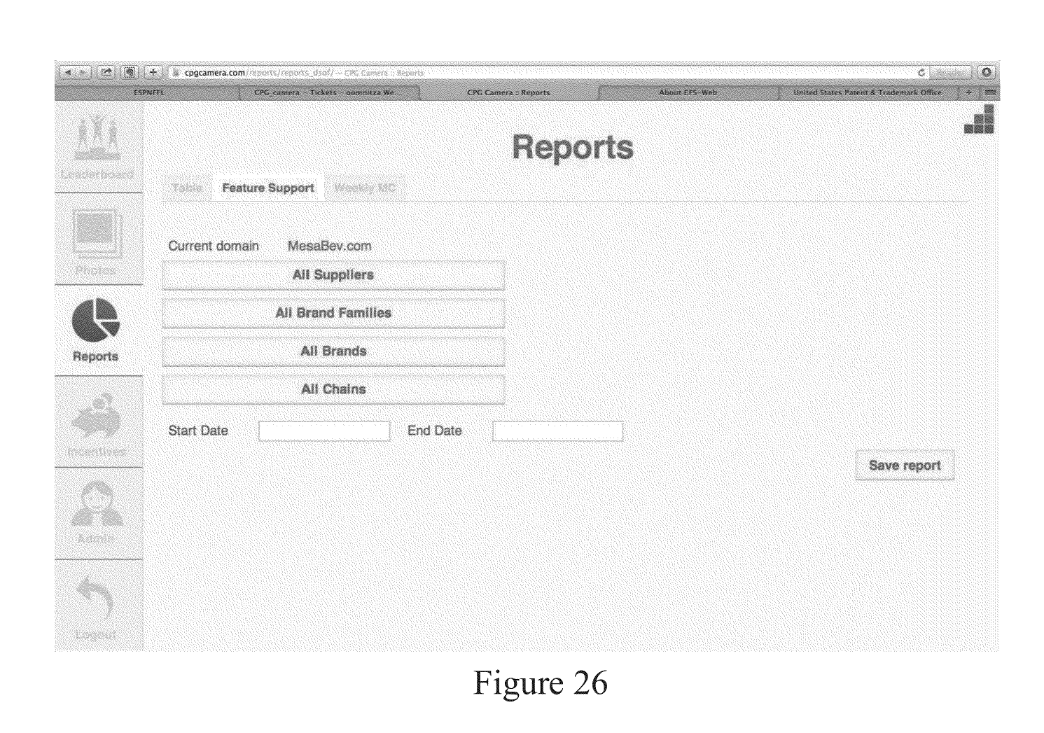

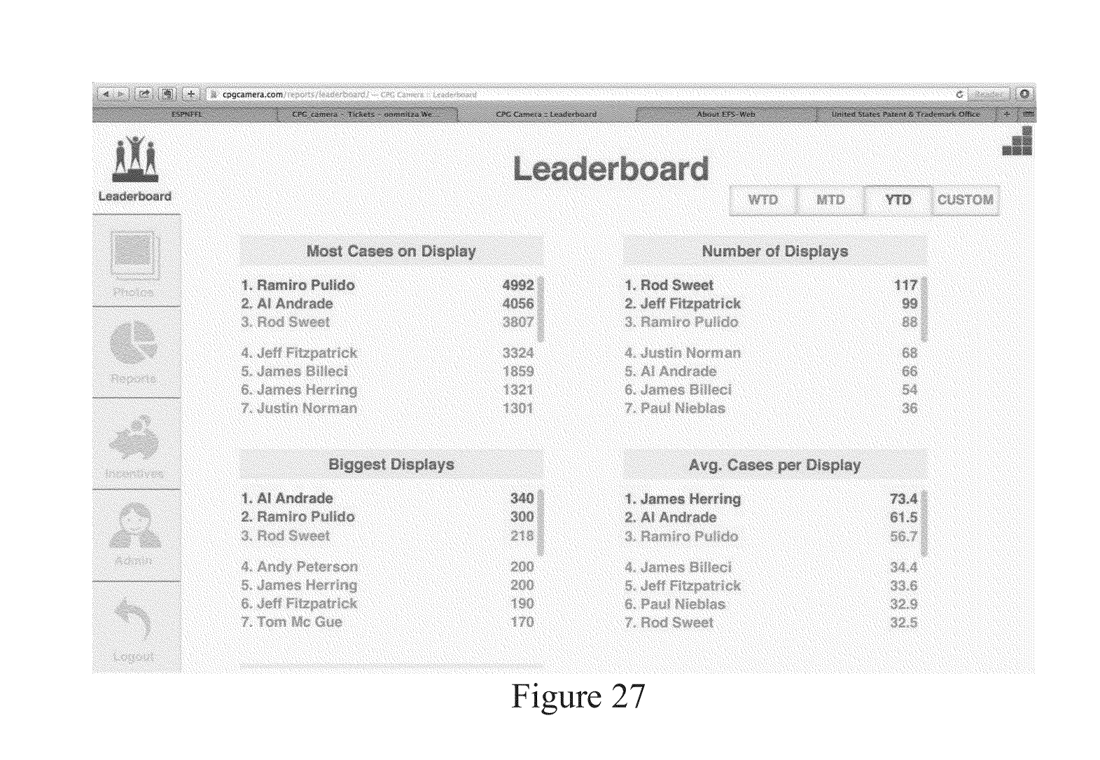

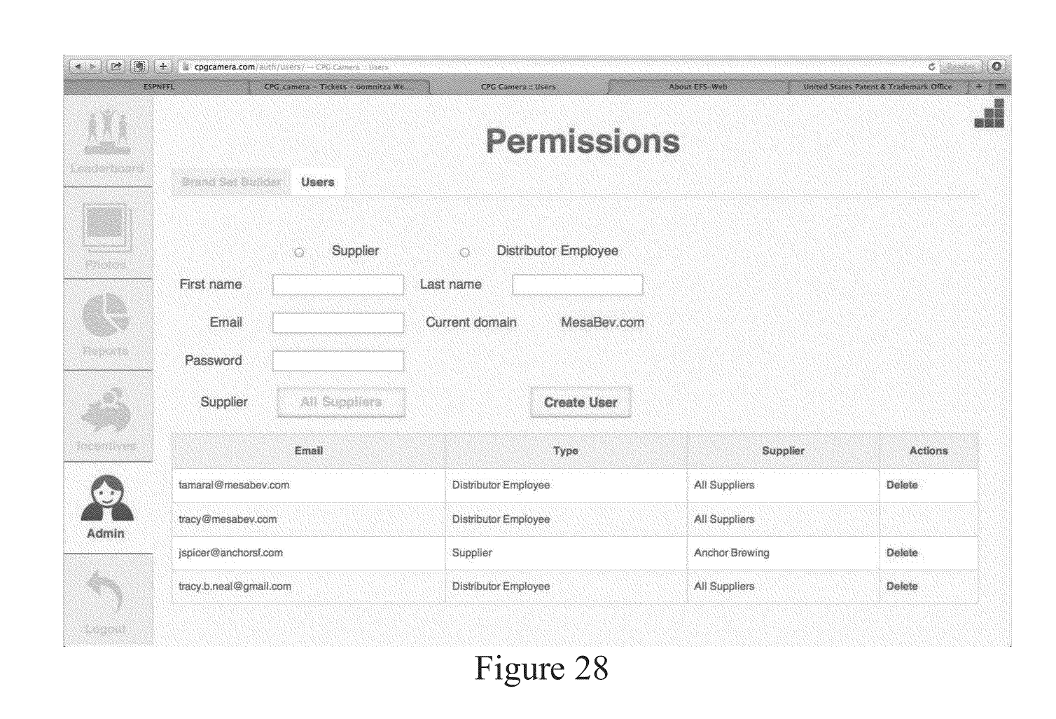

In an example embodiment shown in FIGS. 24 through 28, several buttons down the left side of the webpage are shown with icons representing a variety of feature options for the user to select. These feature options are described below.
1. “Leaderboard”—Provides vertical scroll box summaries of sales rep report parameters that are ranked by a specific parameter. An example of the Leaderboard data presentations of an example embodiment is shown in FIG. 27.
2. “Photos”—Provides a single large vertical scrollable window of three photos across and infinite photos up/down, from most recent at the top to oldest photo at the bottom. Upon hovering on a photo, there are two icons that pop up, “Attach” or “View Large”. The Attach button selects the current photo for either deletion or export. The View Large button launches a new browser window for a larger view of the current photo. There are eight parameter filters down the right side of the page, each parameter filter associated with a universe of options available for each record. There is also a Delete button and an “Export to PDF” button, which exports the attached photos to a PDF report slide show of one photo per page. An example of the Photos data presentations of an example embodiment is shown in FIGS. 23 and 24.
3. “Reports”—Provides all of the record data parameters in a table format without the related photo. The same parameter filters described above are available down the right side of the page. Data is provided in three views or tabs: Table, Feature Support, and Weekly MC (MillerCoors). The Table view provides raw data for export or filter. The Feature Support view provides special filters for specific performance measures associated with feature performance at the retail level. The Weekly MC view provides a data report specific to tracking brand activity for MillerCoors, a supplier that requires such a report for 50% of the potential customer base. An example of the Reports data presentations of an example embodiment is shown in FIGS. 25 and 26.
4. “Incentives”—Similar to a Fantasy Football setup, this page allows a user to create a short cut button that will execute a report associated with a complex set of user-identified parameters.
5. “Admin”—Brand Set Builder—Allows the administrative user of a customer to “drag and drop” product brands from a product brand library to a mock mobile device. These product brands can be more easily found by selecting filters associated with segments, suppliers, or search. The Admin feature also allows the administrative user of the customer to create or delete restricted and secure password access to their secure portal (e.g., see FIG. 28). The administrative user has the option of allowing limited access to only one supplier brand set.
6. “Logout”—Enables logout from the Enterprise Portal.

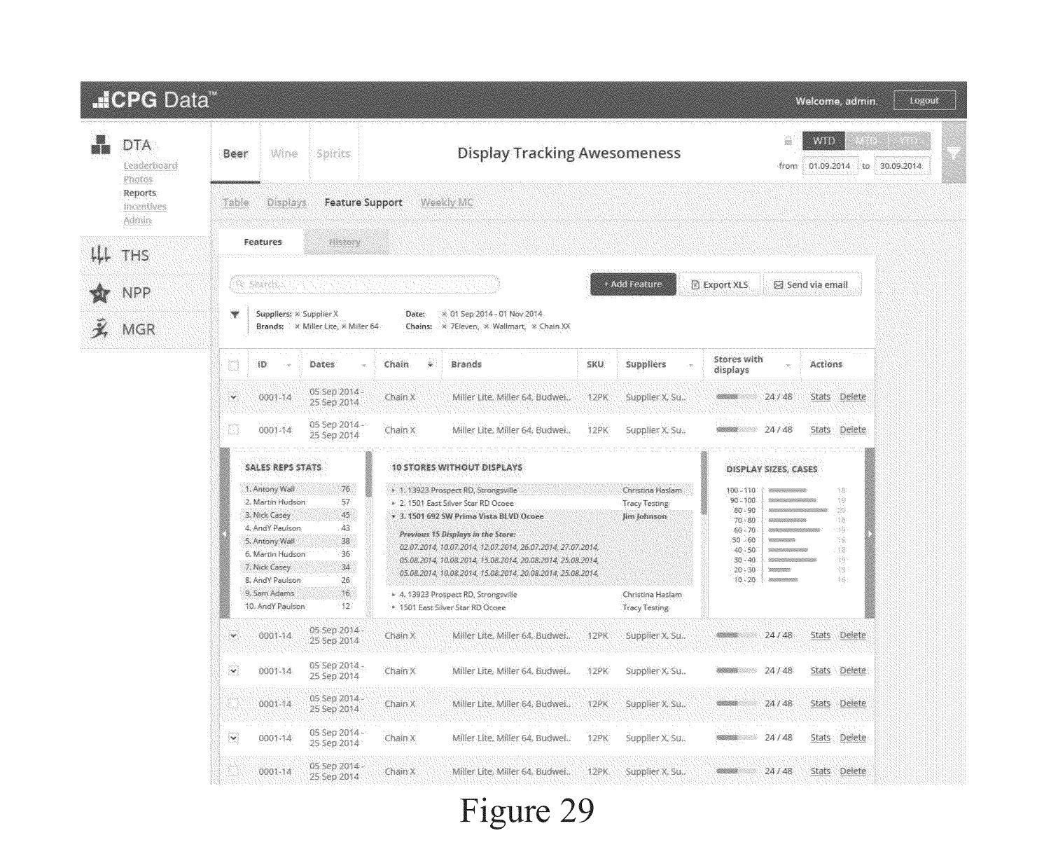

The Enterprise Portal provides a variety of views of the product sales activity metrics as captured and processed in an example embodiment. FIGS. 29 through 52 of an example embodiment illustrate examples of the various views of the sales activity metrics.

The product sales activity execution tracking system 200 of an example embodiment can include a user account management module. The user account management module can be used to create and maintain a user account on the host site 110. The user account management module can also be used to configure user settings, create and maintain a user/user profile on host site 110, and otherwise manage user data and operational parameters on host site 110. In the example embodiment described herein, a user can register as an identified user in order to share photos, information, documents, communications, or other content. The registered user can enter their name, email address, and password. Once this information is entered, a user account is created and the user can share photos, information, documents, communications, or other content.

The product sales activity execution tracking system 200 of an example embodiment can also include an administrative management module. The administrative management module can be used by an agent or administrator of the product sales activity execution tracking system 200 to manage user accounts and to manage the product sales activity execution tracking system. The administrative management module can also be used to enforce privacy protections and content controls for users. Moreover, the administrative management module can also be used to generate and/or process a variety of analytics associated with the operation of the product sales activity execution tracking system 200. For example, the administrative management module can generate various statistical models that represent the activity of the community of users and related manufacturers, distributors, retailers, agents, agent team members, affiliates, and the like. These analytics can be shared, licensed, or sold to others.

Although the various user interface displays provided by the example embodiments described herein are nearly infinitely varied, several sample user interface displays and sequences are provided herein and in the corresponding figures to describe various features of the disclosed embodiments. These sample user interface displays and sequences are described herein and in the accompanying figures. It will be apparent to those of ordinary skill in the art that equivalent user interface displays and sequences can be implemented within the scope of the inventive subject matter disclosed and claimed herein.

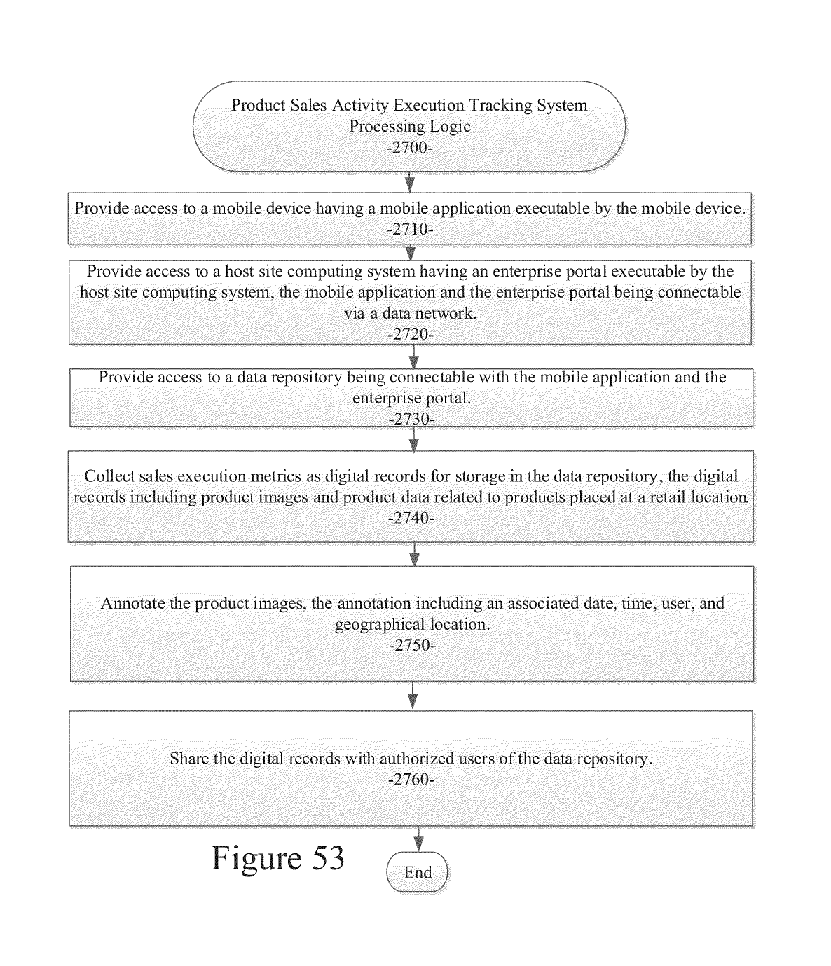

Referring now to FIG. 53, a processing flow diagram illustrates an example embodiment of a product sales activity execution tracking system 200 as described herein. The method 2700 of an example embodiment includes: providing access to a mobile device having a mobile application executable by the mobile device (processing block 2710); providing access to a host site computing system having an enterprise portal executable by the host site computing system, the mobile application and the enterprise portal being connectable via a data network (processing block 2720); providing access to a data repository being connectable with the mobile application and the enterprise portal (processing block 2730); collecting sales execution metrics as digital records for storage in the data repository, the digital records including product images and product data related to products placed at a retail location (processing block 2740); annotating the product images, the annotation including an associated date, time, user, and geographical location (processing block 2750); and sharing the digital records with authorized users of the data repository (processing block 2760).

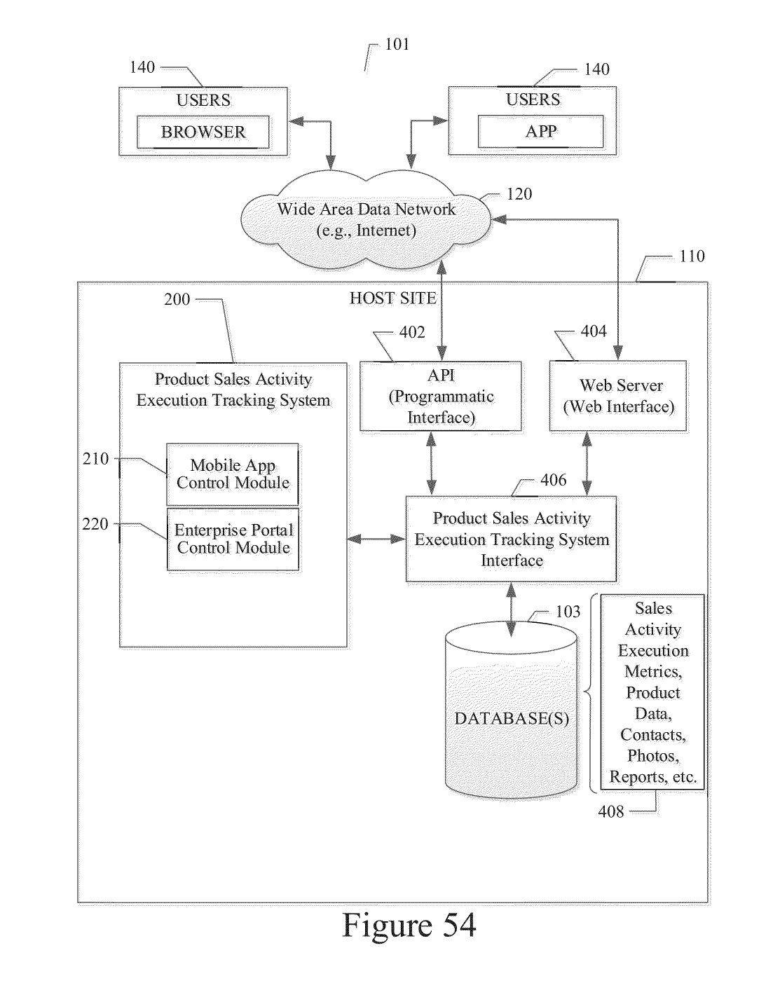

Referring now to FIG. 54, another example embodiment 101 of a networked system in which various embodiments may operate is illustrated. In the embodiment illustrated, the host site 110 is shown to include the product sales activity execution tracking system 200. The product sales activity execution tracking system 200 is shown to include the functional components 210 and 220, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the product sales activity execution tracking system 200 either directly or via an interface 406. The product sales activity execution tracking system 200 may be configured to access a data storage device 103 and data 408 therein either directly or via the interface 406.

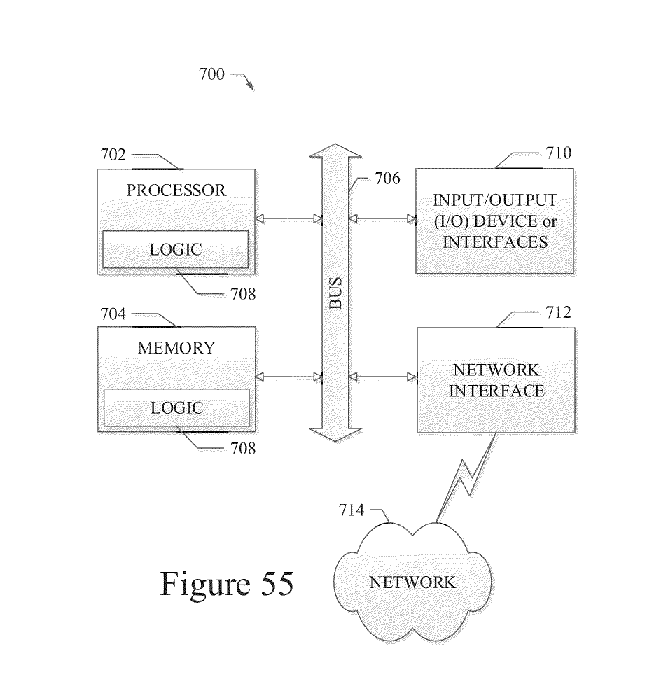

FIG. 55 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™ IEEE™ 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

### MGR: Manager's Survey

The objective of the Manager's Survey is to allow a manager/supervisor to provide immediate, constant, unbiased, fact-based feedback against sales, execution, quality, and relationship standards that they observe in the marketplace. The data/photos collected are also immediately sent to the Enterprise Portal for real-time review in reports and aggregate.

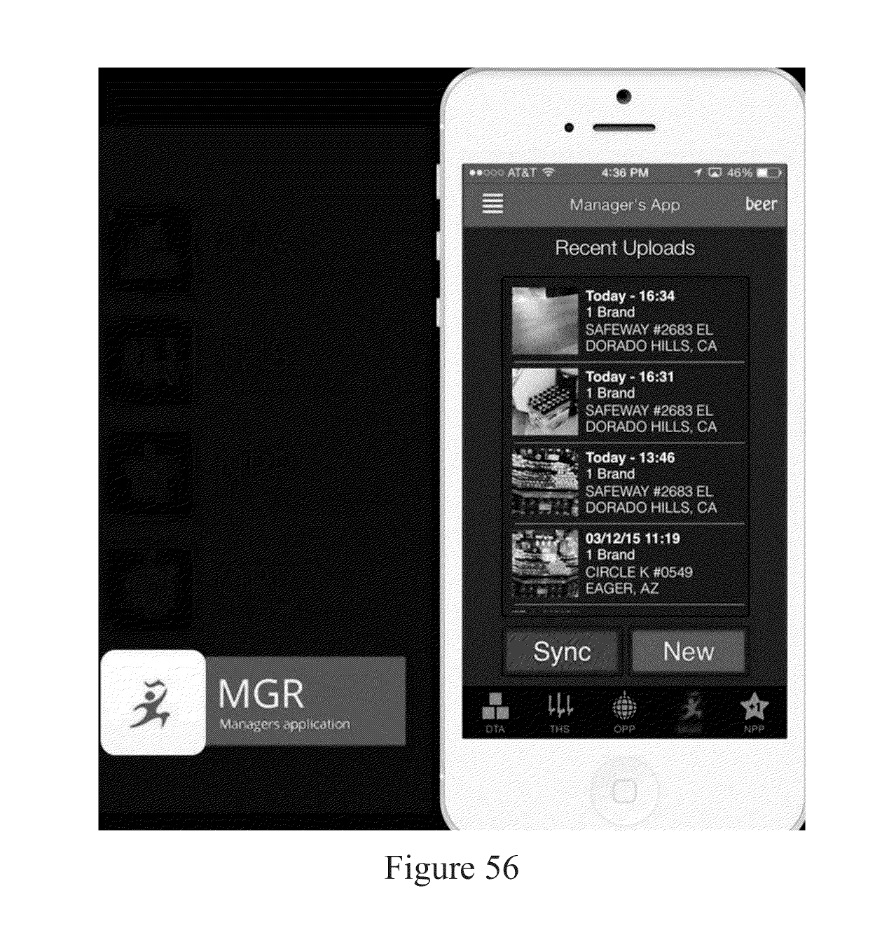

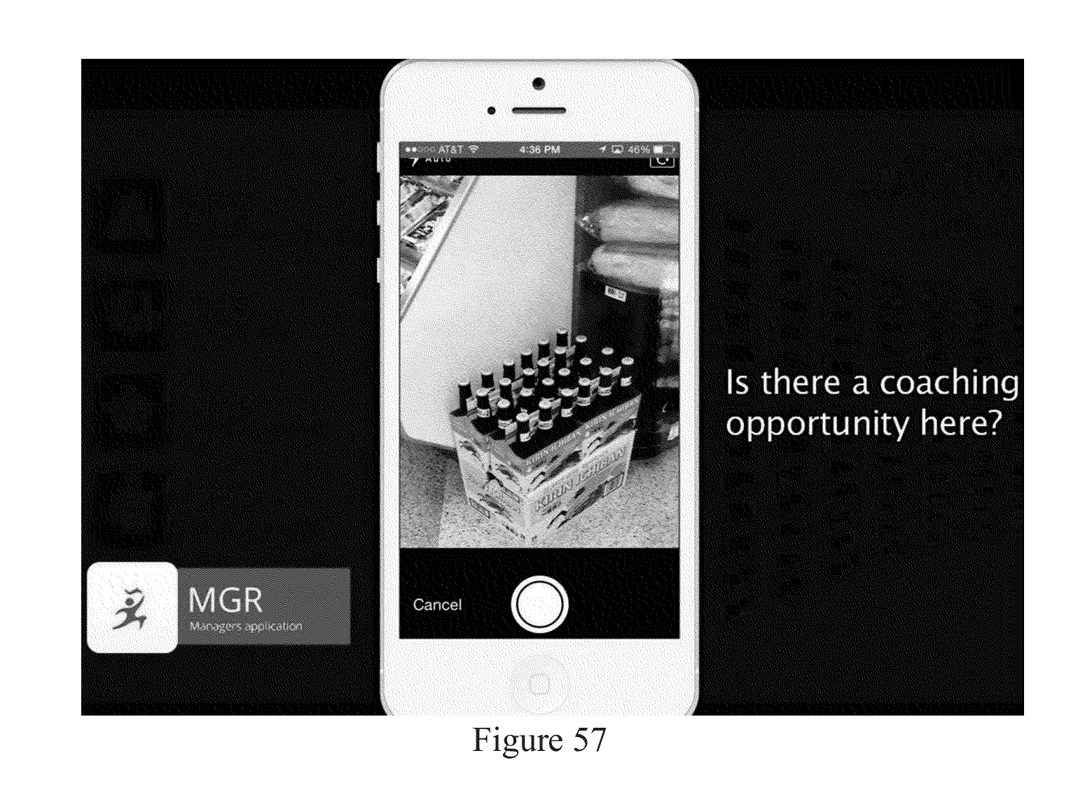

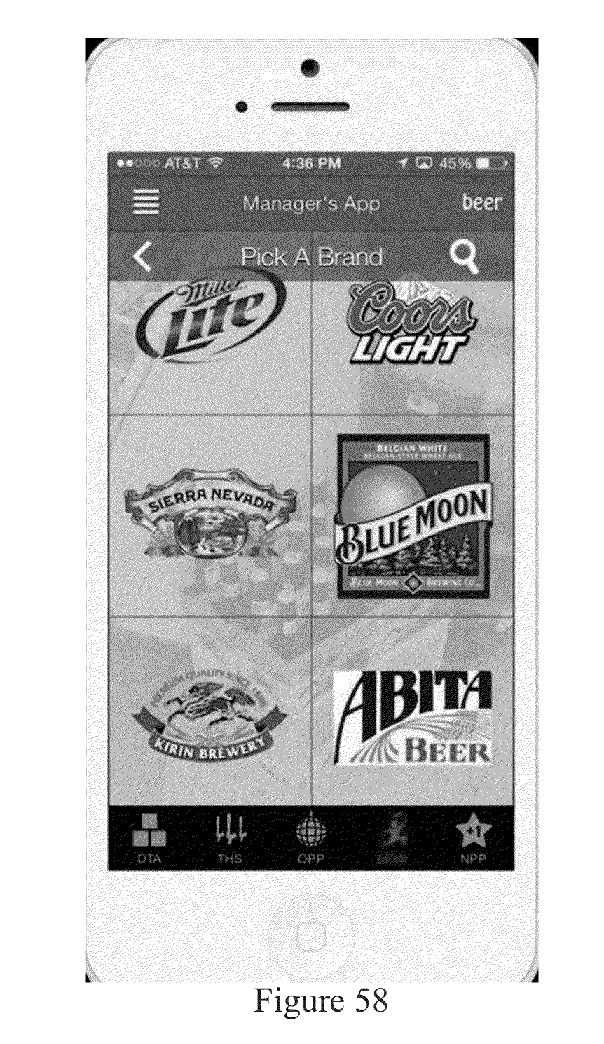

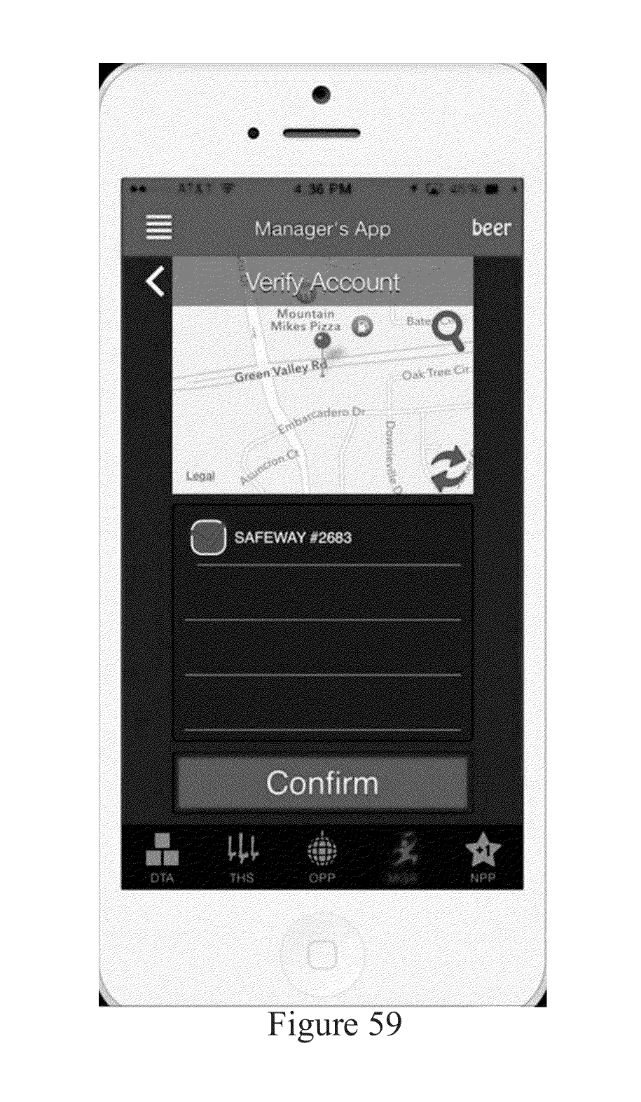

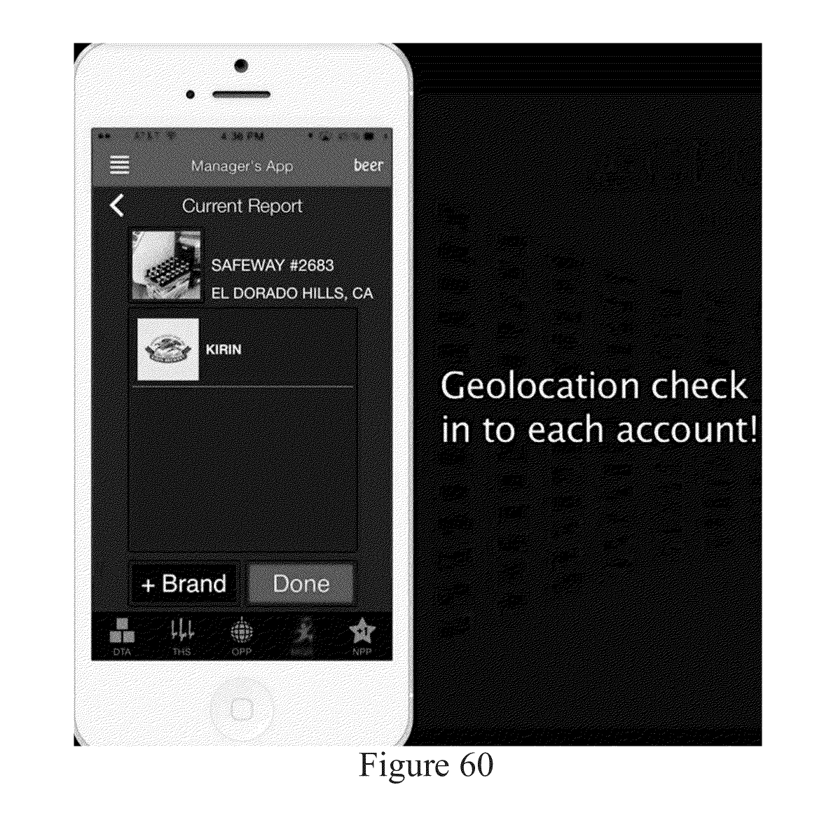

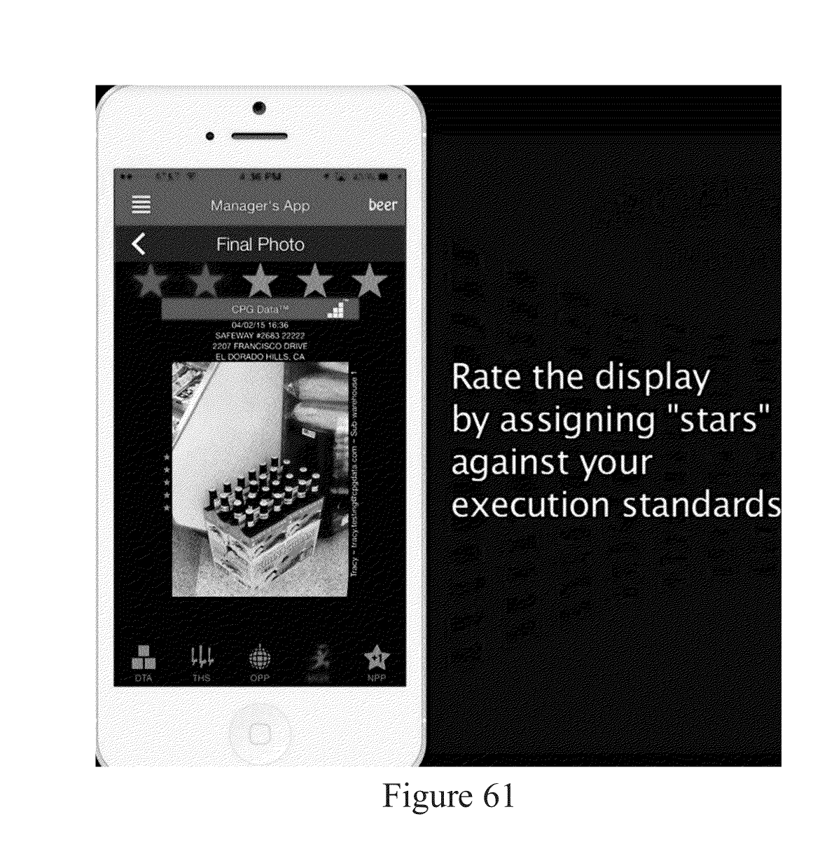

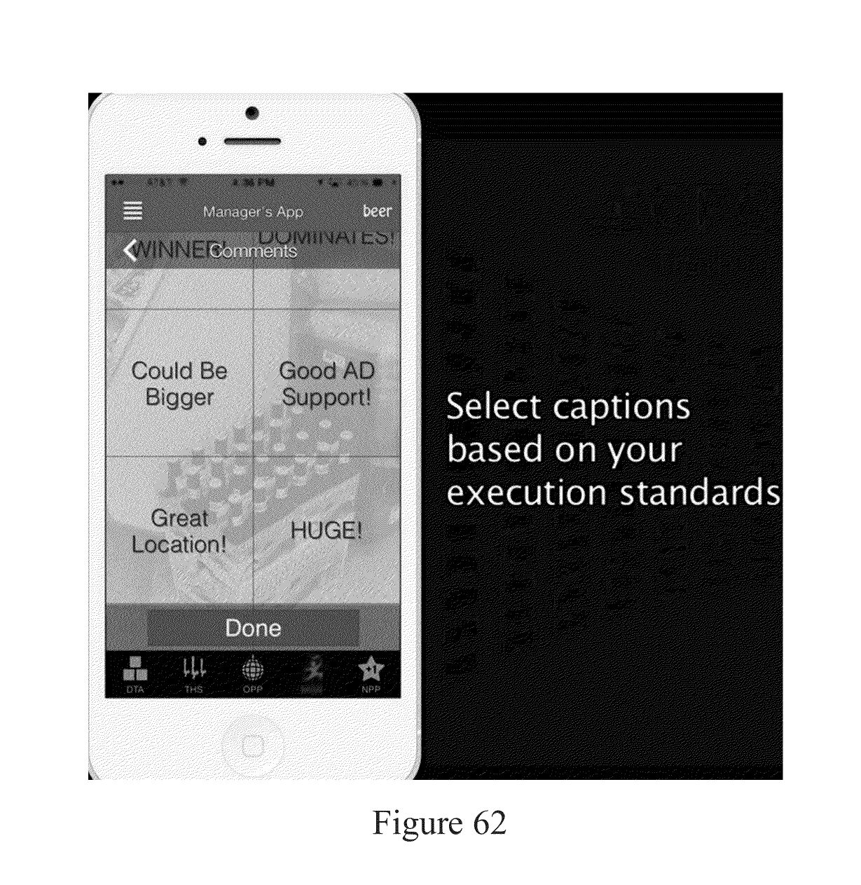

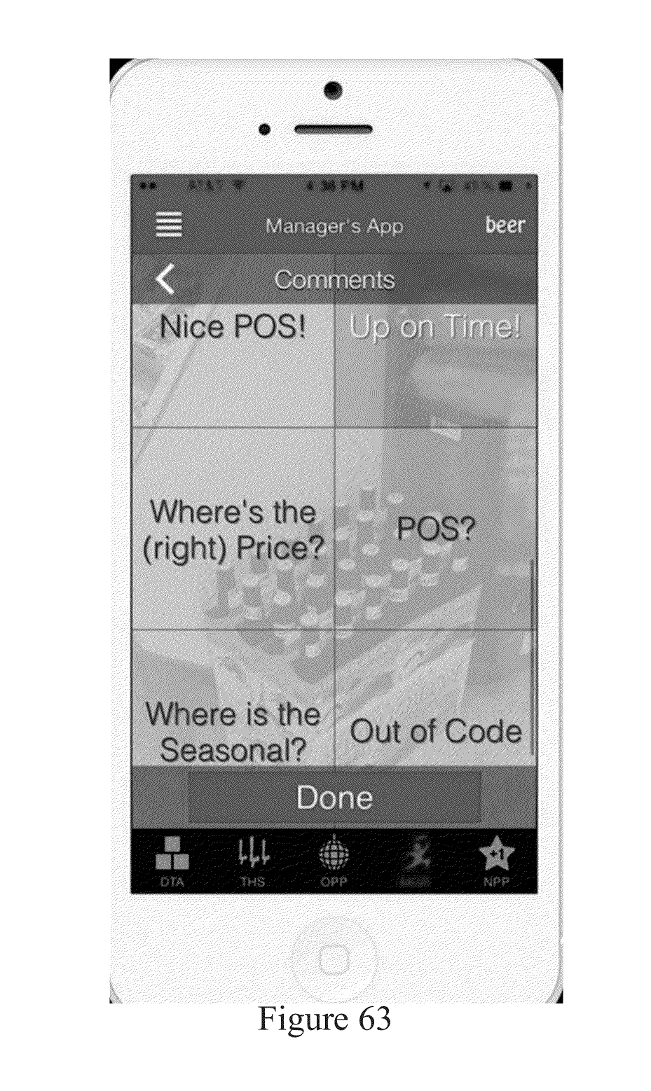

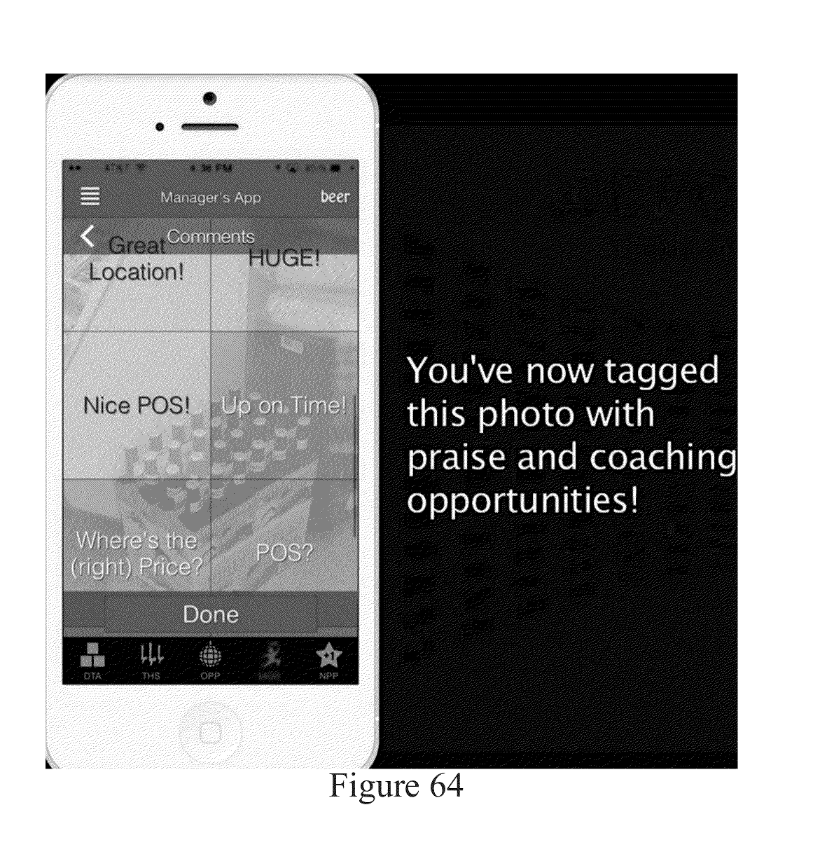

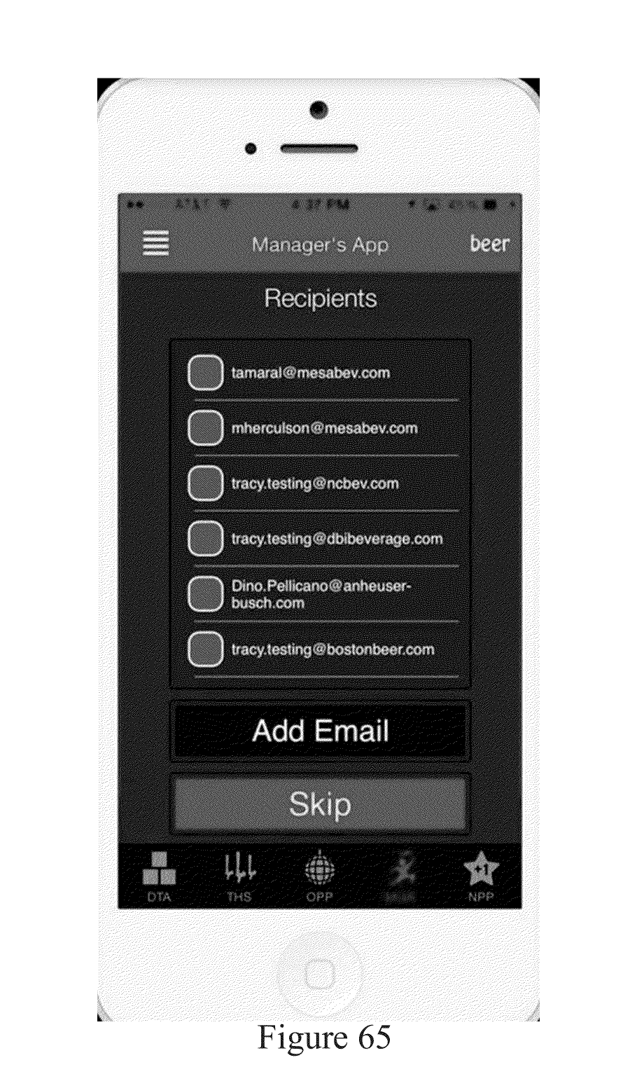

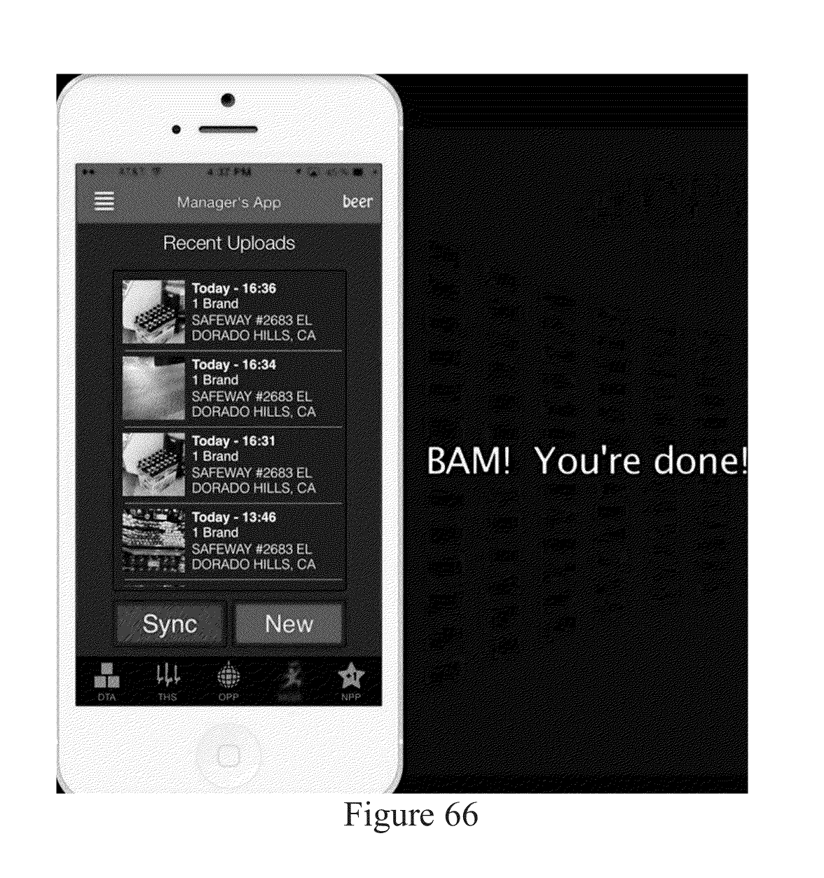

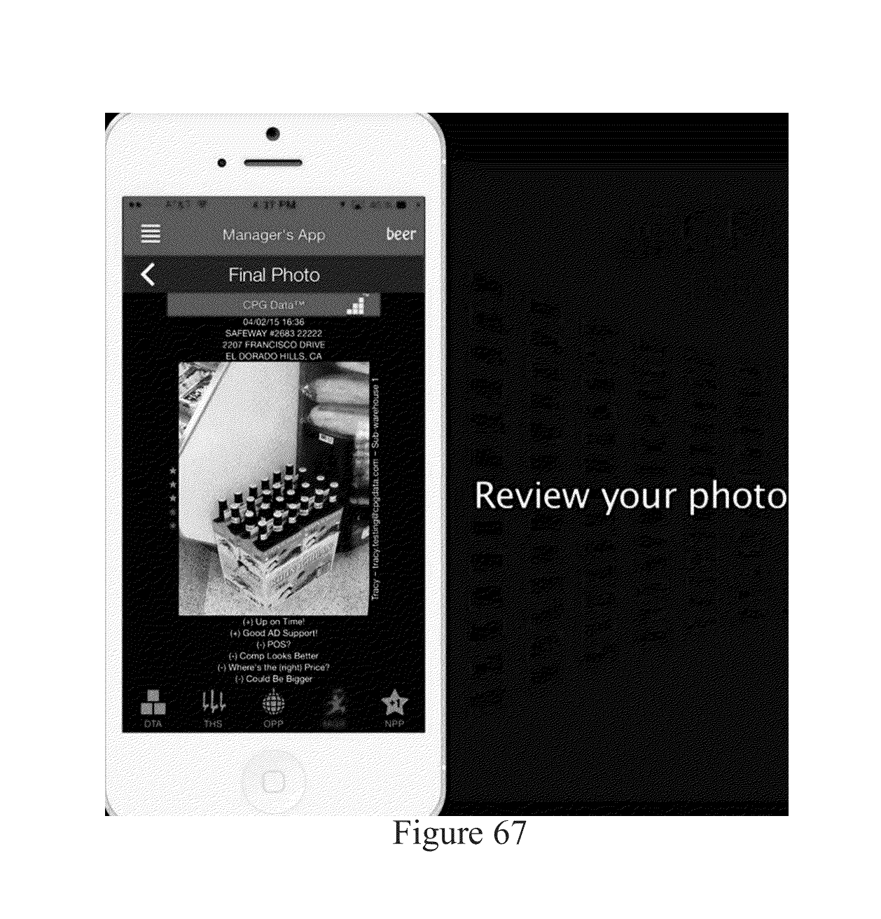

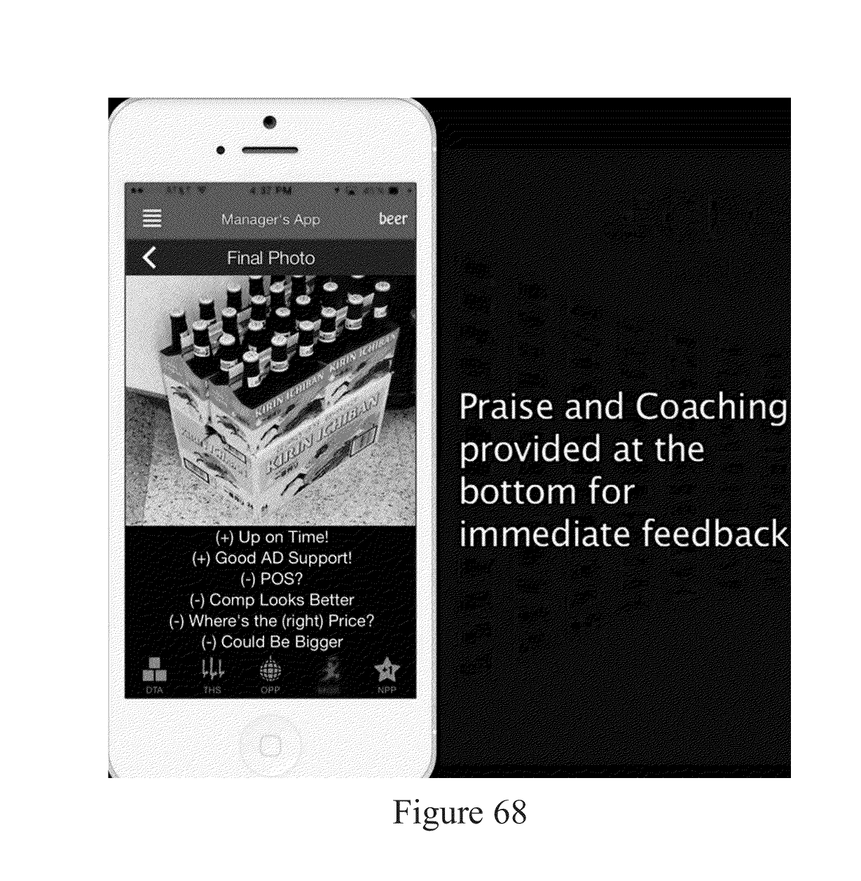

FIGS. 56 through 68 illustrate sample pages of a user interface presented to a user by the product sales activity execution tracking system of an example embodiment when the Mobile App of an example embodiment is used on a mobile device with the Manager's Survey feature. Referring now to FIGS. 56 through 68, the Application Screen Flow in an example embodiment is illustrated.
1. The MGR survey can be accessed from the bottom menu of the CPG Data App, by clicking on the man-with-flag icon with the MGR acronym below it.
2. If the registered customer has more than one state or more than a single warehouse or division, the user selects the appropriate hierarchy.
3. If the customer chooses, a 4-digit pin code is required to access the MGR survey. This is to keep sales reps from using this survey—exclusively allow managers to access it.
4. The manager has observed something in real life so the first screen allows the manager to capture a photo of said observation.
5. The manager can identify which brand is associated with the observation, for later indexing and filtering by brand, by supplier, or by segment.
6. Screen 4 provides a proprietary GPS tracking algorithm to identify the Lat/Long coordinates of the user and then to match & retrieve a list of accounts from CPG Data's database that are within 300 meters radius of the submitted Lat/Long coordinates. If the desired store is not shown, the user may opt to a) expand the radius from 300 meters to 900 meters while retrieving additional store listings from the CPG Data database, or c) exit the CPG Database to a Google Maps database of accounts, or d) select the magnifying glass to “lookup” an account by name or account # from the CPG Data database listings (for use when in offline mode with no cell/WiFi service).
7. Next the user is presented with a listing of brand icons, as arranged in the brand-set builder, a dedicated and secure admin page of the Enterprise Portal for registered CPG Data customers, with a menu of “categories” to the right, resembling a “Rolodex” method of tabs which control each larger set of side-by-side squares which scroll up and down.
8. The manger is then presented with the opportunity to add another brand, in the event that their observation includes multiple brands, or they can select DONE.
9. After DONE is selected, the manager is presented with 5 large grey stars across the top of a preview of the FINAL PHOTO. The manager can select a star, turning the one s/he selected and all the rest of them to the right of that star red. This is the star rating assigned to the photo.
10. Next the manger is presented with a list of scrolling text-based “captions”. The captions are both positive and negative and can be organized from the Caption Set-Builder, a page in the dedicated and secure Enterprise Portal website for registered CPG Data customers. The manger may select 1 or many or all of the appropriate captions that apply to the observation that they made.
11. Next the manager selects DONE.
12. The next screen is an optional email screen. The default red button says “SKIP” if no emails are selected. The manager may make a “favorites” list of emails accessed from their CONTACTS list on their phone, by providing permission. The manager, after importing selected emails, may select 1 or more emails. Those selected will receive a copy of the Final Photo.
13. The FINAL PHOTO has the same details across the top border and right border as all other CPG Data final photos. On the left side border are the 5 grey stars with the corresponding number of them being red. At the bottom of the photo are listed the “captions”, preceded with a “(+)” or “(−)” in front of the positive or negative captions selected by the manager.

The key features of this process survey include;
There are no text boxes for managers to input their own words. All captions are pre-written.
Captions can be managed and selected from the caption-set builder, allowing a consistent set of coaching skills to be enforced across a large geography.
On the backend, the Enterprise Portal, a sales rep is assigned to each Manager's Survey final photo data as a new parameter. The sales rep is identified as the last known sales rep to use the DTA survey in the same account.
The Final Photo listing of the + and − comments at the bottom
The ease of use of sharing the final photo directly from the App
All other signature styles and navigations that are constant with all other CPG Data surveys.
The MGR survey may have value outside of this industry. By providing the same sequences and different “caption” variables, this survey could be used to provide feedback in almost any manner for any industry.

### THS: Tap Handle Survey

The objective of the tap handle survey is to quickly allow a field representative to identify the beverage brands being served by “draught” in an account.

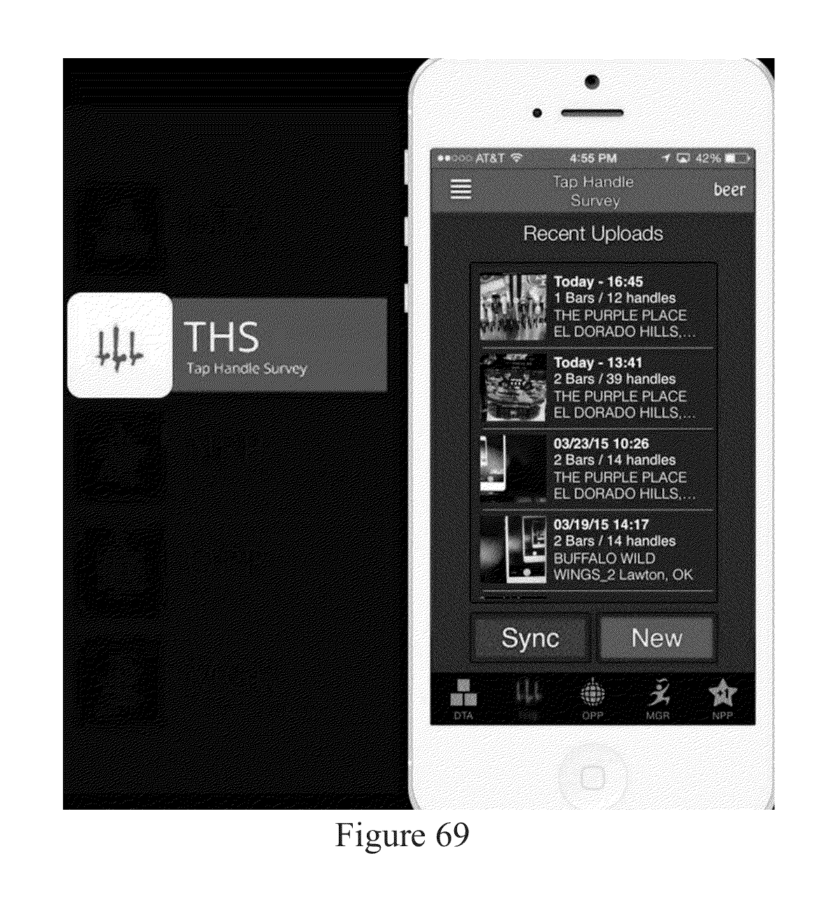

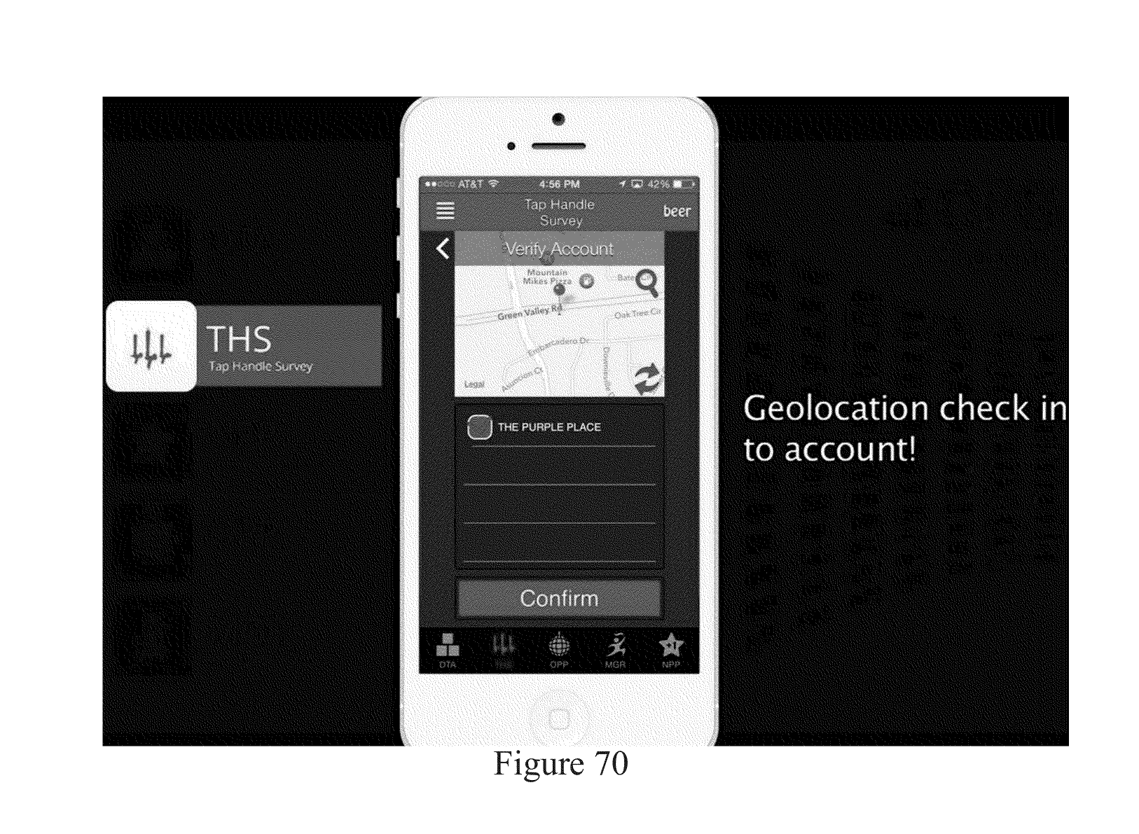

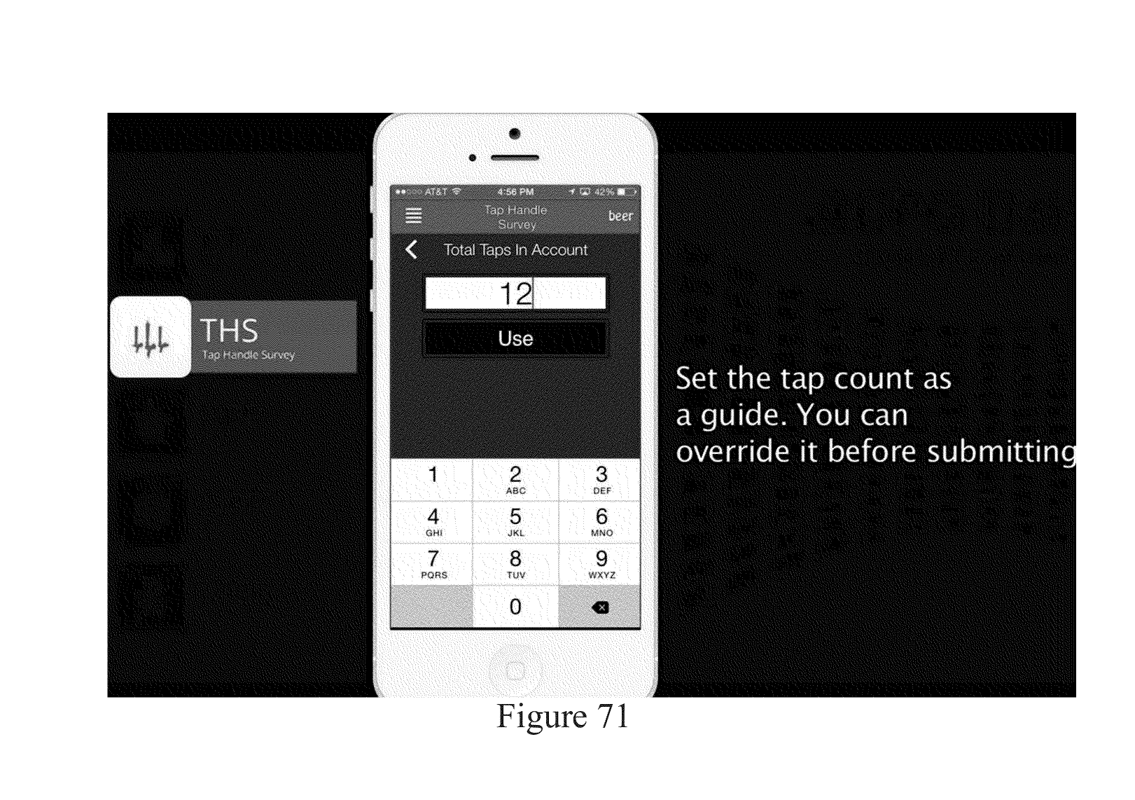

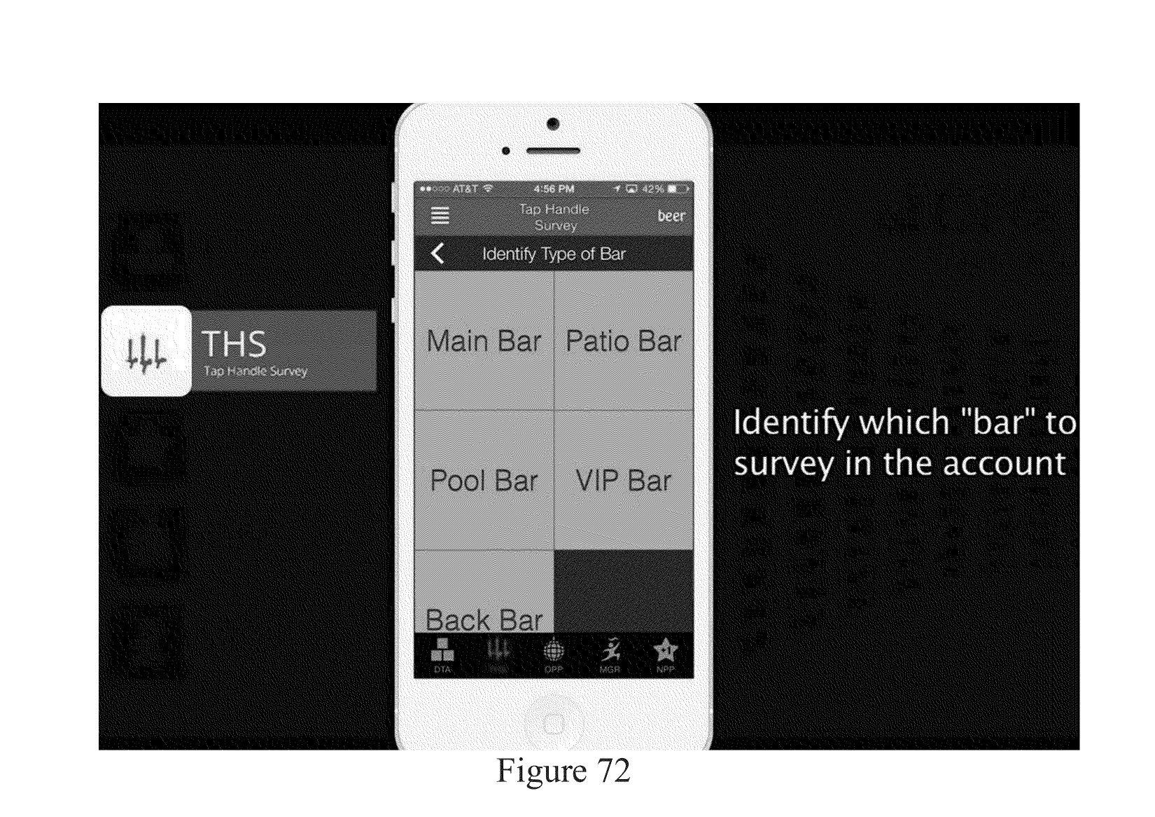

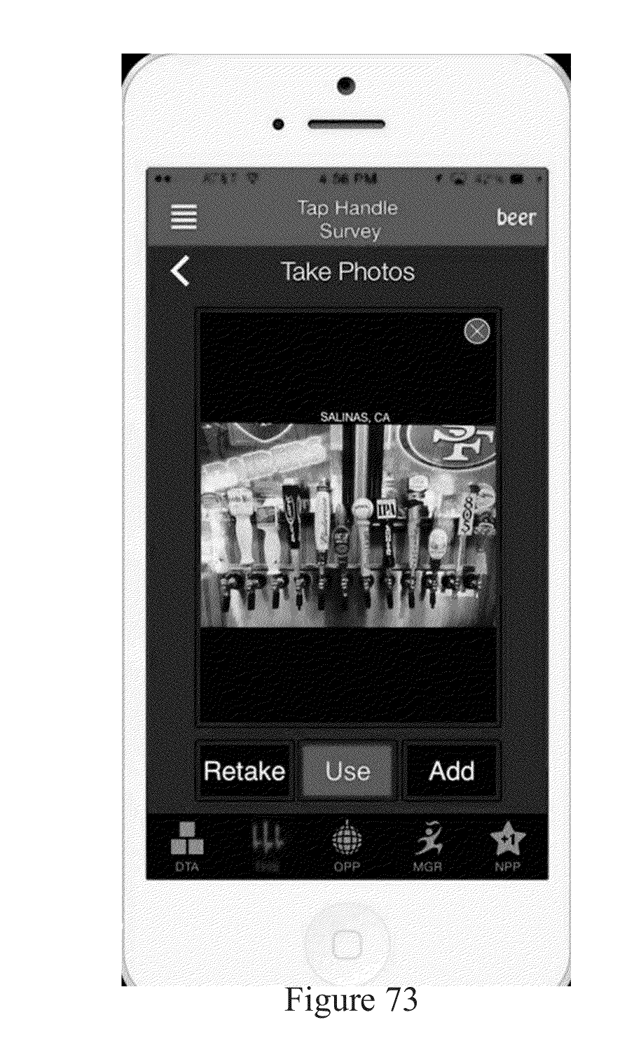

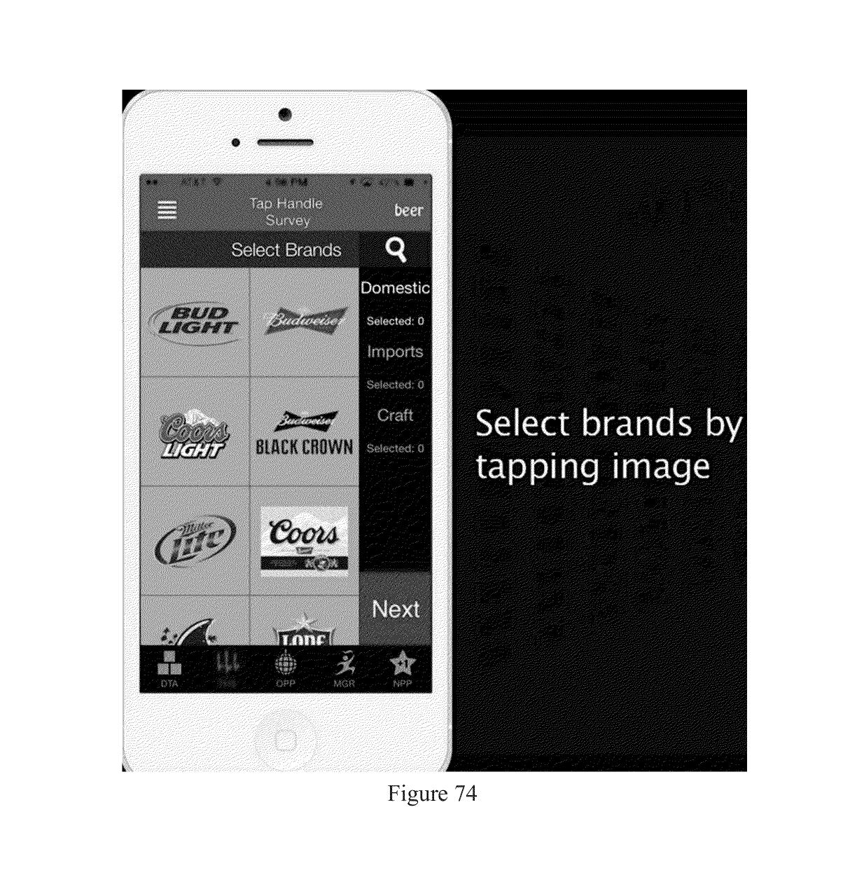

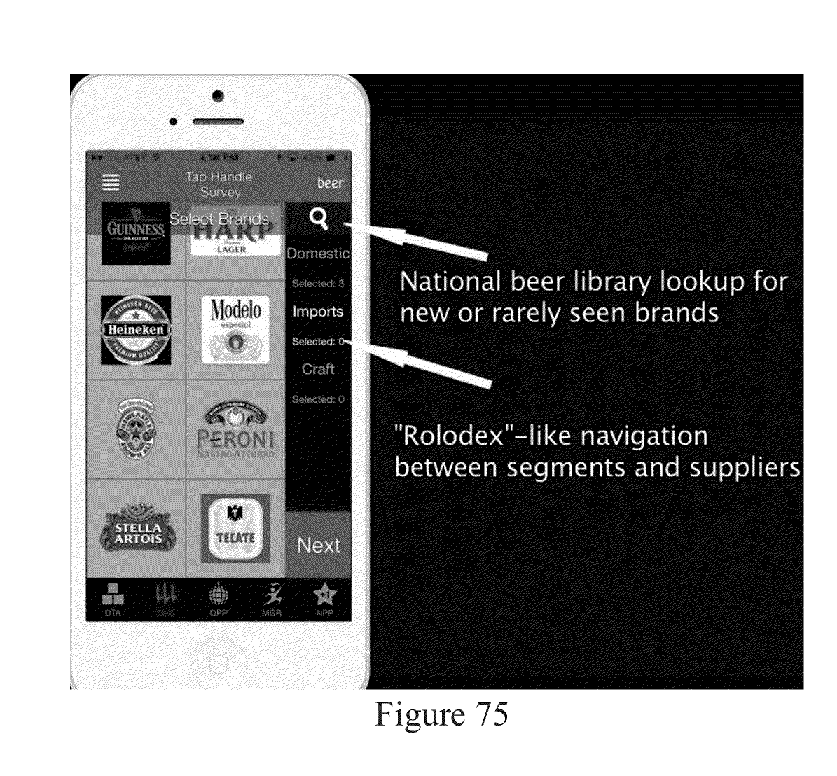

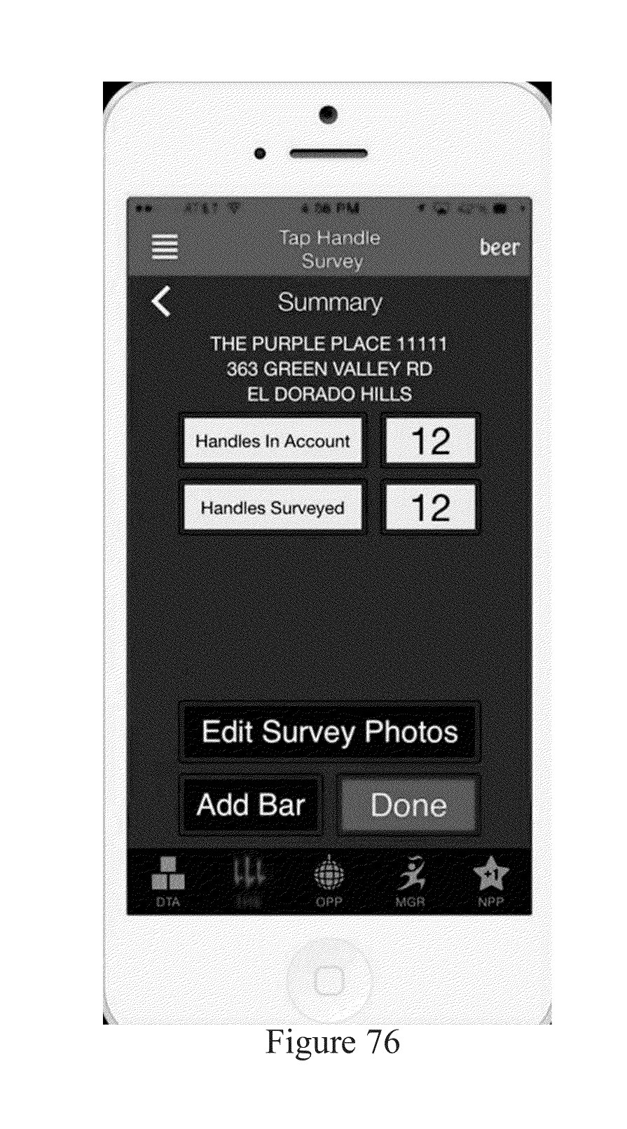

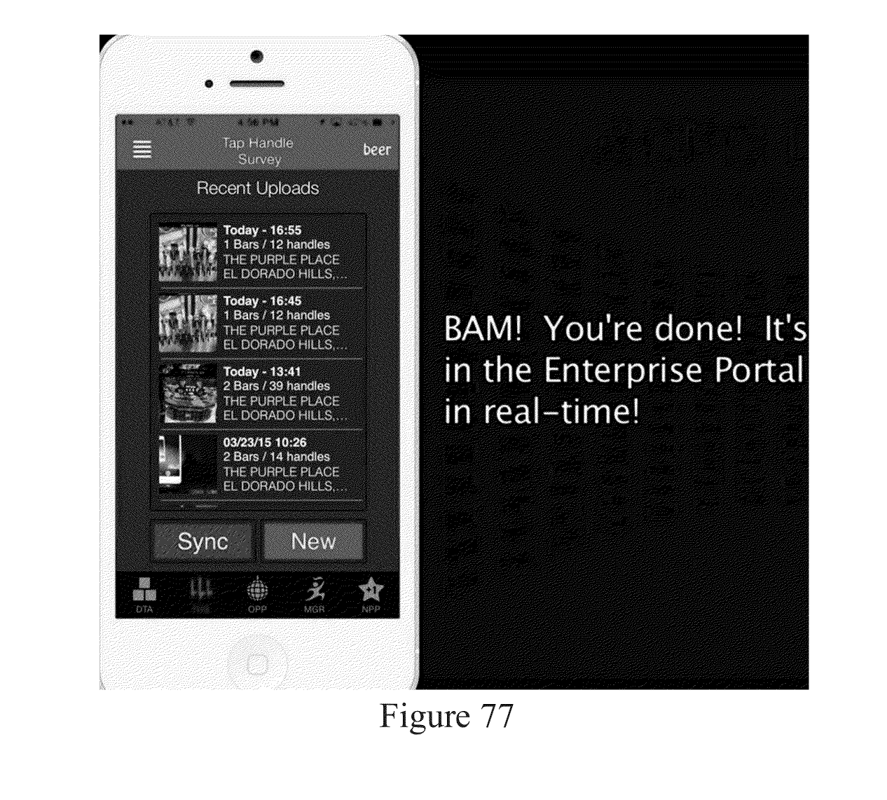

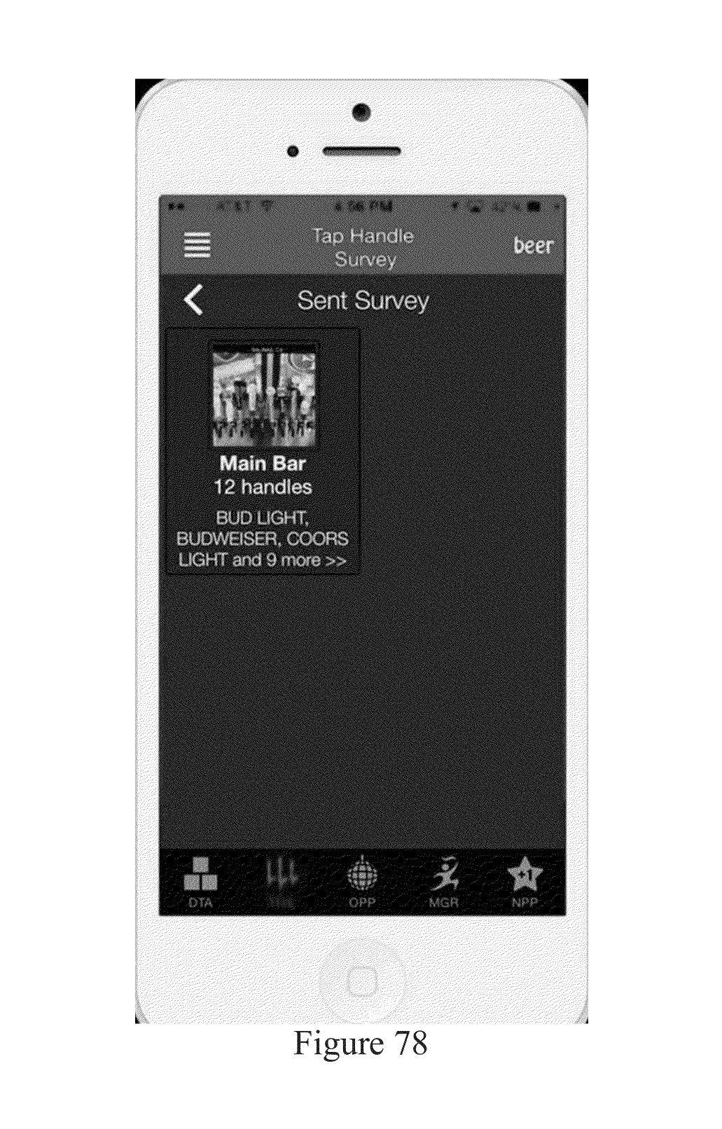

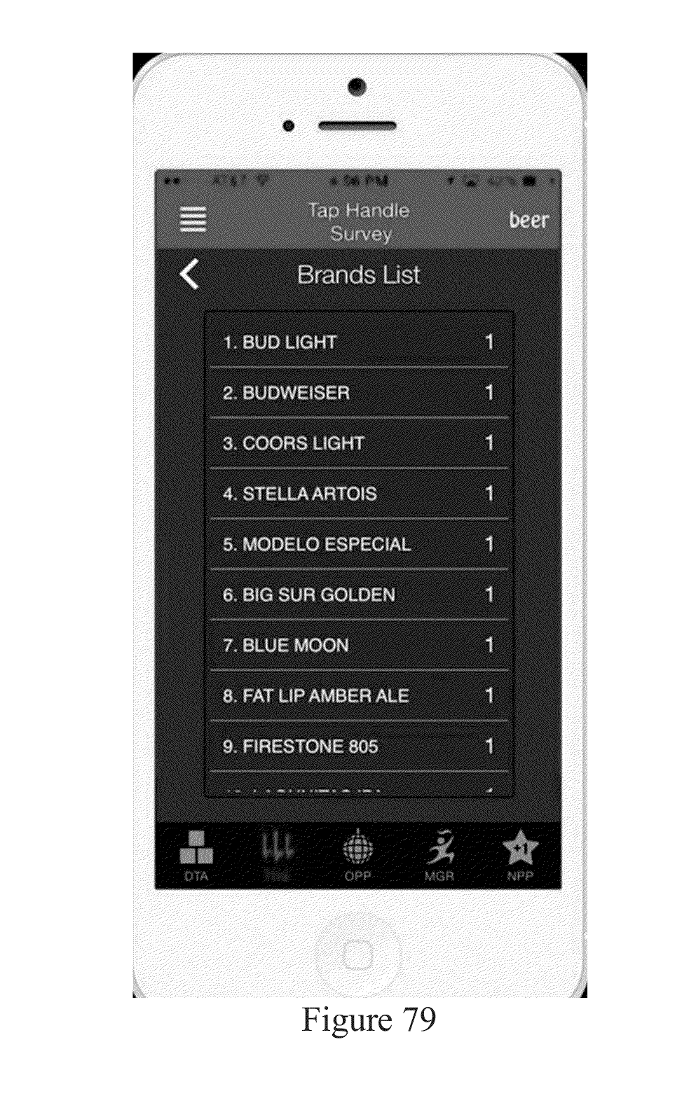

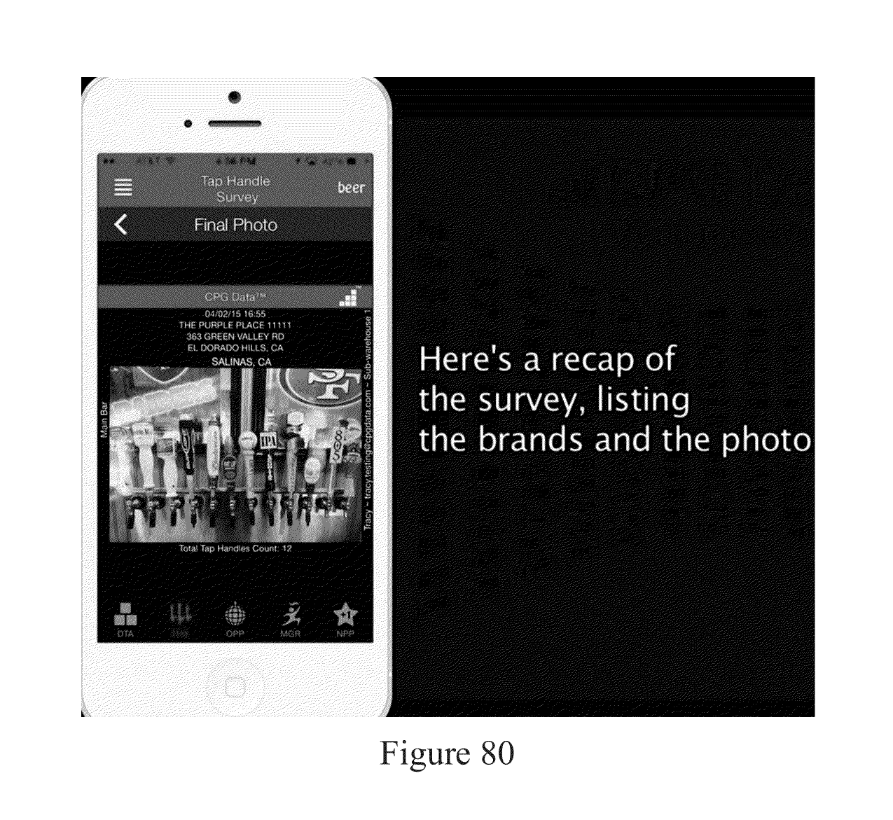

FIGS. 69 through 80 illustrate sample pages of a user interface presented to a user by the product sales activity execution tracking system of an example embodiment when the Mobile App of an example embodiment is used on a mobile device with the Tap Handle Survey feature. Referring now to FIGS. 69 through 80, the Application Screen Flow in an example embodiment is illustrated.
1. The THS survey can be accessed from the bottom menu of the CPG Data App, by clicking on the 3-tap icon with the THS acronym below it.
2. If the registered customer has more than one state or more than a single warehouse or division, the user selects the appropriate hierarchy.
3. Screen 1 provides a proprietary GPS tracking algorithm to identify the Lat/Long coordinates of the user and then to match & retrieve a list of accounts from CPG Data's database that are within 300 meters radius of the submitted Lat/Long coordinates. If the desired store is not shown, the user may opt to a) expand the radius from 300 meters to 900 meters while retrieving additional store listings from the CPG Data database, or c) exit the CPG Database to a Google Maps database of accounts, or d) select the magnifying glass to “lookup” an account by name or account # from the CPG Data database listings (for use when in offline mode with no cell/WiFi service).
4. After identifying the account that the user is in, the user must input, using a keypad, the total # of taps in the account. This is a guide and may be overridden at the end of the survey.
5. Then the user must identify, using the large squares with text that scroll up & down and can be organized or edited from the Enterprise Portal website for CPG Data customers, which “bar” they will service first. (many accounts have >1 bar)
6. After selecting the bar, the user is allowed to take up to 4 photos of evidence of their location or the taps themselves. If more than 1 photo is taken, the two are landscaped side by side into 1 final photo. If 3 photos are taken, the first two are side by side while the 3^{rd} is shown on the bottom of 1 final photo. If 4 photos are taken, they are presented in quadrant format for 1 final photo. The user may use or retake each photo.
7. Next the user is presented with a listing of brand icons, as arranged in the brand-set builder, a dedicated and secure admin page of the Enterprise Portal for registered CPG Data customers, with a menu of “categories” to the right, resembling a “Rolodex” method of tabs which control each larger set of side-by-side squares which scroll up and down.
8. The user may select multiple brand icons to identify which brands are present. The user may also select a single brand multiple times to identify a single brand that has multiple tap handles in a single bar (sports arenas and stadiums have 20+Bud Light taps).
9. The brand-set usually presents a manageable number of brands—but often there are hundreds if not thousands of brands of beer taps in a single market. To access any brand in the CPG Data national brand library, the user may select the magnifying glass to “lookup” brands by name rather than by selecting the large logo icons on the large scrolling squares.
10. The user is now on the Summary screen, where the summary includes Acct Name, Acct #, Address, the # of tap handles that were originally listed and the actual # of tap handles that were surveyed.
11. The user may choose to edit anything already entered at this point—brands, photos, etc. They may also choose to “Add Bar”, aka, add another bar to be surveyed at the same account. If they choose to Add Bar, they are cycled back through the same process beginning at the Identify Type of Bar screen. Bars can continue to be added as necessary.
12. If there are no other bars to add (a single bar account), the user can select “DONE”.
13. If the original tap count # and the actual tap # match, the details are sent to the cloud database owned by CPG Data—where the photo + data is now available for that customer to slice, dice, review, and report.
14. If the original tap count # and the actual tap # do NOT match, the user will be given a warming message, asking them if they would like to proceed despite the actual # of taps surveyed does not match the original estimate provided by the sales rep.

The key features of this process include;
the Rolodex format for presenting a multitude of brands in custom categories by logo
the national brand library lookup method
the ability to continue to click a logo to add multiple tap handles of the same brand for the same bar
all other signature styles and navigations that are constant with all other CPG Data surveys.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a mobile device having a mobile application executable by the mobile device;
a host site computing system having an enterprise portal executable by the host site computing system, the mobile application and the enterprise portal being connectable via a data network, an Internet Protocol (IP) address being used to access the mobile device via the data network;
a data repository being connectable with the mobile application and the enterprise portal; and
a product sales activity execution tracking system being connectable with the mobile application, the enterprise portal, and the data repository, the product sales activity execution tracking system being configured to enable the mobile application and the enterprise portal to operate collaboratively to: collect sales execution metrics as digital records for storage in the data repository, the digital records including product images and product data related to products placed at a retail location; the mobile application and the web application being configured to annotate the product images, the annotation including an associated date, time, user, and geographical location; the product sales activity execution tracking system being configured to enable sharing of the digital records with authorized users of the data repository; and the product sales activity execution tracking system being configured to generate and display a manager's survey view in a user interface.

2. The system in claim 1 wherein the product sales activity execution tracking system further comprising processes to organize and store the collected digital records and make the digital records available to authorized users of the mobile application and the enterprise portal.

3. The system in claim 1 wherein the product data including a product brand and quantity of product pictured in a related product image.

4. The system in claim 1 wherein the product data including an in-store location associated with a product pictured in a related product image.

5. The system in claim 1 wherein the product data including a business account identifier associated with a product pictured in a related product image.

6. The system in claim 1 wherein the product sales activity execution tracking system being further configured to enable a user to create a photo album including a plurality of digital records.

7. The system in claim 1 wherein the product sales activity execution tracking system being further configured to enable a user to create an annotated product photo with related product data annotated around borders of the product photo.

8. The system in claim 1 wherein the product sales activity execution tracking system being further configured to retain digital records in local storage as part of an offline mode if network connectivity is not reliable.

9. The system in claim 1 wherein the product sales activity execution tracking system being further configured to generate reports that provide an analysis of a collection of the digital records.

10. A method comprising:
providing access to a mobile device having a mobile application executable by the mobile device;
providing access to a host site computing system having an enterprise portal executable by the host site computing system, the mobile application and the enterprise portal being connectable via a data network, an Internet Protocol (IP) address being used to access the mobile device via the data network;
providing access to a data repository being connectable with the mobile application and the enterprise portal;
collecting sales execution metrics as digital records for storage in the data repository, the digital records including product images and product data related to products placed at a retail location;
annotating the product images, the annotation including an associated date, time, user, and geographical location;
sharing the digital records with authorized users of the data repository; and
generating and displaying a manager's survey view in a user interface.

11. The method in claim 10 including organizing and storing the collected digital records and making the digital records available to authorized users of the mobile application and the enterprise portal.

12. The method in claim 10 wherein the product data including a product brand and quantity of product pictured in a related product image.

13. The method in claim 10 wherein the product data including an in-store location associated with a product pictured in a related product image.

14. The method in claim 10 wherein the product data including a business account identifier associated with a product pictured in a related product image.

15. The method in claim 10 including enabling a user to create a photo album including a plurality of digital records.

16. The method in claim 10 including enabling a user to create an annotated product photo with related product data annotated around borders of the product photo.

17. The method in claim 10 including retaining digital records in local storage as part of an offline mode if network connectivity is not reliable.

18. The method in claim 10 including generating reports that provide an analysis of a collection of the digital records.

19. A non-transitory machine-useable storage medium embodying instructions which, when executed by a machine, cause the machine to:
provide access to a mobile device having a mobile application executable by the mobile device;
provide access to a host site computing system having an enterprise portal executable by the host site computing system, the mobile application and the enterprise portal being connectable via a data network, an Internet Protocol (IP) address being used to access the mobile device via the data network;
provide access to a data repository being connectable with the mobile application and the enterprise portal;
collect sales execution metrics as digital records for storage in the data repository, the digital records including product images and product data related to products placed at a retail location;
annotate the product images, the annotation including an associated date, time, user, and geographical location;
share the digital records with authorized users of the data repository; and
generate and display a manager's survey view in a user interface.

20. The machine-useable storage medium as claimed in claim 19 wherein the product data including a product brand and quantity of product pictured in a related product image.
